(19) United States
(12) Patent Application Publication
(10) Pub. No.: US 2024/0373844 A1
(43) Pub. Date: Nov. 14, 2024

(54) PYROGLUTAMIC ACID AS AN HERBICIDE SAFENER AND METHODS OF USE THEREOF

(71) Applicant: Verdesian Life Sciences U.S., LLC, Cary, NC (US)

(72) Inventors: Kuide Qin, Chapel Hill, NC (US); Amy Burton, Fuquay-Varina, NC (US)

(21) Appl. No.: 18/691,166

(22) PCT Filed: Sep. 7, 2022
(86) PCT No.: PCT/US2022/042703

§ 371 Date: Mar. 12, 2024

Related U.S. Application Data
(60) Provisional application No. 63/243,810, filed on Sep. 14, 2021.

(51) Int. Cl. A01N 25/32; A01N 37/02; A01N 37/08; A01N 43/42; A01N 47/34; A01N 57/20; A01P 13/00

(52) U.S. Cl. CPC A01N 25/32; A01N 37/02; A01N 37/08; A01N 43/42; A01N 47/34; A01N 57/20; A01P 13/00

(57) ABSTRACT

The present invention is directed to herbicide safener compositions containing pyroglutamic acid (PGA) and finding particular utility in agricultural uses, e.g., being directly applied to soil and/or plant parts, to reduce the phytotoxic effects of certain herbicides in cultivated crops.

### FIELD

The present invention is directed to pyroglutamic acid-containing compositions or formulations thereof finding particular utility as herbicide safeners to prevent and/or minimize injury to crops of cultivated plants treated with a herbicide composition.

### BACKGROUND

Weed management in modern agriculture requires efficient weed control technologies that are safe to the crop. The search for environmentally compatible herbicides with high biological activity and crop tolerance is a challenge for agrochemical research. Insufficient crop tolerance is one of the major constraints in the development of new herbicides and in the use of existing herbicides. Recent efforts have therefore aimed at protecting crops from herbicidal injury by improving crop tolerance to new and existing herbicides by using herbicide safeners.

Herbicide safeners are a group of chemically diverse compounds with the unique ability to protect crop plants from injury by certain herbicides without impairing weed control efficacy. Herbicides attack fundamental physiological and biochemical processes critical to plant growth and function. Herbicide safener compounds are typically co-applied with herbicides to increase the species specificity of herbicides (Jablonkai, 2013), or to improve injury recovery in crop plants. Herbicide safeners come from diverse chemical families, and therefore have varied modes of action (University of Wisconsin Extension, 2013). Many herbicide safeners induce plant gene expression for enzymes that detoxify the herbicide before it can damage the plant (Riechers et al., 2010). Not only are safeners co-applied with the herbicide as a foliar or in-furrow application on crops (particularly monocot crops) but they can also be seed-applied.

With herbicides and herbicide safeners becoming increasingly pivotal in controlling weeds and sustaining food security, current research efforts focus on exploiting safeners in two ways: to improve the tolerance of newly developed herbicides with limited selectivity on target crops, and to extend the use of available herbicides on additional crops.

Thus, with the constant demand to develop herbicides that must efficiently kill weeds while being as harmless as possible for crops, the demand to develop herbicide safeners has increased as well.

In this context, it is a primary object of the present invention to provide eco-friendly products and methods for nodulating weed control with minimal injury to crop plants in order to produce high-yielding crops as is described in more detail below.

### BRIEF SUMMARY

In one aspect, the subject matter described herein is directed to a method of controlling the growth of undesired vegetation in a target area, the method comprising applying to the target area an herbicidally effective amount of an herbicide composition comprising an herbicide selected from a lipid synthesis inhibitor, an amino acid synthesis inhibitor, a nitrogen metabolism inhibitor, a growth regulator inhibitor, and a combination thereof; and applying an herbicide safener composition comprising pyroglutamic acid (PGA) and/or 2-oxoglutaramate at a concentration of less than 1 g/L, wherein the herbicide safener composition is applied to the target area in an amount effective to cause an herbicide safening effect, and wherein the target area contains plants of cultivated crops selected from specialty crops, sugar crops, legumes, and a combination thereof.

In further embodiments, the subject matter described herein is directed to compositions comprising amounts and rates of pyroglutamic acid (PGA) effective to cause an herbicide safening effect, amounts of PGA present in the herbicide safening composition, and application methods of the herbicide safening composition to the target area, as well as what types of cultivated plants are present in a given target area.

These and other embodiments and/or aspects are fully described in more detail below.

### DESCRIPTION OF THE DRAWINGS

FIG. 1 shows corn (Zea mays) plants treated with pyroglutamic acid (PGA), glyphosate herbicide, and a combination of the two. From left, treatments are: untreated (control), pyroglutamic acid (PGA; 0.137 g/L), glyphosate @100% label rate; glyphosate @ 10% label rate, and glyphosate @ 10% label rate and PGA (0.137 g/L), where drench application of PGA was carried out directly after the herbicide application on the same day; N=3; each treatment is shown on 2 plants.

FIG. 2 is a bar graph showing average dry weight (g) of corn plants 7 days after treatment. Treatments are as follows: no glyphosate and no PGA, no glyphosate and PGA (0.137 g/L), glyphosate @ 1% label rate; glyphosate @ 1% label rate and PGA (0.137 g/L), glyphosate @10% label rate; glyphosate @ 10% label rate and PGA (0.137 g/L), glyphosate @ 100% label rate, wherein drench application of PGA was carried out directly after the herbicide application on the same day; N=3.

FIG. 3 is a bar graph showing average leaf area (cm²) of corn plants 7 days after treatment. Treatments are as follows: no glyphosate and no PGA, no glyphosate and PGA (0.137 g/L), glyphosate @ 10% label rate; glyphosate @ 10% label rate and PGA (0.137 g/L); glyphosate @ 100% label rate, and glyphosate @100% label rate with PGA (0.137 g/L); and wherein drench application of PGA was carried out directly after the herbicide application on the same day; N=3.

FIG. 4 shows corn (Zea mays) plants treated with pyroglutamic acid, glyphosate herbicide, and a combination of the two. From left, treatments are: untreated (control), pyroglutamic acid (PGA; 0.137 g/L); glyphosate @ 100% label rate; glyphosate @ 10% label rate; and glyphosate @ 10% label rate and PGA (0.137 g/L), wherein drench application of PGA was carried out 24 hours after the herbicide application; N=3; each treatment is shown on 2 plants.

FIG. 5 shows corn (Zea mays) plants treated with pyroglutamic acid, herbicide, and a combination of the two. From left, treatments are: untreated (control), pyroglutamic acid (PGA; 0.137 g/L); Bayer All-in-One Herbicide® (a mixture of 4.85% 2,4-D, dimethylamine salt (CAS #2008-39-1), 0.45% Dicamba, dimethylamine salt (CAS #2300-66-5), and 1.61% Quinclorac (CAS #84087-1-4))@ 100% label rate; Bayer All-in-One Herbicide @ 100% label rate and PGA (0.137 g/L), Bayer All-in-One Herbicide @ 10% label rate; and Bayer All-in-One Herbicide @ 10% label rate and PGA (0.137 g/L), wherein drench application of PGA was carried out directly after the herbicide application on the same day; injury of this mode of action (MOA) typically presents as non-vertical growth of the stem, which is in contrast to the brown necrotic tissue of glyphosate-type MOAs; N=3; each treatment is shown on 2 plants.

FIG. 6 is a bar graph showing the plant height of soybean plants that were not treated with herbicide 2,4-D, treated with herbicide 2,4-D @ 25% label rate; and treated with herbicide 2,4-D @ 25% label rate and PGA-C-P (PGA-containing product).

FIG. 7 is a bar graph showing the mean number of days taken to reach BBCH growth stages 20, 31 and 39. Sample size=10 plants per plot, replication (n)=5 and error bars are expressed as the standard error of the mean. Groups of plants were as follows (Left to right): untreated (UTC), Herbcide, herbicide +PGA-C-P (PGA-containing product) @1 L/ha, and herbicdes +PGA-C-P (PGA-containing product) @2 L/ha.

FIG. 8 is a picture of a beet plant showing the phytotoxicity displayed in treatment 3, herbicides without PGA-containing product (1 L/ha) following application C.

FIG. 9 is a picture of a beet plant showing the phytotoxicity displayed in treatment 4, herbicides with PGA-containing product (1 L/ha) following application C.

FIG. 10 is a picture of a beet plant showing the phytotoxicity displayed in treatment 4, herbicides with PGA-containing product (2 L/ha) following application C.

FIG. 11 is a bar graph showing the mean chlorophyll content at BBCH20, BBCH31, and BBCH39. Sample size=10 plants per plot, replication (n)=5 and error bars are expressed as the standars error of the mean. Groups of plants included untreated (UTC), herbicides, and herbicdes +PGA-C-P (PGA-contaitning product) @1 L/ha (light grey) and 2 L/ha (dark grey).

FIG. 12 is a bar graph showing the mean fresh plant weight at the end of the trial. Sample size=10 plants per plot, replication (n)=5 and error bars are expressed as the standard error of the mean. Population of plants that were treated (going from left to right on the graph): untreated (UTC), herbicdes, herbicides +PGA-C-P (PGA-containing product) @1 L/ha, and herbicides +PGA-C-P (PGA-containing product) @2 L/ha.

FIG. 13 is a bar graph showing the mean beet weight at the end of the trial. Sample size=10 plants per plot, replication (n)=5 and error bars are expressed as the standard error of the mean. Population of plants that were treated (going from left to right on the graph): untreated (UTC), herbicdes, herbicides +PGA-C-P (PGA-containing product) @1 L/ha, and herbicides +PGA-C-P (PGA-containing product) @2 L/ha.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

It was surprisingly discovered that pyroglutamic acid (PGA), a known biostimulant, can exhibit herbicide safening properties when applied at lower concentrations/label rates compared to concentrations/label rates that are typically employed in the field. Not to be bound by theory, but it is believed that when PGA is applied to plants in certain amounts, a herbicide safening effect can be observed rather than a biostimulant effect.

The low concentrations/label rates of PGA exhibits herbicide safening behavior towards plants and/or seeds, which is expressed as an improvement in plant growth and/or vigor of herbicide-treated plants and/or seeds compared to plants and/or seeds that were treated only with an herbicide and no PGA (i.e., herbicide safener). Since PGA is an analog of 2-oxoglutaramate, it would be expected that 2-oxoglutaramate would act as a biostimulant as well at such lower concentrations.

Such PGA- and/or 2-oxoglutamarate-containing herbicide safener compositions are described further in more detail below.

### I. Definitions

As used herein, the term “biostimulant” refers to a compound stimulating plant physiological processes independently of the compound's nutrient content, with the main aim of improving one or more of the following characteristics of the plant: growth rate, developmental rate, nutrient use efficiency, tolerance to abiotic stress, crop quality, and yield.

As used herein, the term “crop” includes reference to a whole plant, plant organ (e.g., leaves, stems, twigs, roots, trunks, limbs, shoots, fruits, etc.), plant cells, or plant seeds. This term also encompasses plant harvestable organs such as fruits.

As used herein, the term “control of undesirable vegetation” refers to the interference with the normal growth and development of undesired vegetation. Examples of control activity include, but are not limited to, inhibition of root growth, inhibition of shoot growth, inhibition of shoot emergence, inhibition of leave expansion, inhibition of cell division, inhibition of cell elongation, inhibition of seed production, or reduction of weed biomass.

As used herein, the term “herbicidally effective amount” indicates the quantity of such a compound/composition or combination of such compounds and/or compositions, which is capable of producing a controlling effect on the growth of plants. Disclosed herein are herbicide compositions, which are capable of producing a controlling effect on the growth of unwanted vegetation as is described in more detail below. A skilled artisan is well aware of the fact that such an amount can vary in a broad range and is dependent on various factors, e.g., weather, target species, locus, mode of application, soil type, treated crop, climatic conditions and the like.

As used herein, the term “controlling effects” includes all deviation from natural development, for example: killing, retardation, leaf burn, albinism, dwarfing and the like. For example, plants that are not killed are often stunted and noncompetitive with flowering disrupted.

As used herein, the term “pesticide” refers to a substance that is meant to control pests. The term pesticide includes all of the following: insecticides (which may include insect include growth regulators, termiticides, etc.), nematicide, molluscicide, piscicide, avicide, bactericide, insect repellent, animal repellent, antimicrobial, and fungicide.

As used therein, the term “herbicide” refers to any known substances used to control unwanted vegetation. In general, herbicides (often called weed killers) are grouped into “selective” herbicides and “non-selective” herbicides. Selective herbicides control specific species of unwanted vegetation, while leaving the desired crop relatively unharmed, while non-selective herbicides (sometimes called total weed killers) can be used to clear waste ground, industrial and construction sites, railways and railway embankments as they kill all plant material with which they come into contact. As used herein, the term “unwanted vegetation” refers to any plant that is considered undesirable in a particular situation, such as a plant out of place, or a plant that is more detrimental than beneficial. Such plants are also often referred to as weeds.

As used herein, the term “injured” refers to plants that suffered a plant injury due to an external irritant. A plant injury is an abrupt alteration of form or function caused by a discontinuous external irritant such as insects, animals, and physical, chemical or environmental agents/toxins. Herein in particular the term “injured” refers to plants that were exposed to the herbicide composition as disclosed herein (considered an external irritant) which resulted in any plant injuries.

As used herein, the term “seed” comprises propagules of all types, such as, for example, caryopsis, grain, achene, legume, samara, nut, and propagules associated with pods, follicles, capsules, siliques, drupes, berries, tubers, corms, bulbs and similar forms. The seed used can be seed of the useful plants mentioned above, but also the seed of transgenic plants or plants obtained by customary breeding methods.

As used herein, the term “plant parts” refers to various different parts of the plants such as the root, leaves, stem, fruit, flower, and seed.

As used herein, the term “insecticide” refers to any substance used to kill insects.

As used herein, the term “larvicide” refers to an insecticide that is specifically targeted against the larval life stage of an insect.

As used herein, the term “bactericide” refers to any substance used to kill bacteria.

As used herein, the term “acaricide” refers to any substance used to kill members of the arachnid subclass Acari, which includes ticks and mites.

As used herein, the term “nematocide” refers to any substance used to kill nematodes.

As used herein, the term “molluscicide” refers to any substance used to kill mollusks.

As used herein, the term “miticide” refers to any substance used to kill mites.

As used herein, the term “plant growth regulator” refers to any substance or mixture of substances intended, through physiological action, to accelerate or retard the rate of growth or maturation or otherwise alter the behavior of plants or their produce.

As used herein, the term “monocotyledons” refers to monocots that are flowering plants (angiosperms), the seeds of which typically contain only one embryonic leaf, or cotyledon. They constitute one of the major groups into which the flowering plants have traditionally been divided, the rest of the flowering plants having two cotyledons and therefore classified as dicotyledons, or dicots. However, molecular phylogenetic research has shown that while the monocots form a monophyletic group or clade (comprising all the descendants of a common ancestor), the dicotyledons do not. The monocotyledons include about 60,000 species. The largest family in this group (and in the flowering plants as a whole) by number of species are the orchids (family Orchidaceae), with more than 20,000 species. About half as many species belong to the true grasses (Poaceae), which are economically the most important family of monocotyledons. In agriculture the majority of the biomass produced comes from monocotyledons. These include not only major grains (rice, wheat, maize, etc.), but also forage grasses, sugar cane, and the bamboos. Other economically important monocotyledon crops include various palms (Arecaceae), bananas and plantains (Musaceae), gingers and their relatives, turmeric and cardamom (Zingiberaceae), asparagus (Asparagaceae), pineapple (Bromeliaceae), water chestnut (Cyperaceae), and leeks, onion and garlic (Amaryllidaceae). Many houseplants are monocotyledon epiphytes. Additionally most of the horticultural bulbs, plants cultivated for their blooms, such as lilies, daffodils, irises, amaryllis, cannas, bluebells and tulips, are monocotyledons.

As used herein, the term “dicotyledons” refers to any of various flowering plants that are not monocotyledons, having two cotyledons in the seed and usually flower parts in multiples of four or five, leaves with reticulate venation, pollen with three pores, and the capacity for secondary growth. The dicotyledons, which include the eudicotyledons and the magnoliids, are no longer considered to form a single valid taxonomic group. Dicotyledons are also known as dicots (or more rarely dicotyls), and the most typical characteristic of this group is that the seed has two embryonic leaves or cotyledons. There are around 200,000 species within this group.

As used herein, the term “soil” is to be understood as a natural body comprised of living (e.g., microorganisms (such as bacteria and fungi), animals, and plants) and nonliving matter (e.g., minerals and organic matter (e.g., organic compounds in varying degrees of decomposition), liquid, and gases) that occurs on the land surface and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals). Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal, and seaweed extracts. Further examples are enzymatically digested proteins, fish meal, and feather meal. The decomposing crop residue from prior years is another source of fertility. In addition, naturally occurring minerals such as mine rock phosphate, sulfate of potash, and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “manure” is organic matter used as organic fertilizer in agriculture. Depending on its structure, manure can be divided into liquid manure, semi-liquid manure, stable or solid manure, and straw manure. Depending on its origin, manure can be divided into manure derived from animals or plants. Common forms of animal manure include feces, urine, farm slurry (liquid manure), or farmyard manure (FYM), whereas FYM also contains a certain amount of plant material (typically straw), which may have been used as bedding for animals. Animals from which manure can be used comprise horses, cattle, pigs, sheep, chickens, turkeys, and rabbits. Guano from seabirds and bats can also be used. The application rates of animal manure when used as fertilizer highly depend on the origin (type of animals). Plant manures may derive from any kind of plant, whereas the plant may also be grown explicitly for the purpose of plowing them in (e.g., leguminous plants), thus improving the structure and fertility of the soil. Furthermore, plant matter used as manure may include the contents of the rumens of slaughtered ruminants, spent hops (left over from brewing beer), or seaweed.

As used herein, the term “emulsifiable concentrate” refers to liquid formulations with an active ingredient that is dissolved in one or more petroleum-based solvents. An emulsifier is added to cause oil to form tiny globules that disperse in water. The formulation then will mix readily with water for proper application. Emulsifiable concentrates usually contain between 2 and 8 pounds of active ingredient per gallon.

As used herein, the term “wettable powder” refers to finely ground, dry particles that may be dispersed and suspended in water. They typically contain from about 25% to 80% active ingredient. Suspensions of wettable powders appear cloudy. Wettable powders are nearly insoluble and require agitation to remain in suspension.

As used herein, the term “dry flowables,” also called “water-dispersible granules (WDG or WG) or dispersible granules (DG),” refers to wettable powders formed into prills so they pour easily into the sprayer tank without clumping or producing a cloud of dust. Nearly insoluble, they require agitation to remain in suspension.

As used herein, the terms “flowables” and/or “suspension concentrates” and/or “aqueous suspension” refer to finely ground, wettable powders or solids already suspended in a liquid carrier so they can be poured or pumped from one tank to another. They usually contain at least about 4 pounds of active ingredient per gallon of formulation. Flowables are nearly insoluble in water and require agitation to remain in suspension.

As used herein, the terms “microencapsulated suspension” and/or “capsule suspension” refer to herbicides that are encased in extremely small capsules that can be suspended in a liquid carrier and pumped and applied with normal equipment. Microencapsulated formulations are nearly insoluble in water and require agitation to remain in suspension and allows for the active ingredient to be slowly released over a period of time. This extends the soil activity and improves weed control.

As used herein, the term “pellets” refers to granule-like entities but are compressed into larger cylinders about ¼ inch long. Herbicides formulated as pellets usually contain from about 5% to 20% active material and are hand-applied to control clumps of brush. They also may be applied with cyclone-type spinner spreaders mounted on helicopters or aircraft to control brush in forests or permanent pastures. Pellets gradually break down from rainfall and leach into the soil for root uptake.

As used herein, the term “water soluble powder” refers to dry soluble powders (DS) from true solutions in water and require no agitation.

As used herein, the term “ultra-low-volume concentrate” refers to the active ingredient in its original liquid form and is typically applied without further dilution in special aerial or ground equipment at rates of 1.5 pint to 1.5 gallon per acre as an extremely fine spray.

As used herein, the term “premixes” refers not to formulations, but rather to two or more herbicide active ingredients mixed into one product by the manufacturer. The actual formulation can be any of those discussed above and commonly combines two or more herbicides that are already used together. The primary reason for using premixes is convenience.

As used herein, the term “organic solvent” refers to a nonaqueous solvent that solvates PGA to the degree as described elsewhere herein.

As used herein, the term “nonaqueous” refers to a solvent that has a water content of less than 0.2% by weight based on the total weight of the solvent.

Throughout this specification and the claims, the words “comprise,” “comprises,” and “comprising” are used in a nonexclusive sense, except where the context requires otherwise, and are synonymous with “including,” “containing,” or “characterized by,” meaning that it is open-ended and does not exclude additional, unrecited elements or method steps.

As used herein, the transitional phrase “consisting essentially of” limits the scope of a claim to the specified materials or steps “and those that do not materially affect the basic and novel characteristic(s)” of the claimed invention.

As used therein, the transitional phrase “consisting of” excludes any element, step, or ingredient not specified in the claim.

Additional definitions may follow below.

### II. Compositions

The current disclosure relates to an herbicide safener composition comprising pyroglutamic acid (PGA) and/or 2-oxoglutamarate that when applied in combination with the disclosed herbicide composition to plants of cultivated crops at low concentrations and/or label rates exhibits potent herbicide safening properties. This observation was totally surprising and unexpected considering that PGA is known as a biostimulant but was not known to exhibit any herbicide safening properties. Since PGA is an analog of 2-oxoglutaramate, 2-oxoglutaramate would exhibit essentially the same biostimulant properties at low concentrations as PGA does.

The disclosed herbicide safener composition and herbicide composition used herein are further described in more detail below.

### A. Herbicide Safener Composition

The herbicide safener composition as disclosed herein comprises/consists essentially of/consists of pyroglutamic acid (pyroglutamate; PGA). PGA is a biostimulant and its application is known to improve growth and yield of crop plants by increasing nitrogen assimilation in the glutamate biosynthesis pathway, which in turn improves how the plant utilizes other nutrients such as phosphorus and sulfur. PGA also leads to increased carbon fixation and metabolism, fueling faster root and shoot growth. As a result, a bigger plant is created that captures more nutrients from the soil and more sunlight, which, in turn, delivers increased plant vigor, growth and productivity. These growth-promoting effects of PGA are typically observed following applications to plant foliage or through uptake by the root system.

PGA exists in two forms, the D and L stereoisomers, having the following stereochemical structures, respectively:

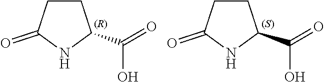

As such, pyroglutamic acid can be present in the combination products as the D or L form, or a ratio of D:L stereoisomers.

PGA has been used for many years as a biostimulant either alone or coupled with various types of fertilizers to improve nitrogen use efficiency, boost crop growth, and increase yield potential. In some embodiments, PGA is used as a biostimulant alone to improve nitrogen use efficiency of nutrients that are generally present in argonomic systems, i.e., as part of the soil. To date, PGA-containing products include TAKE-OFF™, for example, TAKE OFF Calci-Phite®, TAKE OFF Magnesium®, TAKE OFF PGA®, TAKE OFF Phite MZ®, TAKE OFF Sulfone®, TAKE OFF® P+K, and TAKE OFF BOOSTER™, where 1× Label Rate is the equivalent of 250 g PGA applied per hectare.

However, it has been surprisingly discovered that when PGA-containing compositions (such as commercially available PGA products) are applied to plants at much lower application rates than label rates, an herbicide safening effect can be observed. In particular, PGA-containing compositions exhibit an herbicide safening effect when used with an application rate that is equal to or lower than half of the PGA's FIFRA registered lowest label rate. Although the mode of action is not clear, the PGA-mediated growth promotion confers an advantage to the target crop, allowing for crop plants to not sustain any injuries from herbicide applications compared to plants that were only treated with an herbicide.

Since PGA is an analog of 2-oxoglutamarate, 2-oxoglutamarate would also be expected to exhibit biostimulant properties as low concentration similar to PGA. The structure of 2-oxoglutamarate is shown below:

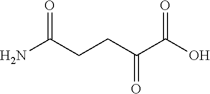

A skilled artisan would recognize that 2-oxoglutamarate is essentially the open form of PGA.

In some embodiments, the herbicide safener composition as disclosed herein exhibits an herbicide safening effect (i.e., protects plants of cultivated crops) on one or more particular types of plants of cultivated crops, wherein the herbicide safening effect is measured by at least one method selected from an increase in crop development, a decrease in phytotoxicity, an increase in crop vigor, an increase in chlorophyll content, an increase in fresh or dry plant weight, an increase in root weight, an increase in crop yield, an increase in fruit quality, an increase in vertical plant growth, and an increase in plant leaf area of plants treated with the herbicide safener composition compared to plants that were treated only with the herbicide composition (and not treated with the herbicide safener composition). In some embodiments, the herbicide safener composition exhibits an herbicide safening effect on one or more particular types of cultivated crops, wherein the herbicide safening effect is measured by an increase of at least about 1%, 10%, 20%, 30%, 40%, 50%, 60%, 70%, 80%, 90%, 95% or about 98% of crop development, crop vigor, chlorophyll content, fresh or dry plant weight, root weight, crop yield, fruit quality, vertical plant growth, plant leaf area, or a combination thereof, of plants treated with the herbicide safener composition compared to plants that were treated only with the herbicide composition (and were not treated with the herbicide safener composition). In some embodiment, such an herbicide safening affect is greater than 100%, such as 150%, 200%, 250%, or greater than 300%. In some embodiments, the herbicide safener composition exhibits an herbicide safening effect, which is measured by an increase of from about 1% to about 20% plant height of plants treated with the herbicide safener composition compared to plants that were only treated with an herbicide composition. In some embodiments, the herbicide safener composition exhibits an herbicide safening effect, which is measured by an increase of from about 1% to about 98%, from about 1% to about 90%, from about 1% to about 50%, or from about 1% to about 25% dry plant weight of plants treated with the herbicide safener composition compared to plants that were only treated with the herbicide compositions. In some embodiments, the herbicide safener composition exhibits an herbicide safening effect, which is measured by an increase of from about 1% to about 300%, from about 1% to about 200%, from about 1% to about 100%, from about 1% to about 50%, or from about 1% to about 30% leaf area of plants treated with the herbicide safener composition compared to plants that were only treated with the herbicide composition.

In some embodiments, the herbicide safener composition exhibits an herbicide safening effect on one or more particular types of plants of cultivated crops, wherein the herbicide safening effect is measured by a decrease of at least about 1%, 10%, 20%, 30%, 40%, 50%, 60%, 70%, 80%, 90%, 95% or about 98% of phytotoxicity of plants treated with the herbicide safener composition compared to plants that were only treated with the herbicide composition.

The effective amount of PGA and/or 2-oxoglutaramate to cause such an herbicide safening effect can vary depending on various factors known to a person skilled in the art. Such factors include, but are not limited to, the type of crop to be protected, the type of herbicide composition being applied, the type of application method being used, the type of formulation being used, additional compositions being present in the herbicide safener composition, environmental factors (such as atmospheric temperatures and/or moisture content prior, during, and post application), soil characteristics (such as pH, heavy metal content, nutrient content, microbial activity, granularity, composition (e.g., clay and/or sandy)), and the like. In some embodiments, the effective amount of PGA and/or 2-oxoglutamarate to cause an herbicide safening effect ranges from about 0.05 to about 250 grams/hectare (g/ha), from about 0.05 to about 150 g/ha, from about 0.05 to about 100 g/ha, from about 0.05 to about 25 g/ha, from about 0.05 to about 10 g/ha, from about 0.05 to about 5 g/ha, from about 0.05 to about 1 g/ha, from about 0.05 to about 0.5 g/ha, or from about 0.05 to about 0.42 g/ha.

In some embodiments, the compositions include those where the PGA is stereochemically enhanced or purified. The commercially available pyroglutamic acid, synthesized by a bacterial fermentation process, has a stereochemistry ratio of approximately 60:40 of the L isomer to the D isomer. In some embodiments, the herbicide safening compositions described herein contain L and D isomers of pyroglutamic acid in various ratios and contribute to the efficacy of such compositions in exhibiting herbicide safening properties. The pyroglutamic acid can be in the forms described in U.S. Pat. Nos. 6,593,275; 6,831,040; 8,802,595; and 8,551,917, each of which is hereby incorporated by reference in its entirety.

In some embodiments, the pyroglutamic acid (PGA) is L-pyroglutamic acid. In some embodiments, the pyroglutamic acid is a mixture of L- and D-pyroglutamic acid. In these embodiments, the ratio of L to D is from about 80:20 to about 97:3. In certain embodiments, the total pyroglutamic acid is supplied as a ratio of L to a mixture of D/L, such as, 3-4.5:1 (D:D/L).

The amount of PGA and/or 2-oxoglutamarate present in the herbicide safener composition can vary. In some embodiments, the herbicide safener composition comprises PGA and/or 2-oxoglutamarate in an amount of from about 1% to about 50%, from about 5% to about 45%, from about 10% to about 40%, from about 15% to about 35%, or from about 20% to about 30% by weight based on the total weight of the herbicide safener composition.

In some embodiments, the herbicide safener composition comprises PGA and/or 2-oxoglutamarate in an amount of from about 1% to about 30%, from about 5% to about 25%, from about 8% to about 20%, from about 12% to about 25%, or from about 15% to about 23% by weight based on the total weight of the herbicide safener composition. In some embodiments, the herbicide safener composition comprises PGA and/or 2-oxoglutamarate in an amount of from about 15% to about 50%, from about 20% to about 50%, from about 25% to about 50%, from about 25% to about 45%, from about 30% to about 45%, or from about 30% to about 40% by weight based on the total weight of the herbicide safener composition.

In some embodiments, the concentration of the PGA and/or 2-oxoglutamarate in the herbicide safener composition can vary. In some embodiments, the herbicide safener composition comprises PGA and/or 2-oxoglutamarate at a concentration ranging from about 0.1 g/L to about 1 g/L (or 1 g/L), from about 0.1 g/L to about 0.75 g/L, from about 0.1 g/L to about 0.5 g/L, or from about 0.1 g/L to about 0.2 g/L. In some embodiments, the herbicide safener composition comprises PGA and/or 2-oxoglutamarate at a concentration of less than about 2 g/L, 1.75 g/L, 1.5 g/L, 1.25 g/L, 1.0 g/L, 0.75 g/L, 0.5 g/L, 0.25 g/L, or less than 0.1 g/L.

In some embodiments, the herbicide safener composition as disclosed herein exhibits little to no impedance on the controlling effect on the growth of unwanted vegetation of the herbicide composition disclosed herein. In some embodiments, the herbicide safener composition exhibits less than about 10%, 9%, 8%, 7%, 6%, 5%, 4%, 3%, 2%, or less than 1% of impedance on the controlling effect on the growth of unwanted vegetation of the herbicide composition disclosed herein.

In some embodiments, the pyroglutamic acid (PGA) and/or 2-oxoglutamarate is in a free base form. In some embodiments, the PGA and/or 2-oxoglutamarate is not in its free base form but in a salt form. Exemplary salts of PGA and/or 2-oxoglutamarate include any salt forms known in the art, such as, but not limited to, ammonia, sodium, potassium, calcium, and the like. Derivatives of pyroglutamic acid (PGA) also include its salts. The neutral salt is the preferred derivative.

In some embodiments, the PGA and/or 2-oxoglutamarate is neat. In some embodiments, the PGA is not neat but is a PGA-containing commercially available composition. Exemplary PGA-containing commercially available compositions include, but are not limited to, TAKE-OFF™ (for example, TAKE OFF Calci-Phite®, TAKE OFF Magnesium®, TAKE OFF PGA®, TAKE OFF Phite MZ®, TAKE OFF Sulfone®, TAKE OFF® P+K) and TAKE OFF BOOSTER™ In some embodiments, the PGA and/or 2-oxoglutamarate is formulated with an organic solvent to render a PGA and/or 2-oxoglutamarate-containing formulation as is described in more detail below.

### B. Herbicide Composition

The herbicide composition as disclosed herein comprises an herbicide selected from a lipid synthesis inhibitor, an amino acid synthesis inhibitor, a growth regulator inhibitor, a photosynthesis inhibitor, a nitrogen metabolism inhibitor, a pigment inhibitor, a cell membrane disruptor, a seedling root growth inhibitor, a seedling growth inhibitor, and a combination thereof. In some embodiments, the herbicide composition comprises an herbicide selected from a lipid synthesis inhibitor, an amino acid synthesis inhibitor, a growth regulator inhibitor, a photosynthesis inhibitor, a nitrogen metabolism inhibitor, a seedling root growth inhibitor, and a combination thereof. In some embodiments, the herbicide composition comprises an herbicide selected from a lipid synthesis inhibitor, a growth regulator inhibitor, an amino acid synthesis inhibitor, a nitrogen metabolism inhibitor, a seedling root growth inhibitor, and a combination thereof. In some embodiments, the herbicide composition comprises an herbicide selected from a lipid synthesis inhibitor, a growth regulator inhibitor, an amino acid synthesis inhibitor, a nitrogen metabolism inhibitor, and a combination thereof.

In some embodiments, the lipid synthesis inhibitor is selected from an aryloxyphenoxypropionate, a cyclohexanedione, a phenylpyrazolin, and a combination thereof. In some embodiments, the lipid synthesis inhibitor is selected from clodinafob, cyhalofob, fenoxaprop, fluazifop, quizalofop, clethodim, sethoxydim, pinoxaden, or a combination thereof. In some embodiments, the lipid synthesis inhibitor is present in a commercially available formulation such as, but not limited to, Discover® NG, Clincher®, Ricestar®, Tecoma®, Fusilade® DX, Assure® II, Targa®, Select® Max, Poast®, Poast® Plus, and Axial® XL.

In some embodiments, the amino acid synthesis inhibitor is selected from an aimidazoline, a pyrimidinylthiobenzoic acid, a sulfonylaminocarbonyltriazolinone, a sulfonylurea, a triazolopyrimidine, an organophosphorus, and a combination thereof. In some embodiments, the amino acid synthesis inhibitor is selected from imazamox, imazapic, imazaquin, imazethapyr, bispyribac, pyrithiobac, flucarbazone, propoxycarbazone, thiencarbazone, bensulfuron, chlorimuron, chlorsulfuron, halosulfuron, iodosulfuron, mesosulfuron, metsulfuron, nicosulfuron, orthosulfamuron, primisulfuron, prosulfuron, rimsulfuron, sulfosulfuron, thifensulfuron, triasulfuron, tribenuron, trifloxysulfuron, triflusulfuron, cloransulam, florasulam, flumetsulam, penoxsulam, pyroxsulam, glyphosate, and a combination. In some embodiments, the amino acid synthesis inhibitor is present in a commercially available product such as, but not limited to, Raptor®, Beyond®, Clearmax®, Plateau®, Scepter®, Pursuit®, Newpath®, Regiment®, Staple®, Everest®, Pre-Pare®, Sierra®, Olympus®, Varro®, Londax®, Classic®, Glean®, Permit®, Autumn®, Osprey®, Ally®, Accent Q®, Zest®, Strada®, Beacon®, Peak®, Resolve®, Matrix®, Maverick®, Harmony®, Amber®, Express®, Envoke®, UpBeet®, FirstRate®, Orion®, Python®, Accolade®, Grasp®, PowerFlex® HL, Roundup®, and Touchdown®.

In some embodiments, the growth regulator inhibitor is selected from an arylpicolinate, a benzoic acid, a carboxylic acid, a phenoxy compound, a semicarbazone, and a combination thereof. In some embodiments, the growth regulator is selected from halauxifen, dicamba, aminopyralid, clopyralid, fluroxypyr, triclopyr, quinclorac, 2,4-D, MCPA, quinmerac, diflufenzopyr, and a combination thereof. In some embodiments, the growth regulator inhibitor is present in a commercially available product such as, but not limited to, Arylex®, Elevore®, Banvel®, Clarity®, DiFlexx®, Engenia®, FeXapan®, XtendiMax®, Milestone®, Stinger®, Starane®, Grandstand®, Facet®, 2,4-D®, MCPA®, and Status®.

In some embodiments, the photosynthesis inhibitor is selected from a phenylcarbamate, a triazine, a triazinone, a uracil, a benzothiadiazole, a nitrile, an amide, a urea, and a combination thereof. In some embodiments, the photosynthesis inhibitor is selected from desmedipham, phenmedipham, atrazine, prometryn, simazine, hexazinone, metribuzin, terbacil, bentazon, bromoxynil, propanil, diuron, metamitron, fluometuron, linuron, and a combination thereof. In some embodiments, the photosynthesis inhibitor is present in a commercially available product such as, but not limited to, Betenex®, Betamix®, AAtrex®, Caparol®, Princep®, Velpar®, Metribuzin®, Sinbar®, Basagran®, Buctril®, SuperWham®, Direx®, Karmex®, Cotoran®, Lorox®, and Linex®.

In some embodiments, the nitrogen metabolism inhibitor is an organophosphorus such as, but not limited to, glufosinate. In some embodiments, the nitrogen metabolism inhibitor is present in a commercially available product such as, but not limited to, Liberty® and/or Cheetah®.

In some embodiments, the pigment inhibitor is selected from an isoxazolidinone, an isoxazole, a pyrazole, a pyrazolone, a triketone, and a combination thereof. In some embodiments, the pigment inhibitor is selected from fluridone, clomazone, isoxaflutole, pyrasulfotole, topramezone, mesotrione, tembotrione, bicyclopyrone, and a combination thereof. In some embodiments, the pigment inhibitor is pesent in a commercially available product such as, but not limited to, Sonar®, Command®, Balance Flexx®, Huskie®, Armezon®, Impact®, Callisto®, Laudis®, and Acuron®.

In some embodiments, the cell membrane disruptor is selected from an aryl triazinone, a dephenylether, a N-phenylphthalimide, a pyrimidinedione, a bipyridylium and a combination thereof. In some embodiments, the cell membrane disruptor is selected from sulfentrazone, carfentrazone, fluthiacet, acifluorfen, fomesafen, lactofen, flumiclorac, flumioxazin, saflufenacil, diquat, paraquat, and a combination thereof. In some embodiments, the cell membrane is present in a commercially available product such as, but not limited to, Spartan®, Aim®, Cadet®, Ultra Blazer®, Flexstar®, Reflex®, Cobra®, Phoenix®, Resource®, Valor®, Rowel®, Sharpen®, Reglone®, and Gramoxone® SL.

In some embodiments, the seedling root growth inhibitor is selected from a benzamide, a dintiroaniline, and a combination thereof. In some embodiments, the seedling root growth inhibitor is selected from pronamide, ethalfluralin, pendimethalin, trifluralin, and a combination thereof. In some embodiments, the seedling root growth inhibitor is present in a commercially available product such as, but not limited to, Kerb®, Sonalan®, Prowl® H₂O, and Treflan®.

In some embodiments, the seedling shoot growth inhibitor is selected from a thiocarbamate, a chloroacetamide, an oxyacetamde, a pyrazole, a benzofurane and a combination thereof. In some embodiments, the seedling shoot growth inhibitor is selected from butylate, cycloate, EPTC, thiobencarb, triallate, acetochlor, alachlor, s-metolachlor, dimethenamid-P, flufenacet, pyroxasulfone, ethofumesate, and a combination thereof. In some embodiments, the seedling shoot growth inhibitor is present in a commercially available product such as, but not limited to, Sutan® +, Ro-Neet®, Eradicane®, Eptam®, Bolero®, Far-Go®, Degree®, Harness®, Surpass® NXT, Topnotch®, Warrant®, Intrro®, Micro-Tech®, Dual Magnum®, Outlook®, Define®, Zidua®, and Nortron®.

In some embodiments, the herbicide composition comprises an herbicide composition that is specifically used to control unwanted vegetation present in target areas of cultivated crops selected from specialty crops, sugar crops and/or legumes. A skilled artisan would be aware of what herbicides to use in treating target areas containing such crops against the growth of unwanted vegetation (e.g., weeds).

For example, in some embodiments, the herbicide composition comprises an herbicide used to treat target areas containing sugar crops and is selected from, but not limited to, 2,4-D, MCPA, dicamba, aminopyralid, clopyralid, picloram, triclopyr, halauxifen, aminocyclopyrachlor, quinclorac, imazamox, imazapyr, imazathepyr, chlorimuron, halosulfuron, mesosulfuron, rimsulfuron, sulfosulfuron, thifensulfuron, tribenuron, triflusulfuron, flucarbazone, propoxycarbazone, thiencarbazone, chloransulam, flumetsulam, pyroxsulam, glyphosate, clethodim, sethoxydim, clodinafob-P, fenoxaprop-P, fluzifob-P, quizalofob, pinoxaden, ethalfluralin, pendimethalin, trifluralin, acetachor, s-metolachlor, dimethenamid-P, pyroxasulfone, EPTC, triallate, cycloate, ethofumesate, linuron, diuron, tebuthiuron, terbacil, bentazon, bromoxynil, desmediphan, phenmedipham, glufonsinate, clomazone, isoxaflutole, mesotrione, tembotrione, bicyclopyrone, topramezone, pyrasulfotole, acifluorfen, lactofen, fomesafen, fluthiacet, flumioxazin, saflufenacil, sulfentrazone, carfentrazone, paraquat, atrazine, clomazone, diuron, hexazinone, pendimethalin, metribuzin, terbacil, sulfentrazone, trifluralin, flumioxazin, and a combination thereof.

In some embodiments, the herbicide composition comprises an herbicide used to treat target areas containing legumes and is selected from, but not limited to, carfentrazone, quizalofob, bentazon, clomazone, napropamide, EPTC, paraquat, alachor, saflufenacil, imazethapyr, dimethenamid-P, pendimethalin, halosulfron, sethoxydim, imazamox, fomesafen, glyphosate, clethodim, saflufenacil, ethalfluralin, sulfentrazone, trifluralin, and a combination thereof.

In some embodiments, the herbicide composition comprises and herbicide selected from glyphosate, glufosinate, 2,4-D, dicamba, quinclorac, quinmerac, metamitron, phenmedipham, ethofumesate, and a combination thereof.

In some embodiments, the herbicide composition is a blend of esterified vegetable oils and nonionic surfactants such as HASTEN®.

In some embodiments, the herbicide composition is a non-selective herbicide composition (e.g., broad-spectrum herbicide composition). A skilled person in the art would understand that the degree of selectivity of the herbicide composition can vary and is often quantified in terms of the extent of injury to the crops when exposed to the herbicide composition disclosed herein. In some embodiments, the disclosed herbicide composition is a non-selective herbicide composition, wherein the proportion of crop plants being injured when contacted with the herbicide composition is at least 10%, 20%, 30%, 40%, or 50%, based on the total number of crop plants in a given crop plant population.

In some embodiments, the herbicide composition is a contact herbicide. Such herbicides do not translocate or move through the (unwanted) plant. Only portions of the (unwanted) plant that are contacted by this type of herbicide are killed. Thus, these types of herbicides are only effective when applied to the plant directly and not to the soil.

In some embodiments, the herbicide composition is a systemic herbicide composition. Systemic herbicides are understood to be absorbed by foliage or roots and translocated to other parts of the plant. Further, such herbicides are able to alter the normal biological function of the plant by interfering with certain biochemical reactions. They can be applied to foliage or soil and are able to translocate to their site of action once they enter the (unwanted) plant.

It will be understood by a person of skill in the art that the herbicidally effective amount of the herbicide composition can vary as it is depending upon factors such as the type of unwanted vegetation being targeted by the herbicide composition, the type of application method being used, the type of formulation being used, additional components present in the herbicide composition (e.g., additional pesticides), environmental factors (such as atmospheric temperature and/or moisture content prior, during, and post application, soil characteristics such as pH, heavy metal content, nutrient content, microbial activity, granularity, composition (e.g., clay and/or sandy) etc.), mode of action and/or selectivity of the herbicide composition being applied, and the like. In some embodiments, the herbicide composition is applied to a target area in an herbicidally effective amount ranging from about 0.005 to about 500 kilograms/hectare (kg/ha), from about 0.05 to about 500 kg/ha, from about 0.5 to about 500 kg/ha, from about 1 to about 500 kg/ha, from about 5 to about 400 kg/ha, from about 5 to about 300 kg/ha, from about 10 to about 300 kg/ha, from about 100 to about 250 kg/ha, or from about 150 to about 200 kg/ha.

In some embodiments, the herbicide composition as disclosed herein exhibits a controlling effect on the growth of one or more particular types of unwanted vegetation by at least 10%, 20%, 30%, 40%, 50%, 60%, 70%, 80%, 90%, 95% or 98% based on a given population of plants of unwanted vegetation present in the target area. In some embodiments, the herbicide composition as disclosed herein inhibits growth of one or more particular types of unwanted vegetation by at least 10%, 20%, 30%, 40%, 50%, 60%, 70%, 80%, 90%, 95% or 98%, wherein growth is measured as a function of the size and/or height of the plant and/or the foliage of the plant. In some embodiments, the herbicide composition as disclosed herein inhibits reproduction of one or more particular types of unwanted vegetation by at least 10%, 20%, 30%, 40%, 50%, 60%, 70%, 80%, 90%, 95%, or 98% based on a given population of unwanted vegetation present in the target area. In some embodiments, the herbicide composition as disclosed herein kills one or more particular types of unwanted vegetation by at least 10%, 20%, 30%, 40%, 50%, 60%, 70%, 80%, 90%, 95%, or 98% based on a given population of unwanted vegetation present in the target area.

### III. Formulations

The disclosed herbicide composition and herbicide safener composition can be used in their unmodified original form (e.g., neat) or can be formulated into formulations containing an organic solvent and/or other additional ingredients to generate formulations as is described in more detail below.

### A. Herbicide Safener Formulation

The disclosed herbicide safener composition can be used in its unmodified original form (e.g., neat) or can be formulated into an herbicide safener formulation comprising one or more auxiliaries selected from extenders, carriers, solvents, surfactants (surface-active agents), stabilizers, anti-foaming agents, anti-freezing agents, preservatives, biocides, antioxidants, viscosity modifiers, suspending agents, light absorbers, corrosion inhibitors, fragrances, pH-modifying substances, glidants, lubricants, plasticizers, complexing agents, colorants, thickeners, solid adherents, fillers, wetting agents, dispersing agents, lubricants, anticaking agents, deformers and diluents. Such auxiliaries are known in the art and are commercially available. Their use in the formulation of the disclosed herbicidal compositions will be apparent to a person skilled in the art.

In some embodiments, the herbicide safener composition is formulated into a formulation comprising one or more organic solvents. Suitable organic solvents include all polar and non-polar organic solvents usually employed for formulation purposes. Preferably the solvents are selected from ketones, e.g., methyl-isobutyl-ketone and cyclohexanone, amides, e.g., dimethyl formamide, and alkanecarboxylic acid amides, e.g., N,N-dimethyl decaneamide and N,N-dimethyl octanamide, furthermore cyclic solvents, e.g., N-methyl-pyrrolidone, N-octyl-pyrrolidone, N-dodecylpyrrolidone, N-octyl-caprolactame, N-dodecyl-caprolactame and butyrolactone, furthermore strong polar solvents, e.g., dimethylsulfoxide, and aromatic hydrocarbons, e.g., xylol, SOLVESSO™, mineral oils, e.g., white spirit, petroleum, alkyl benzenes and spindle oil, also esters, e.g., propyleneglycol-monomethylether acetate, adipic acid dibutylester, acetic acid hexylester, acetic acid heptylester, citric acid tri-n-butylester and phthalic acid di-n-butylester, and also alcohols, e.g., benzyl alcohol and 1-methoxy-2-propanol. Useful liquid solvents are essentially: aromatics such as xylene, toluene or alkylnaphthalenes, chlorinated aromatics and chlorinated aliphatic hydrocarbons such as chlorobenzenes, chloroethylenes or dichloromethane, aliphatic hydrocarbons such as cyclohexane or paraffins, for example, mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, and also water. The solvent can be present in an amount from about 1% to about 99% w/w, for example, about 5% to about 75%, about 15% to about 70%, about 25% to about 65%, about 35% to about 60%, about 40% to about 55%, or about 45% to about 50%. In some embodiments, the solvent is water.

In some embodiments, the herbicide safener formulation can include carriers and/or fillers. A carrier is a natural or synthetic, organic or inorganic substance for admixing or combining with the compositions for better applicability, in particular for application to plants or plant parts. The carrier, which may be solid or liquid, is generally inert and should be suitable for use in agriculture. Useful solid or liquid carriers include, for example, ammonium salts and natural rock dusts, such as kaolins, clays, talc, chalk, quartz, attapulgite, montmorillonite or diatomaceous earth, and synthetic rock dusts, such as finely divided silica, alumina and natural or synthetic silicates, resins, waxes, solid fertilizers, water, alcohols, especially butanol, organic solvents, mineral and vegetable oils, and derivatives thereof. Mixtures of such carriers can likewise be used.

Suitable solid fillers and carriers include inorganic particles, e.g., carbonates, silicates, sulphates and oxides with an average particle size of between 0.005 and 20 μm, preferably of between 0.02 to 10 μm, for example, ammonium sulphate, ammonium phosphate, urea, calcium carbonate, calcium sulphate, magnesium sulphate, magnesium oxide, aluminum oxide, silicondioxide, so-called fine-particle silica, silica gels, natural or synthetic silicates, and alumosilicates and plant products like cereal flour, wood powder/sawdust and cellulose powder.

Useful solid carriers include, for example, crushed and fractionated natural rocks such as calcite, marble, pumice, sepiolite, dolomite, and synthetic granules of inorganic and organic meals, and also granules of organic material such as sawdust, coconut shells, maize cobs and tobacco stalks.

Useful liquefied gaseous extenders or carriers are those liquids which are gaseous at standard temperature and under standard pressure, for example, aerosol propellants such as halohydrocarbons, and also butane, propane, nitrogen and carbon dioxide.

In some embodiments, the herbicide safener formulation can include other additional components, for example, protective colloids, binders, extenders, adhesives, tackifiers, thickeners, thixotropic substances, penetrants, stabilizers, sequestrants, surfactants, complexing agents, etc. In general, the herbicide safener compositions can be combined with any solid or liquid additive commonly used for formulation purposes.

In the formulations, it is possible to use tackifiers such as carboxymethylcellulose, and natural and synthetic polymers in the form of powders, granules or lattices, such as gum arabic, polyvinyl alcohol and polyvinyl acetate, or else natural phospholipids, such as cephalins and lecithins, and synthetic phospholipids. Further additives may be mineral and vegetable oils. If the extender used is water, it is also possible to employ, for example, organic solvents as auxiliary solvents.

The formulations may additionally comprise surfactants. Useful surfactants are emulsifiers and/or foam formers, dispersants or wetting agents having ionic or nonionic properties, or mixtures of these surfactants. Examples of these are salts of polyacrylic acid, salts of lignosulphonic acid, salts of phenolsulphonic acid or naphthalenesulphonic acid, polycondensates of ethylene oxide with fatty alcohols or with fatty acids or with fatty amines, substituted phenols (preferably alkylphenols or arylphenols), salts of sulphosuccinic esters, taurine derivatives (preferably alkyl taurates), phosphoric esters of polyethoxylated alcohols or phenols, fatty esters of polyols, and derivatives of the compounds containing sulphates, sulphonates and phosphates, for example, alkylaryl polyglycol ethers, alkylsulphonates, alkylsulphates, arylsulphonates, protein hydrolysates, lignosulphite waste liquors and methylcellulose. The presence of a surfactant is necessary if one of the active ingredients and/or one of the inert carriers is insoluble in water and when application is affected in water. The proportion of surfactants is between about 5% and about 40% by weight of the composition. In some embodiments, the proportion of surfactants is between about 10% and about 30% or between about 15% and about 25% by weight of the composition. In some embodiments, the proportion of surfactant is less than about 40%, less than about 30%, less than about 25%, less than about 20%, less than about 10%, or less than about 5% by weight of the composition. In some embodiments, the proportion of surfactants is more than about 5%, more than about 10%, more than about 20%, more than about 25%, or more than about 30% by weight of the composition.

Suitable surfactants (adjuvants, emulsifiers, dispersants, protective colloids, wetting agent and adhesive) include all common ionic and nonionic substances, for example, ethoxylated nonylphenols, polyalkylene glycolether of linear or branched alcohols, reaction products of alkyl phenols with ethylene oxide and/or propylene oxide, reaction products of fatty acid amines with ethylene oxide and/or propylene oxide, fatty acid esters, alkyl sulfonates, alkyl sulphates, alkyl ethersulphates, alkyl etherphosphates, arylsulphate, ethoxylated arylalkylphenols (e.g., tristyryl-phenol-ethoxylates, ethoxylated and propoxylated arylalkylphenols like sulphated or phosphated arylalkylphenol-ethoxylates and -ethoxy- and -propoxylates). Further examples are natural and synthetic, water soluble polymers, e.g., lignosulphonates, gelatine, gum arabic, phospholipides, starch, hydrophobic modified starch and cellulose derivatives, in particular cellulose ester and cellulose ether, polyvinyl alcohol, polyvinyl acetate, polyvinyl pyrrolidone, polyacrylic acid, polymethacrylic acid and co-polymerisates of (meth)acrylic acid and (meth)acrylic acid esters, and co-polymerisates of methacrylic acid and methacrylic acid esters which are neutralized with alkalimetal hydroxide and also condensation products of optionally substituted naphthalene sulfonic acid salts with formaldehyde.

In some embodiments, the formulations may comprise colorants and dyes. Dyes include inorganic pigments, for example, iron oxide, titanium oxide and Prussian blue, and organic dyes such as alizarin dyes, azo dyes and metal phthalocyanine dyes, and trace nutrients such as salts of iron, manganese, boron, copper, cobalt, molybdenum, and zinc.

Antifoams which may be present in the formulations include, e.g., silicone emulsions, long-chain alcohols, fatty acids and their salts as well as fluoroorganic substances and mixtures thereof.

Thickeners include polysaccharides, e.g., xanthan gum or veegum, silicates, e.g., attapulgite, bentonite and fine-particle silica.

The amounts of active ingredients (e.g., PGA and/or 2-oxoglutamarate) in the compositions and formulations are generally between 0.05 and 99% by weight, between about 0.01% and about 98% by weight, between about 0.1% and about 95% by weight, between about 0.5% and about 90% by weight, between about 1% and about 80% by weight, between about 10% and about 75% by weight, between about 20% and about 70% by weight, between about 25% to about 65% by weight, or between about 30% and about 50% by weight. Alternatively, a formulation can contain active ingredients at a concentration from about 0.1 g/L to about 1 g/L (or 1 g/L), from about 0.1 g/L to about 0.75 g/L, from about 0.1 g/L to about 0.5 g/L, or from about 0.1 g/L to about 0.2 g/L. In some embodiments, the herbicide safener composition compries PGA at a concentration of less than about 2 g/L, 1.75 g/L, 1.5 g/L, 1.25 g/L, 1.0 g/L, 0.75 g/L, 0.5 g/L, 0.25 g/L, or less than 0.1 g/L.

The formulations mentioned can be prepared in a manner known, for example, by mixing the active ingredients with at least one customary extender, solvent or diluent, adjuvant, emulsifier, dispersant, and/or binder or fixative, wetting agent, water repellent, if appropriate, desiccants and UV stabilizers, and, if appropriate, dyes and pigments, antifoams, preservatives, such as bronopol in an amount of about 0.04%, inorganic and organic thickeners, adhesives, further processing auxiliaries, and also water. Depending on the formulation type to be prepared, further processing steps are necessary, e.g., wet grinding, dry grinding, and granulation. A skilled person in the art would also be aware of the type and combination of auxilaries that would be required to optimize the herbicide safener formulation based on the properties just listed and additional properties apparent to a skilled person in the art.

The herbicide safener formulation can be in the form of a liquid or a solid. Examples of liquid and solid herbicide formulations include, but are not limited to, soluble liquids (SF), emulsifiable concentrates (EC), wettable powders (WP), dry flowable (DF), flowables (F), water soluble powders (SP), ultra-low-volume concentrate (ULV), suspension concentrates (SC), aqueous suspensions (AS), microencapsulated suspension (ME or MT), capsule suspension (CS), granules (G), or pellets (P). In some embodiments, the herbicidal composition is in the form of a soluble salt, which is water soluble and requires little to no agitation to stay in solution. These types of formulations are often referred to as solutions (S), soluble concentrates (SC), liquid (L), and water soluble concentrates (WSC). In some embodiments, these types of formulations (e.g., S) are “ready-to-use.” In some embodiments, the formulation is a tank mix formulation or a premix formulation. In some embodiments, these types of formulations (e.g., SC, WSC) are diluted with water prior to use. In some embodiments, the herbicide composition disclosed herein is in the form of a granule (G).

In some embodiments, the herbicide safener formulation is in a form selected from a liquid, solid, aerosol, capsule suspension, cold-fogging concentrate, warm-fogging concentrate, encapsulated granule, fine granule, flowable concentrate, ready-to-use solution, dustable powder, emulsifiable concentrate, oil-in-water emulsion, water-in-oil emulsion, macrogranule, microgranule, oil-dispersible powder, oil-miscible flowable concentrate, oil-miscible liquid, gas (under pressure), gas-generating product, foam, paste, suspension concentrate, soluble concentrate, suspension, wettable powder, soluble powder, dust and granule, water-soluble and water-dispersible granule or tablet, water-soluble and water-dispersible powder, wettable powder, microencapsulation in polymeric substances and in coating materials. For purposes of the present disclosure, “ready-to-use” refers to compositions that are not in a concentrate form but rather which may be applied without modification of the relative amounts of components within the product. They can be applied with a suitable apparatus to the plant, and also commercial concentrates which have to be diluted with water prior to use, e.g., a tank mix. Customary applications are, for example, dilution in water and subsequent spraying of the resulting spray liquid, application after dilution in oil, or direct application without dilution.

In some embodiments, the herbicide safener formulation is in the form of a concentrate for end-use tank mixing. In some embodiments, the herbicide safener formulation is a type selected from the group consisting of emulsifiable concentrate, soluble concentrate, oil-in-water emulsion, microemulsion, oil-based suspension concentrate, suspension concentrate, and dispersible concentrate. In some embodiments, the formulation is an emulsifiable concentrate or a soluble concentrate.

### B. Herbicide Formulations

The disclosed herbicide composition can be used in its unmodified original form (e.g., neat) or can be formulated into an herbicide formulation comprising one or more auxiliaries selected from extenders, carriers, solvents, surfactants (surface-active agents), stabilizers, anti-foaming agents, anti-freezing agents, preservatives, biocides, antioxidants, viscosity modifiers, suspending agents, light absorbers, corrosion inhibitors, fragrances, pH-modifying substances, glidants, lubricants, plasticizers, complexing agents, colorants, thickeners, solid adherents, fillers, wetting agents, dispersing agents, lubricants, anticaking agents, deformers and diluents. Such auxiliaries are known in the art and are commercially available. Their use in the formulation of the disclosed herbicide compositions will be apparent to a person skilled in the art.

The amount of herbicide composition present in the herbicide formulation as disclosed herein can vary. In some embodiments, the herbicide composition is present in an amount ranging from about 0.10% to about 99.9%, from about 10% to about 90%, from about 20% to about 80%, from about 30% to about 70%, or from about 40% to about 60% by weight based on the total weight of the herbicide formulation.

In some embodiments, the herbicide formulation contains one or more auxilaries selected from carriers and/or solvents. Exemplary carriers and/or solvents that can be used in liquid herbicide formulations include, but are not limited to, water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, A/, A/-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, A/-methyl-2-pyrrolidone and the like.

The amount of the liquid carrier(s) and/or solvent(s) present in a liquid herbicide formulation can vary. In some embodiments, the liquid carrier(s) and/or solvent(s) are present in an amount ranging from about 0.1% to about 99.9%, from about 10% to about 90%, from about 20% to about 80%, from about 30% to about 70%, or from about 40% to about 60% by weight based on the total weight of the liquid herbicide formulation.

In some embodiments, the herbicide formulation contains one or more auxiliaries selected from carriers that are used in solid herbicide formulations. Exemplary solid carriers include, but are not limited to, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

The amount of the solid carrier(s) present in a solid herbicide formulation can vary. In some embodiments, the solid carriers are present in an amount ranging from about 0.1% to about 99.9%, from about 10% to about 90%, from about 20% to about 80%, from about 30% to about 70%, or from about 40% to about 60% by weight based on the total weight of the solid herbicide formulation.

In some embodiments, the herbicide formulation contains surfactants (surface-active agents). Surfactants are designed to improve the dispersing/emulsifying, absorbing, spreading, sticking and/or pest-penetrating properties of a liquid herbicide formulation such as, e.g., a spray mixture. Pure water will stand as a droplet, with a small area of contact with the waxy leaf surface of an unwanted plant/vegetation. Water droplets containing a surfactant will spread in a thin layer over a waxy leaf surface. Because the effectiveness of postemergence herbicide compositions is greatly influenced by plant factors of the unwanted plant/vegetation such as age, size and the growing conditions encountered before application, herbicide performance can vary. A way to minimize the variations in postemergence herbicide performance, for example, is to use an auxiliary, such as a surfactant in the spray solution containing the herbicide composition. Thus, surfactants can greatly improve the effectiveness of postemergence herbicide compositions.

Based on chemical composition, surfactants can be divided into the following five groupings: 1. nonionic surfactants (NIS); 2. crop oil concentrates (COC); 3. nitrogen-surfactant blends; 4. esterified seed oils; and 5. organosilicones. NIS are comprised of linear or nonyl-phenol alcohols and/or fatty acids. This class of surfactant reduces surface tension and improves spreading, sticking and herbicide uptake. Crop oil concentrates are composed of a blend of paraffinic-based petroleum oil and surfactants. This surfactant class reduces surface tension and improves herbicide uptake and leaf surface spreading. Nitrogen-surfactant blends consist of premix combinations of various forms of nitrogen and surfactants. They generally are used with herbicides recommending the addition of ammonium sulfate or 28% nitrogen. These surfactants reduce surface tension and improve leaf surface spreading. Esterified seed oils are produced by reacting fatty acids from seed oils (corn, soybean, sunflower, and canola) with an alcohol to form esters. The methyl or ethyl esters produced by this reaction are combined with surfactants/emulsifiers to form an esterified seed oil. These surfactants reduce surface tension and improve herbicide uptake by improving herbicide distribution on the leaf surface. Organosilicones are usually silicone/surfactant blends of silicone to nonionic or other surfactants; a few within this classification are composed entirely of silicone. These surfactants provide a tremendous reduction in surface tension and spread more than conventional surfactants. In addition, this class of surfactant provides improved effectiveness through maximum rainfastness.

The addition of oils as surfactants in spray solutions is a relatively common practice, depending on the type of herbicide and the weeds involved. As such, it is important to note that not all oils provide the same surfactant effectiveness. In general, three types of oils are commonly referred to as surfactants: vegetable seed oils, crop oil concentrates, and esterified seed oils. Vegetable seed oils are a blend of vegetable oil (cottonseed and soybean) and surfactants. These surfactants exhibit good crop tolerance but do not have good spreading, sticking or pest-penetrating properties. Crop oil concentrates are a blend of paraffinic oil (petroleum based) and surfactants. These surfactants exhibit good spreading and penetrating properties but crop tolerance may be a problem. Esterified seed oils are comprised of a methyl or ethyl ester of a vegetable seed oil (sunflower, soybean, corn, and canola) combined with a surfactant/emulsifier. These spray solution additives have good spreading and pest-penetrating properties and convey good crop tolerance. However, these additives generally are more expensive than vegetable seed oils or crop oil concentrates.

Thus, in some embodiments, the herbicide formulation contains one or more surfactants selected from nonionic surfactants, crop oil concentrates, nitrogen-surfactant blends, esterified seed oils, organosilicones, vegetable seed oils, esterfied seed oils and a combination thereof. A skilled artisan would be aware of what surfactants to choose to optimize the action and/or efficacy of the herbicide composition, the formulation used, the application type (e.g., preplant, preemergent, and/or postemergent), application equipment used, environmental and/or human safety, environmental conditions (e.g., climate and/or soil properties) before, during and/or after application, and/or plant features of the unwanted vegetation (e.g., leaf-surface characteristics) and/or crops.

Further, a skilled person in the art would also be aware of the type and combination of auxilaries that would be required to optimize the herbicide formulation based on the properties just listed and additional properties apparent to a skilled person in the art.

In some embodiments, the herbicide composition is a commercially available herbicide composition. Such herbicide formulations are already formulated into one of the above-listed liquid or solid formulations. In some embodiments, the herbicide formulation can be used as is without any further modification. In some embodiments, the herbicide formulation is a concentrate and requires the addition of a diluent (e.g., water).

The herbicide formulation can be in the form of a liquid or a solid. Examples of liquid and solid herbicide formulations include, but are not limited to, soluble liquids (SF), emulsifiable concentrates (EC), wettable powders (WP), dry flowable (DF), flowables (F), water soluble powders (SP), ultra-low-volume concentrate (ULV), suspension concentrates (SC), aqueous suspensions (AS), microencapsulated suspension (ME or MT), capsule suspension (CS), granules (G), or pellets (P). In some embodiments, the herbicide composition is in the form of a soluble salt, which is water soluble and requires little to no agitation to stay in solution. These types of formulations are often referred to as solutions (S), soluble concentrates (SC), liquid (L), and water-soluble concentrates (WSC). In some embodiments, these types of formulations (e.g., S) are “ready-to-use.” In some embodiments, the formulation is a tank mix formulation or a premix formulation. In some embodiments, these types of formulations (e.g., SC, WSC) are diluted with water prior to use. In some embodiments, the herbicide composition disclosed herein is in the form of a granule (G).

### IV. Agricultural Compositions

Any of the described herbicide safener compositions and formulations thereof comprising PGA and/or 2-oxoglutamarate can be combined with one or more agricultural products to render an agricultural composition. Agricultural products can be selected from the group consisting of fertilizer, agriculturally active compounds, seed, compounds having urease inhibition activity, nitrification inhibition activity, pesticides, herbicides, insecticides, fungicides, miticides, other herbicide safener agents and the like. In some embodiments, the agricultural composition can include an organic solvent such as the ones already discussed above.

In some embodiments, the described herbicide safener composition may be mixed with the fertilizer products, applied as a surface coating to the fertilizer products, or otherwise thoroughly mixed with the fertilizer products. In some embodiments, in such combined fertilizer/herbicide safener composition, the fertilizer is in the form of particles having an average diameter of from about powder size (less than about 0.001 cm) to about 10 mm, more preferably from about 0.1 mm to about 5 mm, and still more preferably from about 0.15 mm to about 3 mm. The PGA and/or 2-oxoglutamarate can be present in such combined products at a level of about 0.001 g to about 20 g per 100 g fertilizer, about 0.01 to 7 g per 100 g fertilizer, about 0.08 g to about 5 g per 100 g fertilizer, or about 0.09 g to about 2 g per 100 g fertilizer. In some embodiments, PGA and liquid fertlizers can be mixe at a rate of about 0.25 to about 0.50 g/L. In some embodiments, the herbicide safener composition is used as a coating to prepare a coated solid fertilizer product. Fertilizers

In some embodiments, the agricultural product is a fertilizer. The fertilizer can be a solid fertilizer, such as, but not limited to, a granular fertilizer, and the herbicide safener composition can be applied to the fertilizer as a liquid dispersion. The fertilizer can be in liquid form, and the herbicide safener composition can be mixed with the liquid fertilizer. The fertilizers can be selected from the group consisting of starter fertilizers, phosphate-based fertilizers, fertilizers containing nitrogen, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite and/or fertilizers containing molybdenum, iron and/or sulfur-containing materials. In some embodiments, the fertilizer is an NPK fertilizer containing nitrogen, phosphorus and potassium (e.g., NPK 6-24-6 and/or NPK 15-5-15). In some embodiments, the fertilizer is or contains urea, and/or ammonia, including anhydrous ammonia fertilizer. In some embodiments, the fertilizer comprises plant-available nitrogen, phosphorous, potassium, sulfur, calcium, magnesium or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of. Fe, Mn, Mg, Zn, Cu, Ni, V, Mo, and Ca. In some embodiments, the fertilizer comprises gypsum, kieserite group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material).

In some embodiments, the herbicide safener composition is combined with any suitable liquid or dry fertilizer for application to fields and/or crops.

The described herbicide safener composition, or formulations thereof, can be applied with the application of a fertilizer. The herbicide safener composition can be applied prior to, subsequent to, or simultaneously with the application of fertilizers.

Herbicide safener-containing fertilizer compositions can be applied in any manner which will benefit the crop of interest. In some embodiments, a fertilizer composition is applied to growth mediums in a band or row application. In some embodiments, the compositions are applied to or throughout the growth medium prior to seeding or transplanting the desired crop plant. In some embodiments, the compositions can be applied to the root zone of growing plants. In some embodiments, the compositions can be applied directly adjacent to the growing plants. In some embodiments, the compositions can be applied to one or more parts of the plant (e.g., foliar application methods). In some embodiments, the herbicide safener composition is applied in a different manner than the fertilizer composition. In some embodiments, the herbicide safener composition is applied in the same manner as the fertilizer composition.

### A. Seed

In some embodiments are described agricultural seeds coated with one or more of the described herbicide safener compositions. The herbicide safener composition can be present in the seed product at a level of from about 0.001% to about 10%, about 0.004% to about 2%, about 0.01% to about 1, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product. A seed can be, but is not limited to, wheat, barley, oat, triticale, rye, rice, maize, soybean, cotton, or oilseed rape.

### B. Other

In some embodiments are described urease-inhibiting compounds, nitrification-inhibiting compounds, pesticides, and/or other herbicide safener agents in combination with one or more of the described herbicide safener compositions to form multi-active ingredient compositions and formulations thereof. As used herein, “pesticide” refers to any agent with pesticidal activity (e.g., herbicides, insecticides, fungicides, and/or miticides) and is preferably selected from the group consisting of insecticides, herbicides, and mixtures thereof, but normally excluding materials which assertedly have plant-fertilizing effect, for example, sodium borate and zinc compounds such as zinc oxide, zinc sulfate, and zinc chloride. For a comprehensive list of pesticides, see “Farm Chemicals Handbook 2000, 2004” (Meister Publishing Co, Willoughby, OH), which is hereby incorporated by reference in its entirety. A skilled artisan would be aware of the types of urease-inhibiting compounds, nitrification-inhibiting compounds, pesticides, and/or other herbicide safener agents that are compatible with PGA present in the disclosed herbicide safener composition to form suitable multi-active ingredient compositions.

In some embodiments, the herbicide safener composition is combined with the herbicide composition disclosed herein to form a multi-active ingredient composition.

In some embodiments, the herbicide safener composition is combined with a suitable insecticide to form a multi-ingredient composition. Exemplary insecticides include, but are not limited to, 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo-DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A &B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP. DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′-DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vaniliprole, XMC, xylylcarb, zeta cypermethrin and zolaprofos.

In some embodiments, the herbicide safener composition is combined with a suitable fungicide to form a multi-ingredient composition. Exemplary fungicides include, but are not limited to, acibenzolar, acylamino acid fungicides, acypetacs, aldimorph, aliphatic nitrogen fungicides, allyl alcohol, amide fungicides, ampropylfos, anilazine, anilide fungicides, antibiotic fungicides, aromatic fungicides, aureofungin, azaconazole, azithiram, azoxystrobin, barium polysulfide, benalaxyl, benalaxyl-M, benodanil, benomyl, benquinox, bentaluron, benthiavalicarb, benzalkonium chloride, benzamacril, benzamide fungicides, benzamorf, benzanilide fungicides, benzimidazole fungicides, benzimidazole precursor fungicides, benzimidazolylcarbamate fungicides, benzohydroxamic acid, benzothiazole fungicides, bethoxazin, binapacryl, biphenyl, bitertanol, bithionol, bixafen, blasticidin-S, Bordeaux mixture, boric acid, boscalid, bridged diphenyl fungicides, bromuconazole, bupirimate, Burgundy mixture, buthiobate, sec-butylamine, calcium polysulfide, captafol, captan, carbamate fungicides, carbamorph, carbanilate fungicides, carbendazim, carboxin, carpropamid, carvone, Cheshunt mixture, chinomethionat, chlobenthiazone, chloraniformethan, chloranil, chlorfenazole, chlorodinitronaphthalene, chloroform, chloroneb, chloropicrin, chlorothalonil, chlorquinox, chlozolinate, ciclopirox, climbazole, clotrimazole, conazole fungicides, conazole fungicides (imidazoles), conazole fungicides (triazoles), copper(II) acetate, copper(II) carbonate, basic, copper fungicides, copper hydroxide, copper naphthenate, copper oleate, copper oxychloride, copper(II) sulfate, copper sulfate, basic, copper zinc chromate, cresol, cufraneb, cuprobam, cuprous oxide, cyazofamid, cyclafuramid, cyclic dithiocarbamate fungicides, cycloheximide, cyflufenamid, cymoxanil, cypendazole, cyproconazole, cyprodinil, dazomet, DBCP, debacarb, decafentin, dehydroacetic acid, dicarboximide fungicides, dichlofluanid, dichlone, dichlorophen, dichlorophenyl, dichlozoline, diclobutrazol, diclocymet, diclomezine, dicloran, diethofencarb, diethyl pyrocarbonate, difenoconazole, diflumetorim, dimethirimol, dimethomorph, dimoxystrobin, diniconazole, diniconazole-M, dinitrophenol fungicides, dinobuton, dinocap, dinocap-4, dinocap-6, dinocton, dinopenton, dinosulfon, dinoterbon, diphenylamine, dipyrithione, disulfiram, ditalimfos, dithianon, dithiocarbamate fungicides, DNOC, dodemorph, dodicin, dodine, donatodine, drazoxolon, edifenphos, epoxiconazole, etaconazole, etem, ethaboxam, ethirimol, ethoxyquin, ethylene oxide, ethylmercury 2,3-dihydroxypropyl mercaptide, ethylmercury acetate, ethylmercury bromide, ethylmercury chloride, ethylmercury phosphate, etridiazole, famoxadone, fenamidone, fenaminosulf, fenapanil, fenarimol, fenbuconazole, fenfuram, fenhexamid, fenitropan, fenoxanil, fenpiclonil, fenpropidin, fenpropimorph, fentin, ferbam, ferimzone, fluazinam, fluconazole, fludioxonil, flumetover, flumorph, fluopicolide, fluoroimide, fluotrimazole, fluoxastrobin, fluquinconazole, flusilazole, flusulfamide, flutolanil, flutriafol, fluxapyroxad, folpet, formaldehyde, fosetyl, fuberidazole, furalaxyl, furametpyr, furamide fungicides, furanilide fungicides, furcarbanil, furconazole, furconazole-cis, furfural, furmecyclox, furophanate, glyodin, griseofulvin, guazatine, halacrinate, hexachlorobenzene, hexachlorobutadiene, hexachlorophene, hexaconazole, hexylthiofos, hydrargaphen, hymexazol, imazalil, imibenconazole, imidazole fungicides, iminoctadine, inorganic fungicides, inorganic mercury fungicides, iodomethane, ipconazole, iprobenfos, iprodione, iprovalicarb, isopropyl alcohol, isoprothiolane, isovaledione, isopyrazam, kasugamycin, ketoconazole, kresoxim-methyl, lime sulfur (lime sulphur), mancopper, mancozeb, maneb, mebenil, mecarbinzid, mepanipyrim, mepronil, mercuric chloride (obsolete), mercuric oxide (obsolete), mercurous chloride (obsolete), metalaxyl, metalaxyl-M (a.k.a. Mefenoxam), metam, metazoxolon, metconazole, methasulfocarb, methfuroxam, methyl bromide, methyl isothiocyanate, methylmercury benzoate, methylmercury dicyandiamide, methylmercury pentachlorophenoxide, metiram, metominostrobin, metrafenone, metsulfovax, milneb, morpholine fungicides, myclobutanil, myclozolin, N-(ethylmercury)-p-toluenesulfonanilide, nabam, natamycin, nystatin, β-nitrostyrene, nitrothal-isopropyl, nuarimol, OCH, octhilinone, ofurace, oprodione, organomercury fungicides, organophosphorus fungicides, organotin fungicides (obsolete), orthophenyl phenol, orysastrobin, oxadixyl, oxathiin fungicides, oxazole fungicides, oxine copper, oxpoconazole, oxycarboxin, pefurazoate, penconazole, pencycuron, pentachlorophenol, penthiopyrad, phenylmercuriurea, phenylmercury acetate, phenylmercury chloride, phenylmercury derivative of pyrocatechol, phenylmercury nitrate, phenylmercury salicylate, phenylsulfamide fungicides, phosdiphen, phosphite, phthalide, phthalimide fungicides, picoxystrobin, piperalin, polycarbamate, polymeric dithiocarbamate fungicides, polyoxins, polyoxorim, polysulfide fungicides, potassium azide, potassium polysulfide, potassium thiocyanate, probenazole, prochloraz, procymidone, propamocarb, propiconazole, propineb, proquinazid, prothiocarb, prothioconazole, pyracarbolid, pyraclostrobin, pyrazole fungicides, pyrazophos, pyridine fungicides, pyridinitril, pyrifenox, pyrimethanil, pyrimidine fungicides, pyroquilon, pyroxychlor, pyroxyfur, pyrrole fungicides, quinacetol, quinazamid, quinconazole, quinoline fungicides, quinomethionate, quinone fungicides, quinoxaline fungicides, quinoxyfen, quintozene, rabenzazole, salicylanilide, silthiofam, silver, simeconazole, sodium azide, sodium bicarbonate[2][3], sodium orthophenylphenoxide, sodium pentachlorophenoxide, sodium polysulfide, spiroxamine, streptomycin, strobilurin fungicides, sulfonanilide fungicides, sulfur, sulfuryl fluoride, sultropen, TCMTB, tebuconazole, tecloftalam, tecnazene, tecoram, tetraconazole, thiabendazole, thiadifluor, thiazole fungicides, thicyofen, thifluzamide, thymol, triforine, thiocarbamate fungicides, thiochlorfenphim, thiomersal, thiophanate, thiophanate-methyl, thiophene fungicides, thioquinox, thiram, tiadinil, tioxymid, tivedo, tolclofos-methyl, tolnaftate, tolylfluanid, tolylmercury acetate, triadimefon, triadimenol, triamiphos, triarimol, triazbutil, triazine fungicides, triazole fungicides, triazoxide, tributyltin oxide, trichlamide, tricyclazole, tridemorph, trifloxystrobin, triflumizole, triforine, triticonazole, unclassified fungicides, undecylenic acid, uniconazole, uniconazole-P, urea fungicides, validamycin, valinamide fungicides, vinclozolin, voriconazole, zarilamid, zinc naphthenate, zineb, ziram, and/or zoxamide.

In some embodiments, the herbicide safener composition is combined with a suitable miticide to form a multi-ingredient composition. Exemplary classes of miticides include, but are not limited to, botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricies, organitin acaricides, phenylsulfonamide acaricides, pyrazolecarboxamide acaricdes, pyrethroid ether acaricide, quaternary ammonium acaricides, oyrethroid ester acaricides, pyrrole acaricides, quinoxaline acaricides, methoxyacrylate strobilurin acaricides, teronic acid acaricides, thiasolidine acaricides, thiocarbamate acaricides, thiourea acaricides, and unclassified acaricides. Examples of miticides for these classes include, but are not limited to, botanical acaricides—carvacrol, sanguinarine; bridged diphenyl acaricides—azobenzene, benzoximate, benzyl, benzoate, bromopropylate, chlorbenside, chlorfenethol, chlorfenson, chlorfensulphide, chlorobenzilate, chloropropylate, cyflumetofen, DDT, dicofol, diphenyl, sulfone, dofenapyn, fenson, fentrifanil, fluorbenside, genit, hexachlorophene, phenproxide, proclonol, tetradifon, tetrasul; carbamate acaricides—benomyl, carbanolate, carbaryl, carbofuran, methiocarb, metolcarb, promacyl, propoxur; oxime carbamate acaricides—aldicarb, butocarboxim, oxamyl, thiocarboxime, thiofanox; carbazate acaricides—bifenazate; dinitrophenol acaricides—binapacryl, dinex, dinobuton, dinocap, dinocap-4, dinocap-6, dinocton, dinopenton, dinosulfon, dinoterbon, DNOC; formamidine acaricides—amitraz, chlordimeform, chloromebuform, formetanate, formparanate, medimeform, semiamitraz; isoxazoline acaricides—afoxolaner, fluralaner, lotilaner, sarolaner; macrocyclic lactone acaricides—tetranactin; avermectin acaricides—abamectin, doramectin, eprinomectin, ivermectin, selamectin; milbemycin acaricides—milbemectin, milbemycin, oxime, moxidectin; mite growth regulators—clofentezine, cyromazine, diflovidazin, dofenapyn, fluazuron, flubenzimine, flucycloxuron, flufenoxuron, hexythiazox; organochlorine acaricides—bromociclen, camphechlor, DDT, dienochlor, endosulfan, lindane; organophosphate acaricides—chlorfenvinphos, crotoxyphos, dichlorvos, heptenophos, mevinphos, monocrotophos, naled, TEPP, tetrachlorvinphos; organothiophosphate acaricides—amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides—trichlorfon; phosphoramidothioate acaricides—isocarbophos, methamidophos, propetamphos; phosphorodiamide acaricides—dimefox, mipafox, schradan; organotin acaricides—azocyclotin, cyhexatin, fenbutatin, oxide, phostin; phenylsulfamide acaricides—dichlofluanid; phthalimide acaricides—dialifos, phosmet; pyrazole acaricides—cyenopyrafen, fenpyroximate; phenylpyrazole acaricides—acetoprole, fipronil, vaniliprole; pyrazolecarboxamide acaricides—pyflubumide, tebufenpyrad; pyrethroid ester acaricides—acrinathrin, bifenthrin, brofluthrinate, cyhalothrin, cypermethrin, alpha-cypermethrin, fenpropathrin, fenvalerate, flucythrinate, flumethrin, fluvalinate, tau-fluvalinate, permethrin; pyrethroid ether acaricides—halfenprox; pyrimidinamine acaricides—pyrimidifen; pyrrole acaricides—chlorfenapyr; quaternary ammonium acaricides—sanguinarine; quinoxaline acaricides—chinomethionat, thioquinox; methoxyacrylate strobilurin acaricides—bifujunzhi, fluacrypyrim, flufenoxystrobin, pyriminostrobin; sulfite ester acaricides—aramite, propargite; tetronic acid acaricides—spirodiclofen; tetrazine acaricides, clofentezine, diflovidazin; thiazolidine acaricides—flubenzimine, hexythiazox; thiocarbamate acaricides—fenothiocarb; thiourea acaricides—chloromethiuron, diafenthiuron; unclassified acaricides—acequinocyl, acynonapyr, amidoflumet, arsenous, oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azinphos-methyl, Bacillus thuringiensis, bendiocarb, beta-cyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chlorpyrifos, clofentezine, chlorfenapyr, clothianidin, coumaphos, crotoxyphos, crotoxyphos+dichlorvos, cryolite, cyfluthrin, cyromazine, cypermethrin, deet, deltamethrin, demeton, diazinon, dichlofenthion, dichloropropene, dichlorvos, dicofol, dicrotophos, dieldrin, dienochlor, diflubenzuron, dikar (fungicide+miticide), dimethoate, dinocap, dinotefuran, dioxathion, disulfoton, emamectin benzoate, endosulfan, endrin, esfenvalerate, ethion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, methoprene, methoxychlor, methoxyfenozide, methyl bromide, methyl parathion, mevinphos, mexacarbate, milky disease spores, naled, naphthalene, nicotine sulfate, novaluron, oxamyl, oxydemeton-methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids—synthetic: see allethrin, permethrin, fenvalerate, resmethrin, pyrethrum, pyridaben, pyriproxyfen, resmethrin, rotenone, s-methoprene, soap, pesticidal, sodium fluoride, spinosad, spiromesifen, sulfotep, sulprofos, temephos, terbufos, tetrachlorvinphos, tetrachlorvinphos+dichlorvos, tetradifon, thiamethoxam, thiodicarb, toxaphene, tralomethrin, trimethacarb, and tebufenozide.

The amount of the herbicide safener composition in the multi-active ingredient composition (i.e., pesticide/herbicide safener containing composition) can vary. In some embodiments, the herbicide safener composition (containing PGA and/or 2-oxoglutamarate) is present in an amount of from about 0.01% to about 99%, from about 10% to about 80%, from about 20% to about 70%, or from about 30% to about 60% by weight based on the total weight of the multi-active ingredient composition. In some embodiments, the herbicide safener composition (containing PGA and/or 2-oxoglutamarate) is present in an amount of from about 0.01% to about 99%, from about 10% to about 80%, from about 20% to about 70%, or from about 30% to about 60% by weight based on the total weight of the multi-active ingredient composition. In some embodiments, the herbicide safener composition is present in an amount of less than about 99%, about 90%, about 85%, about 80%, about 75%, about 70%, about 65%, about 60%, about 55%, about 50%, about 45%, about 40%, about 35%, about 30%, about 25%, about 20%, about 15% about 10% or less than about 5% by weight based on the total weight of the multi-active ingredient compositions. In some embodiments, the amount of herbicide safener composition is present at a level of from about 0.05% to about 10% by weight (more preferably from about 0.1% to about 4% by weight, and most preferably from about 0.2% to about 2% by weight) based upon the total weight of the multi-active ingredient composition taken as 100% by weight.

In some embodiments, the multi-active ingredient composition comprises the disclosed herbicide safener composition and the disclosed herbicide composition. The amount of the herbicide safener composition and the herbicide composition present in the multi-active ingredient composition can vary. In some embodiments, the herbicide safener composition and the herbicide composition are present in a ratio from about 1:100 to about 100:1, from about 1:50 to about 50:1, from about 1:25 to about 25:1, from about 1:20 to about 20:1, from about 1:10 to about 10:1, from about 1:5 to about 5:1, from about 1:2 to about 2:1, or about 1:1 herbicide safener composition to herbicide composition based on weight.

In some embodiments, the herbicide safener composition is combined with another herbicide safener. Exemplary classes of other herbicide safener compositions include, but are not limited to, benoxacor, BPCMS, cloquintocet, cyometrinil, cyprosulfamide, dichlormid, dicyclonon, dietholate, fenchlorazole, fenclorim, flurazole, fluxofenim, furilazole, isoxadifen, jiecaowan, jiecaoxi, mefenpyr, mephenate, metcamifen, naphthalic anhydride, oxabetrinil, and a combination thereof.

The amounts of each herbicide safener in the muli-active ingredient composition can vary. A skilled artisan would be able to determine the appropriate amount of each herbicide safener required in the multi-active ingredient composition to achieve the most optimal herbicide safening effect. In some embodiments, the herbicide safener composition and the other herbicide safener are present in a ratio from about 1:100 to about 100:1, from about 1:50 to about 50:1, from about 1:25 to about 25:1, from about 1:20 to about 20:1, from about 1:10 to about 10:1, from about 1:5 to about 5:1, from about 1:2 to about 2:1, or about 1:1 herbicide safener composition to herbicide safener based on weight.

### V. Methods

In some embodiments, the herbicide composition and/or the herbicide safener composition can be used directly. In other embodiments, the herbicide composition and/or herbicide safener composition are formulated in ways to make their use convenient in the context of productive agriculture.

In particular, the herbicide composition and herbicide safener compositions as disclosed herein can be used in methods of controlling the growth of undesired vegetation in a target area by applying to the target area an herbicidally effective amount of an herbicide composition as disclosed herein and applying an herbicide safener composition comprising pyroglutamic acid (PGA) and/or 2-oxoglutamarate. In some embodiments, the herbicide composition comprises an herbicide selected from a lipid synthesis inhibitor, an amino acid synthesis inhibitor, a nitrogen metabolism inhibitor, a growth regulator inhibitor, and a combination thereof. In some embodiments, the herbicide safener composition comprising pyroglutamic acid (PGA) and/or 2-oxoglutamarate at a concentration of less than 1 g/L. In some embodiments, the herbicide safener composition is applied to the target area in an amount effective to cause an herbicide safening effect. In some embodiments, the target area is an agricultural field, a lawn, a garden, a vineyard, an orchard, a plantation, or a combination thereof.

In some embodiments, the herbicide composition and/or formulation thereof is applied to the soil and/or the unwanted vegetation (if it has emerged) after the crop has been planted but before it emerges. Such an herbicide composition is referred to as a preemergent herbicide composition, with respect to the crops of cultivated plants.

In some embodiments, the herbicide composition and/or formulation thereof is applied to the soil and/or the unwanted vegetation (if it has emerged) after the crop has been planted and the crop plants have emerged. Such herbicide compositions are referred to as postemergent herbicide compositions, with respect to the crops of cultivated plants.

In some embodiments, the herbicide safener composition is applied to the soil of the target area, the plants of cultivated crops (if emerged), or a combination thereof.

In some embodiments, the target area contains:
(a) emerged plants of cultivated crops but no emerged plants of unwanted vegetation;
(b) emerged plants of cultivated crops and emerged plants of unwanted vegetation;
(c) no emerged plants of cultivated crops and emerged plants of unwanted vegetation; or
(d) no emerged plants of cultivated crops and no emerged plants of unwanted vegetation.

In some embodiments, the target area contains unwanted vegetation and plants of cultivated crops and the herbicide composition is applied to the soil of the target area, the plants of cultivated crops, or a combination thereof.

In some embodiments, the herbicide composition and/or herbicide safener composition are applied to the soil adjacent to the plants (or stems) and/or in the root zone of the plants. In some embodiments, the herbicide composition and/or herbicide safener composition are applied directly to plants that have emerged, such as directly applied to one or more plant parts (e.g., foliar application methods) of the unwanted vegetation or cultivated crops. In some embodiments, the herbicide composition and/or herbicide safener composition are applied only to a portion of the target area.

The herbicide safener composition is applied to the target area either at the same time as the herbicide composition is applied or is applied after the herbicide composition is applied. In some embodiments, the herbicide composition and the herbicide safener composition are applied to the target area at the same time. In some embodiments, the herbicide composition is applied before the application of the herbicide safener composition. In some embodiments, the herbicide composition and the herbicide safener composition are applied within 24 hours of each other. In some embodiments, the herbicide composition is applied about 1 minute to about 60 minutes, about 1 minute to about 30 minutes, or about 1 minute to about 15 minutes (or about 1, 5, 10, 15, 20, 25, 30, 35, 40, 45, 50, 55 or about 60 minutes) before the application of the herbicide safener composition. In some embodiments, the herbicide composition is applied about 1 to about 48 hours, about 1 to about 36 hours, about 1 to about 24 hours, about 1 to about 12 hours, or about 1 to about 6 hours before the herbicide safener application is applied to the target area (or about 1, 2, 3, 4, 5, 6, 7, 8, 9, 10, 11, 12, 13, 14, 15, 16, 17, 18, 19, 20, 21, 22, 23, or about 24 hours before the herbicide safener application is applied to the target area). In some embodiments, the herbicide composition is applied less than about 1 minute before the application of the herbicide safener composition.

The number of applications of the herbicide and herbicide safener compositions can vary depending on the type of unwanted vegetation, the type of crop, climate, and the like. A skilled person in the art would be aware of such factors and apply the herbicide and/or herbicide safener compositions accordingly. For example, in some embodiments, the herbicide composition and/or herbicide safener composition and formulations thereof are applied at least 1-10 times (or at least 1, 2, 3, 4, 5, 6, 7, 8, 9 or 10 times) over a time frame of 1-6 months. In some embodiments, the herbicide composition and/or herbicide safener composition and formulation thereof are applied weekly or monthly over a time frame of 1-12 months.

The rate of application of herbicide composition or formulation thereof to treat a target area can vary within wide limits and depend on the nature of the soil, the method of application (pre- or postemergence; etc.), the crop plant, the type(s) of unwanted vegetation to be controlled, the prevailing climatic conditions, and other factors governed by the method of application, the time of application and the target crop. In some embodiments, the herbicide composition and/or formulation thereof can be applied at a rate of between about 0.1 to about 100 gallons/acre, about 1 to about 90 gallons/acre, about 10 to about 80 gallons/acre, 20 to about 70 gallons/acre, or from about 30 to about 60 gallons/acre.

In some embodiments, the herbicide composition and/or formulation thereof can be applied at a rate of between about 1 to about 2,000 lbs./acre (about 1.12 to about 2241 kg/ha), about 20 to about 1,900 lbs./acre (about 22.4 to about 2129.6 kg/ha), about 50 to about 1,800 lbs./acre (about 56 to about 2017.5 kg/ha), about 100 to about 1,700 lbs./acre (about 112.1 to about 1905.4 kg/ha), about 125 to about 1,650 lbs./acre (about 140.1 to about 1849 kg/ha), about 137.5 to about 1,650 lbs./acre (about 154.12 to about 1849.4 kg/ha), about 200 to about 1,500 lbs./acre (about 224.1 to about 1681.2 kg/ha), or about 500 to about 1,000 lbs./acre (about 560.4 to about 1120.8 kg/ha).

The amount of the herbicide compositions and/or formulation thereof being applied to a target area may vary within wide limits and depend on the nature of the soil, the method of application (pre- or postemergence; etc.), the crop plant, the weed(s) to be controlled, the prevailing climatic conditions, and other factors governed by the method of application, the time of application and the target crop. In some embodiments, the herbicide composition is used in an amount of from about 1 to about 1,000 liters/hectare (L/ha), from about 100 to about 900 L/ha, from about 200 to about 800 L/ha, from about 250 to 600 L/ha or from about 350 to about 500 L/ha.

In some embodiments, the herbicide composition and/or formulation thereof is used in an amount from about 1 to about 500 kg/hectare (kg/ha), from about 10 to about 400 kg/ha, from about 20 to about 350 kg/ha, from about 25 to about 300 kg/ha, from about 50 to about 275 kg/ha, from about 75 to about 250 kg/ha, or from about 100 to about 200 kg/ha.

In some embodiments, the amount of the herbicide composition being applied in a target area depends on the plant population density present in the target area. In some embodiments, the plant population density (which includes plants of the unwanted vegetation alone or in combination with emerged crop plants) ranges from about 1 to about 100,000 plants per acre (plants/acre) (or 1 to about 40,485 plants/hectar), from about 100 to about 100,000 plants/acre (100 to about 50,485 plants/hectar), from about 1,000 to about 100,000 plants/acre, from about 10,000 to about 75,000 plants/acre, from about 10,0000 to about 60,000 plants/acre, or from about 25,000 to about 50,000 plants/acre. In some embodiments, the plant population density (which includes plants of the unwanted vegetation alone or in combination with emerged crop plants) ranges from about 1 to about 40,485 plants/hectar, from about 45 to about 50,485 plants/hectar, from about 350 to about 50,000 plants/hectar, from about 3,500 to about 40,000 plants/hectar, from about 3,500 to about 30,000 plants/hectar, or from about 2,500 to about 25,000 plants/hectar.

Thus, in some embodiments, the herbicide composition is used in the target area in an amount ranging from about 10 to about 400 kg/ha, based on planting densities ranging from about 10,000 to 60,000 plants/ha, or from about 25 to about 300 kg/ha, based on planting densities ranging from about 10,000 to 60,000 plants/ha.

In such embodiments, the herbicide composition is applied to each plant of the plant population present in the target area at an effective herbicidal rate, which can vary. In some embodiments, the herbicide composition is applied at an effective herbicidal amount of from about 1 to about 10 grams, from about 2 to about 7.5 grams, or from about 2.5 to about 5.25 grams per plant of the unwanted vegetation.

Likewise, it will be understood by a person of skill in the art that the rate of the herbicide safener composition or formulation thereof required to cause a safening effect can vary as it depends upon factors such as the type of cultivated crop being targeted by the herbicide safener composition, the type of application method being used, the type of formulation being used, additional components present in the herbicide safener composition (e.g., additional pesticides and/or fertilizers), environmental factors (such as atmospheric temperature and/or moisture content prior, during, and post application, soil characteristics such as pH, heavy metal content, nutrient content, microbial activity, granularity, composition (e.g., clay and/or sandy) etc.), and the like. As such, in some embodiments the herbicide safener composition is applied at a rate of between about 0.1 to about 625 gallons/acre or from about 0.1 to about 5,846 L/ha.

In some embodiments, the rate of application of the herbicide safener composition or formulation thereof depends on the plant population density present in the target area. In some embodiments, the plant population density (which includes plants of the unwanted vegetation alone or in combination with emerged crop plants) ranges from about 1 to about 200,000 plants per acre (plants/acre), from about 100 to about 200,000 plants/acre, from about 1,000 to about 200,000 plants/acre, from about 10,000 to about 175,000 plants/acre, from about 25,0000 to about 150,000 plants/acre, from about 75,000 to about 125,000 plants/acre, or 10,000 to about 100,000 plants/acre. In some embodiments, the plant population density (which includes plants of the unwanted vegetation alone or in combination with emerged crop plants) ranges from about 1 to about 100,000 plants per hectar (plants/hectar), from about 50 to about 100,000 plants/hectar, from about 5000 to about 100,000 plants/hectar, from about 5,000 to about 85,000 plants/hectar, from about 8,0000 to about 75,000 plants/hectar, from about 35,000 to about 55,000 plants/hectare, or 8,000 to about 50,000 plants/hectare.

In such embodiments, the herbicide safening composition is applied to each plant of the plant population present in the target area at an effective herbicidal safening rate, which can vary. In some embodiments, the herbicide composition is applied at an effective amount of from about 0.001 mg to about 50 mg, 0.001 mg to about 25 mg, from about 0.01 to about 15 mg, from about 0.01 mg to about 10 mg, from about 0.1 mg to about 10 mg, from about 1 mg to about 10 mg, or from about 5 mg to about 10 mg per plant of the cultivated crop.

In some embodiments, the herbicide safening composition is applied to each plant in a liquid form. For example, in some embodiments, the amount of herbicide safening composition applied to each plant ranges from about 1 mL to about 250 mL, from about 10 mL to about 200 mL, from about 10 mL to about 100 mL, from about 10 ml to about 75 mL, from about 10 mL to about 50 mL, from about 25 mL to about 75 mL, from about 30 mL to about 60 mL, from about 40 mL to about 55 ml, or from about 45 mL to about 55 mL per plant.

The concentration of the herbicide safening composition applied to each plant in liquid form can vary as well. For example, in some embodiments, the herbicide safening composition has a concentration ranging from about 0.1 g/L to about 0.2 g/L, from about 0.1 g/L to about 0.15 g/L, from about 0.12 g/L to about 0.14 g/L, or from about 0.13 g/L to about 0.14 g/L.

In some embodiments, the herbicide safener composition of formulation thereof as disclosed herein exhibits an herbicide safening effect (i.e., protects plants of cultivated crops) on one or more particular types of plants of cultivated crops, wherein the herbicide safening effect is measured by at least one method selected from an increase in crop development, a decrease in phytotoxicity, an increase in crop vigor, an increase in chlorophyll content, an increase in fresh or dry plant weight, an increase in root weight, an increase in crop yield, an increase in fruit quality, an increase in vertical plant growth, and an increase in plant leaf area of plants treated with the herbicide safener composition compared to plants that were not treated with the herbicide safener composition. In some embodiments, the herbicide safener composition of formulation thereof exhibits an herbicide safening effect on one or more particular types of cultivated crops, wherein the herbicide safening effect is measured by an increase of at least about 1%, 10%, 20%, 30%, 40%, 50%, 60%, 70%, 80%, 90%, 95% or about 98% of crop development, crop vigor, chlorophyll content, fresh or dry plant weight, root weight, crop yield, fruit quality, vertical plant growth, plant leaf area, or a combination thereof, of plants treated with the herbicide safener composition compared to plants that were only treated with the herbicide composition. In some embodiments, the herbicide safener composition of formulation thereof exhibits an herbicide safening effect, which is measured by an increase of from about 1% to about 20% plant height of plants treated with the herbicide safener composition compared to plants that were only treated with the herbicide composition. In some embodiments, the herbicide safener composition of formulation thereof exhibits an herbicide safening effect, which is measured by an increase of from about 1% to about 98%, from about 1% to about 90%, from about 1% to about 50%, or from about 1% to about 25% dry plant weight of plants treated with the herbicide safener composition of formulation compared to plants that were only treated with the herbicide composition. In some embodiments, the herbicide safener composition of formulation thereof exhibits an herbicide safening effect, which is measured by an increase of from about 1% to about 300%, from about 1% to about 200%, from about 1% to about 100%, from about 1% to about 50%, or from about 1% to about 30% leaf area of plants treated with the herbicide safener composition of formulation thereof compared to plants that were only treated with the herbicide composition.

In some embodiments, the herbicide safener composition or formulation thereof exhibits an herbicide safening effect on one or more particular types of plants of cultivated crops, wherein the herbicide safening effect is measured by a decrease of at least about 1%, 10%, 20%, 30%, 40%, 50%, 60%, 70%, 80%, 90%, 95% or about 98% of phytotoxicity of plants treated with the herbicide safener composition of formulation thereof compared to plants that were only treated with the herbicide composition.

The herbicide composition and herbicide safener composition can be applied to the target area using application methods that are commonly used in agriculture. Exemplary application methods include, but are not limited to, band application, broadcast application, directed application and spot application. In some embodiments, the herbicide composition and the herbicide safener composition are applied to the target area using the same application method. In some embodiments, the herbicide composition and the herbicide safener composition are applied to the target area using different application methods.

In some embodiments, the herbicide composition and/or formulation thereof are applied to the target area using broadcast application methods, which applies the herbicide composition and/or formulation thereof non-selectively to the soil over the entire target area and/or plants of unwanted vegetation an/or of cultivated crops present in the entire target area.

Broadcast application methods can be used for preemergent herbicide compositions and/or postemergent herbicide compositions (with respect to the culticated crops) of non-selective or selective herbicide compositions and/or formulations thereof. Thus, in some embodiments, the herbicide composition and/or formulation thereof are applied to the soil (and/or plants if present) of a target area using broadcast application methods for preemergent herbicide compositions and/or postemergent herbicide compositions prior to emergence of unwanted vegetation.

In some embodiments, the herbicide composition and/or formulation thereof are applied to the target area using band application methods, which apply the herbicide composition and/or formulations thereof in the form of narrow strips over the row of cultivated crops. Band application methods use smaller amounts of herbicide composition and/or formulation thereof compared to broadcast application methods because the target area is much smaller. Band application methods can be used for postemergence selective herbicide compositions (with respect to the cultivated crops) and/or formulation thereof. In some embodiments, the herbicide composition and/or formulation thereof is applied to the soil and/or plant parts of the cultivated crops and unwanted vegetation (if present) using this particular application method.

In some embodiments, the herbicide composition and/or formulation thereof are applied to the target area using direct application methods. In these types of applications, the target area typically is the area between the rows of cultivated crops, where the herbicide composition and/or formulation thereof are being applied with little to no herbicide composition and/or formulation thereof being applied to the crop foliage. Direct application methods are used for postemergence herbicide compositions (with respect to the cultivated crops) where the unwanted vegetation may or may not have emerged in the target area. In some embodiments, directed application methods of the herbicide composition and/or formulation are applied to the soil of the target area prior to emergence of the unwanted vegetation. In some embodiments, direct application methods of the herbicide composition and/or formulation thereof are applied to plant parts (e.g., leaves, stem, and/or flowers) of the unwanted vegetation present in the target area.

In some embodiments, the herbicide composition and/or formulation thereof are applied to the target area using spot application methods, which apply the herbicide composition and/or formulation thereof being applied to small target areas where unwanted vegetation is present or is at risk of being present. Spot application methods can be used for preplant, preemergence and postemergence (with repost to the crops) non-selective herbicide compositions. In some embodiments, the composition is applied using spot application methods to the soil of the target area prior to emergence of the unwanted vegetation. In some embodiments, the composition is applied using spot application methods to plant parts of the already emerged unwanted vegetation.

In some embodiments, the herbicide safener composition and/or formulation thereof are applied to the target area using broadcast application methods, band application methods, and/or spot application methods. During broadcast application methods the herbicide safener composition and/or formulation thereof are non-selectively applied to the soil and/or plants over the entire target area. During band application methods the herbicide safener composition and/or formulation thereof are applied in the form of narrow strips over the row of cultivated plants. During spot application methods the herbicide safener composition and/or formulation thereof are applied to a small target area. The target area can comprise any one of the following: (a) emerged plants of cultivated crops but no emerged unwanted vegetation; or (b) emerged plants of unwanted vegetation but no emerged plants of cultivated crops; or (c) no emerged plants of unwanted vegetation and no emerged plants of cultivated crops; or (d) emerged plants of unwanted vegetation and emerged plants of cultivated crops.

In some embodiments, the herbicide safener composition or formulation thereof is applied to the target area using application methods such as fertigation, irrigation, dripping, drenching, spraying, or a combination thereof. With such application methods the composition can be applied to the entire target area or portions (e.g., rows and/or smaller target areas) of the target area.

In some embodiments, the herbicide composition is applied using broadcast application methods. In such embodiments, the herbicide safener composition is applied using broadcast application methods, band application methods, or spot application methods. In such embodiments, the herbicide safener composition is applied to the entire target area or a portion thereof using fertigation, irrigation, drenching, dripping, or spraying.

In some embodiments, the herbicide composition is applied using band application methods. In such embodiments, the herbicide safener composition is applied using broadcast application methods, band application methods, or spot application methods. In such embodiments, the herbicide safener composition is applied to the entire target area or a portion thereof using fertigation, irrigation, drenching, dripping, or spraying.

In some embodiments, the herbicide composition is applied using spot application methods. In such embodiments, the herbicide safener composition is applied using broadcast application methods, band application methods, or spot application methods. In such embodiments, the herbicide safener composition is applied to the entire target area or a portion thereof using fertigation, irrigation, drenching, dripping, or spraying.

The herbicide composition and/or herbicide safener composition and formulations thereof can be applied using any known agricultural equipment that is known in the art to carry out such function. Exemplary agricultural equipment includes but is not limited to sprayers (e.g., boom sprayer, spot sprayer, high volume spray truck, backpack sprayer, spray dusters), power-dusters, misters, blanket wipers, rope wick applicator, handheld rope wick wiper, rotary and drop spreaders, and the like. A skilled person in the art would be aware of the agricultural equipment that would be suitable for a given herbicide composition and/or formulation thereof and application method.

The plants of cultivated crops are selected from specialty crops, sugar crops, legumes and a combination thereof. In some embodiments, the plants of cultivated crops are specialty crops. Specialty crops include fruits and tree nuts, vegetables, culinary herbs and spices, medicinal herbs, horticulture crops, and a combination thereof. Specialty crops selected from fruits and nuts include almonds, apples, apricots, avocado, banana, blackberry, blueberry, breadfruit, cacao, cashew, citrus, cherimoya, cherry, chestnut, coconut, coffee, cranberry, currant, date, fejou, fig, filbert, gooseberry, grape, guava, kiwi, lychee, macadamia, mango, nectarine, olive, papaya, passion fruit, peach, pear, pecan, persimmon, pineapple, pistachio, plum, pomegranate, quince, raspberry, strawberry, suriname cherry, walnut, and a combination thereof. Specialty crops selected from vegetables include artichoke, asparagus, bean snap, green lima, beet, broccoli, brussels sprouts, cabbage, cauliflower, celeriac, celery, collards, cucumber, edamame, eggplant, endive, garlic, horseradish, kohlrabi, leek, lettuce, melons, mustard greens, okra, peas, onion, opuntia, pepper, potato, pumpkin, radish, rhubarb, rutabaga, salsify, spinach, squash, sweet corn, sweet potato, swiss chard, taro, tomato, tomatillo, turnip, watermelon, and a combination thereof. Specialty crops selected from culinary herbs and spices include ajwain, allspice, angelica, anise, annatto, artemisia, asafetida, basil, bay, bladder wrack, Bolivian coriander, borage, calendula, chamomile, candle nut, caper, caraway, cardamom, cassia, catnip, chervial, chicory, chive, cicely, cilantro, cinnamon, clary, cloves, comfrey, common rue, coriander, cress, cumin, curry, dill, fennel, fenugreek, file, fingerroot, French sorrel, galangal, giner, hops, horehound, hyssop, lavender, lemon balm, lemon thyme, lovage, mace, mahlab, malabathrum, marjoram, mint, nutmeg, oregano, orris root, paprika, parsley, pepper, rocket (arugula), rosemary, rue, saffron, sage, savory, terragon, thyme, turmeric, vanilla, wasabi, watercress, and a combination thereof. Specialty crops selected from medicinal herbs include artemisia, arum, astragalus, boldo, cananga, comfrey, coneflower, ephedra, fenugreek, feverfew, foxglove, ginko biloba, ginseng, goat's rue, goldenseal, gypsywort, horehound, horsetail, lavender, yerba buena, liquorice, marshmallow, mullein, passion flower, pennyroyal, pokeweed, St. John's wort, senna, skullcap, sonchus, sorrel, stevia, transy, urtica, witch hazel, wood betony, wormwood, yarrow, and a combination thereof. Specialty crops selected from horticulture crops include bedding plants, Christmas trees, cut flowers, honey, tea leaves, ornamental trees and shrubs, maple syrup, hops and a combination thereof.

In some embodiments, the specialty crop is a legume. Legumes include alfalfa, clover, beans, peas, chickpeas, lentils, lupins, mesquite, carob, soybeans, peanuts, and tamarind.

In some embodiments, the specialty crops is a sugar crop selected from sugar beets, sugar cane, and a combination thereof.

In some embodiments, the crops are not genetically modified crops. In some embodiments, the crops are genetically modified crops.

The herbicide compositions and formulations disclosed herein are able to control the growth of a wide variety of unwanted vegetation such as monocotyledonous and dicotyledonous weed species. In some embodiments, the unwanted vegetation to be controlled is monocotyledonous. Exemplary monocotyledonous genera include, but are not limited to, Agrostis spp., Alopecurus spp., Apera spp., Avena spp., Brachiaria spp., Bromus spp., Digitaria spp., Echinochloa spp., Eleusine spp., Eriochloa spp., Leptochloa spp., Lolium spp., Ottochloa spp., Panicum spp., Paspalum spp., Phalaris spp., Poa spp., Rottboelia spp., Setaria spp., Sorghum spp., Commelina spp., Monochoria spp., Sagittaria spp. and sedges such as Cyperus spp. and Scirpus spp. Exemplary monocotyledonous weed species include, but are not limited to, Alopecurus myosuroides, Avena fatua, Brachiaria plantaginea, Bromus tectorum, Cyperus esculentus, Digitaria sanguinalis, Echinochloa crus-galli, Lolium perenne, Lolium multiflorum, Panicum miliaceum, Poa annua, Setaria viridis, Setaria faberi and Sorghum bicolor.

In some embodiments, the unwanted vegetation is dicotyledonous. Exemplary genera of dicotyledonous weed species include, but are not limited to, Abutilon spp., Ambrosia spp., Amaranthus spp., Chenopodium spp., Erysimum spp., Euphorbia spp., Fallopia spp., Galium spp., Hydrocotyle spp., Ipomoea spp., Lamium spp., Medicago spp., Oxalis spp., Plantago spp., Polygonum spp., Richardia spp., Sida spp., Sinapis spp., Solanum spp., Stellaria spp., Taraxacum spp., Trifolium spp., Veronica spp., Viola spp. and Xanthium spp. Exemplary dicotyledonous weed species include, but are not limited to, Abutilon theophrasti, Amaranthus retroflexus, Bidens pilosa, Chenopodium album, Euphorbia heterophylla, Galium aparine, Ipomoea hederacea, Kochia scoparia, Polygonum convolvulus, Sida spinosa, Sinapis arvensis, Solanum nigrum, Stellaria media, Veronica persica and Xanthium strumarium.

Unwanted vegetation can also include plants which may be considered crop plants but which are growing outside a crop area (“escapes”), or which grow from seed left over from a previous planting of a different crop (“volunteers”). Such volunteers or escapes may be tolerant to certain other herbicides.

In some embodiments, the unwanted vegetation is selected from monocotyledonous weeds such as grasses (e.g., barnyard grass (Echinochloa crus-galli), large and smooth crabgrass (Digitaria sanguinalis, Digitaria ischaemum), goosegrass (Eleusine indica), bent grass (Agrostis spp.) and nimbleweed) and dicotyledonous weeds such as dandelion.

In some embodiments, the unwanted vegetation is a broadleaf species. Exemplary broadleaf weeds include, but are not limited to, foxtail (Setaria spp.), wild finger millet (Eleusine spp.), cough grass (Digitaria spp.), rye grass (Lolium spp.), shepherd's purse (Capsella bursapastories), fathen (Chenopodium album), double thom (Oxygonum sinuatum), black bind weed (Polygonum convolvulus), Mexican marigold (Tagetes minuta), gallant soldier (Galinsoga parviflora), white charlock (Raphanus raphanastrium), blackgrass (Alopecurus spp.), meadow grass (Poa spp.), silky bent grass (Apera spp.), barnyardgrass (Echinochloa spp.), cleavers (Galium aparine), common chickweed (Stellaria media), hedge mustard (Sisymbrium officinale), parsley-piert, scanted mayweed (Matricaria chamomilla), scentless mayweed (Matricaria perforate), mugwort (Artemisia spp.), milkweed (Asclepias spp.), Canada thistle (Cirsium spp.), velvetleaf (Abutilon theophrasti), pigweed (Amaranthus spp.), buttonweed (Borreria spp.), canola, Indian mustard, Commelina (Commelina spp), filaree (Eradium spp.), sunflower (Helianthus spp.), morning glory (Ipomoea spp.) Kochia (Kochia scoparia), mallow (Malva spp.), wild buckwheat, smartweed (Polygonum spp.), purslane (Portulaca spp.), Russian thistle (Salsola spp.), Sida (Sida spp.), wild mustard (Sinapis arventis) and cocklebur (Xanthium spp.), field bindweed (Convolvulus arvensis), kudzu (Pueraria), shepherd's-needle, shepherd's purse, volunteer oilseed rape (Brassica napus), wild radish (Raphanusraphanistrum), charlock (Sinapis arvensis), poppy (Papaver rhoeas), especially blackgrass, meadow grass, silky bent grass, cleavers, chickweed, mayweeds, poppy, charlock and volunteer oilseed rape.

In some embodiments, the unwanted vegetation is a narrowleaf species. Exemplary monocot species include, but are not limited to, wild oat (Avena fatua), carpetgrass (Axonopus spp.), downy brome (Bromus sectorum), crabgrass (Digitaria spp.), barnyardgrass (Echinochola crus-galli), goosegrass (Eleusine indica), annual ryegrass (Lolium multiflorum), rice (Oryza sativa), Ottochloa (Ottochloa nodosa), bahiagrass (Paspalum notatum), canarygrass (Phalaris spp.), foxtails (Setaria spp.), wheat (Triticum aestivum), corn (Zea mays), Bracheria (Braacheria spp.), bermudagrass (Cynodon dactylon), yellow nutsedge (Cyperus esculentus), purple nutsedge (C. rotundus), quackgrass (Elymus repens), lalang (Imperata cylinderica), perennial ryegrass (Lotium perenne), guineagrass (Panicum masimum), dallisgrass (Paspalum dilatatum), reed (Phragmites app.), johnsongrass (Sorghum halepense) and cattail (Typha spp.).

In some embodiments, the unwanted vegetation is a glyphosphate-resistant weed speices. Exemplary glyphosphate-resistant weed species include, but are not limited to, rigid ryegrass, horseweed (marestail), Italian ryegrass, common ragweed, palmer amaranth, waterhemp, goosegrass, hairy fleabane, broadleaf plantain, johnsongrass, and wild poinsettia.

In yet another embodiment, the undesired vegetation is selected from Brassica napus, Brassica nigra, Arctotheca calendula, Fallopia convolvulus, Sinapis arvensis, Stellaria media, Sonchus oleraceus, Buglossoides arvense, Ipomoea lonchophylla, Crassula spp., Lamium spp., Lamium amplexicaule, Fumaria densiflora, Rumex spp., Emex australis, Chenopodium spp., Chenopodium album, Senecio spp., Senecio vulgaris, Centaurea cyanus, Fumaria spp., Sisymbrium officinale, Melilotus indicus, Marrubium vulgare, Lythrum hyssopifolia, Mesembryanthemum spp., Sisymbrium orientale, Sisymbrium irio, Erodium botrys, Cerastium glomeratum, Matthiola longipetala, Echium plantagineum, Lepidium spp., Lactuca serriola, Scleroblitum atriplicinum, Papaver hybridum, Carthamus lanatus, Anagallis arvensis, Capsella bursa-pastoris, Chondrilla juncea, Rumex spp., Onopordum acaulon, Juncus bufonius, Polygonum spp., Polygonum convolvulus, Polygonum patulum, Rapistrum rugosum, Silybum marianum, Vicia sativa, Lupinus spp., Carrichtera annua, Raphanus raphanistrum, Brassica tournefortii, Polygonum aviculare, Malva parviflora, Solanum nigrum, Amaranthus retroflexus, Galium aparine, Matricaria spp., Matricaria recutita, Matricaria chamomilla, Veronica spp., Papaver rhoeas, Viola arvensis, Ranunculus repens, Geranium spp., volunteer oilseed rape, Myosotis arvensis, Galium aparine, Brassica nigra, Capsella bursa-pastoris, Fallopia convolvulus, Matricaria Spp., Matricaria chamomilla, Viola arvensis, Stellaria media, Veronica spp., Lamium spp., Myosotis arvensis, Senecio vulgaris, Centaurea cyanus, Papaver rhoeas, Polygonum spp., and Chenopodium spp.

In some embodiments, the above method is further combined with one or more additional methods to control unwanted vegetation. Exemplary methods include but are not limited to crop rotation, crop competition, introduction of natural predators, and/or mechanical control (e.g., hoeing, tilling, mowing, flooding, and/or smothering).

Particular embodiments of the subject matter described herein include:

1. A method of controlling the growth of undesired vegetation in a target area, the method comprising
applying to the target area an herbicidally effective amount of an herbicide composition comprising an herbicide selected from a lipid synthesis inhibitor, an amino acid synthesis inhibitor, a nitrogen metabolism inhibitor, a growth regulator inhibitor, and a combination thereof; and
applying an herbicide safener composition comprising pyroglutamic acid (PGA) and/or 2-oxoglutaramate at a concentration of less than 1 g/L,
wherein the herbicide safener composition is applied to the target area in an amount effective to cause an herbicide safening effect, and
wherein the target area contains plants of cultivated crops selected from specialty crops, sugar crops, legumes, and a combination thereof.

2. The method of embodiment 1, wherein the PGA amount effective to cause an herbicide safening effect is from about 0.001 mg to about 50 mg per plant of cultivated crop.

3. The method of claim 1 or 2, wherein the herbicide safener composition comprises PGA at a concentration ranging from about 0.1 g/L to about 0.2 g/L.

4. The method of any one of the preceding embodiments, wherein the herbicide safening effect is measured by at least one method selected from an increase in crop development, a decrease in phytotoxicity, an increase in crop vigor, an increase in chlorophyll content, an increase in fresh or dry plant weight, an increase in root weight, an increase in crop yield, an increase in fruit quality, an increase in plant growth, and an increase in leaf area of plants treated with the herbicide safener composition compared to plants that were only treated with the herbicide composition and were not treated with the herbicide safener composition.

5. The method of embodiment 4, wherein an increase of about 1% to about 20% of plant height of plants treated with the herbicide safener composition was observed compared to plants that were not treated with the herbicide safener composition.

6. The method of embodiment 4, wherein an increase of about 1% to about 90% of dry plant weight of plants treated with the herbicide safener composition was observed compared to plants that were only treated with the herbicide composition.

7. The method of embodiment 4, wherein an increase of about 1% to about 300% of leaf area of plants treated with the herbicide safener composition was observed compared to plants that were only treated with the herbicide composition.

8. The method of any one of the preceding embodiments, wherein the target area contains unwanted vegetation and plants of cultivated crops and the herbicide safener composition is applied to the soil of the target area, the plants of cultivated crops, or a combination thereof.

9. The method of any one of the above embodiments, wherein the herbicide safener composition is applied to the soil adjacent to the plant, the root zone of the plant, one or more plant parts of the plants of cultivated crops, or a combination thereof.

10. The method of any one of the above embodiments, wherein the herbicidal composition and the herbicide safener composition are applied to the soil of the target area containing crops of cultivated plants that have not yet emerged.

11. The method of any one of the above embodiments, wherein the herbicidal composition and the herbicide safener composition are applied to the target area at the same time.

12. The method of any one of the above embodiments, wherein the herbicide safener composition is applied using fertigation, irrigation, drenching, dripping, spraying, or a combination thereof.

13. The method of any one of the above embodiments, wherein the plants of cultivated crops are selected from:
specialty crops selected from fruits and nuts such as almonds, apples, apricots, avocado, banana, blackberry, blueberry, breadfruit, cacao, cashew, citrus, cherimoya, cherry, chestnut, coconut, coffee, cranberry, currant, date, feijoa, fig, filbert, gooseberry, grape, guava, kiwi, lychee, macadamia, mango, melons, nectarine, olive, papaya, passion fruit, peach, pear, pecan, persimmon, pineapple, pistachio, plum, pomegranate, quince, raspberry, strawberry, suriname cherry, walnut, watermelon; and/or
vegetables such as artichoke, asparagus, bean snap, green lima, beet, broccoli, brussels sprouts, cabbage, cauliflower, celeriac, celery, chive, collards, cucumber, edamame, eggplant, endive, garlic, horseradish, kohlrabi, leek, lettuce, mustard greens, okra, peas, onion, opuntia, parsley, parsnip, pepper, potato, pumpkin, radish, rhubarb, rutabaga, salsify, spinach, squash, sweet corn, sweet potato, swiss chard, taro, tomato, tomatillo, turnip, and combinations thereof.

14. The method of any one of the above embodiments, wherein the cultivated crops are legumes selected from alfalfa, clover, beans, peas, chickpeas, lentils, lupins, mesquite, carob, soybeans, peanuts, and tamarind.

15. The method of any one of the above embodiments, wherein the cultivated crops are sugar crops selected from sugar beets, sugar cane, and a combination thereof.

16. The method of any one of the above embodiments, wherein the cultivated crops are not genetically modified crops.

17. The method of any one of the above embodiments, wherein PGA is a mixture of L- and D-PGA stereoisomers.

18. The method of any one of the above embodiments, wherein the PGA is L-PGA isomer.

19. The method of any one of the above embodiments, wherein PGA is D-PGA isomer.

20. The method of any one of the above embodiments, wherein the PGA is a mixture of L- and D-PGA stereoisomers in a molar ratios of L and D from about 80:20 to about 97:3.

21. The method of any one of the above embodiments, wherein the herbicidal composition is selected from:
a lipid synthesis inhibitor selected from fenoxaprop, fluazifob, quizalofob, clethodim, sethaxydim, and a combination thereof;
an amino acid synthesis inhibitor selected from chlorimuron, foramsulfuron, halosulfuron, iodosulfuron, nicosulfuron, primisulfuron, prosulfuron, rimsulfuron, thifensulfuron, tribenuron, imazamox, imazaquin, imazethapyr, flumetsulam, cloransulam, thiencarbazone, glyphosate, and a combination thereof;
a nitrogen metabolism inhibitor selected from glufosinate;
a growth regulator inhibitor selected from 2,4-D, dicamba, quinmerac, clopyralid, fluroxpyr, diflufenzopyr, and a combination thereof; and
a combination thereof.

22. The method of any one of the above embodiments, wherein the herbicidal composition is selected from glyphosate, glufosinate, 2,4-D, dicamba, quinmerac, metamitron, phenmedipham, ethofumesate, quinclorac, and a combination thereof.

23. The method of any one of the above embodiments, wherein the herbicidal composition is a non-selective herbicidal composition.

24. The method of any one of the above embodiments, wherein the herbicidally effective amount ranges from 0.005 to about 500 kilograms/hectare (kg/ha).

25. The method of any one of the above embodiments, wherein the herbicidal composition is applied to the target area using broadcast, direct, or spot application methods.

26. The method of any one of the above embodiments, wherein the herbicidal composition is applied to the target area at a rate of from about 0.1 to about 10 gallons/acre.

27. The method of any one of the above embodiments, wherein the herbicidal composition is applied with a field strength of at least about 10% of the label rate.

28. The method of any one of the above embodiments, wherein the target area is selected from an agricultural field, a garden, a lawn, an orchard, a vineyard, a plantation, and a combination thereof.

29. The method of any one of the above embodiments, wherein the herbicide composition and/or herbicide safener composition is applied to a portion of the target area.

30. The method of any one of the above embodiments, wherein the unwanted vegetation is selected from:
a monocotyledonous weed selected from the group of genera consisting of Agrostis spp., Alopecurus spp., Apera spp., Avena spp., Brachiaria spp., Bromus spp., Digitaria spp., Echinochloa spp., Eleusine spp., Eriochloa spp., Leptochloa spp., Lolium spp., Ottochloa spp., Panicum spp., Paspalum spp., Phalaris spp., Poa spp., Rottboelia spp., Setaria spp., Sorghum spp., Commelina spp., Monochoria spp., Sagittaria spp. and sedges such as Cyperus spp. and Scirpus spp.; and/or a dicotyledonous weed selected from the group of genera consisting of Abutilon spp., Ambrosia spp., Amaranthus spp., Chenopodium spp., Erysimum spp., Euphorbia spp., Fallopia spp., Galium spp., Hydrocotyle spp., Ipomoea spp., Lamium spp., Medicago spp., Oxalis spp., Plantago spp., Polygonum spp., Richardia spp., Sida spp., Sinapis spp., Solanum spp., Stellaria spp., Taraxacum spp., Trifolium spp., Veronica spp., Viola spp. and Xanthium spp; and/or glyphosphate-resistant weeds selected from the group consisting of rigid ryegrass, horseweed (marestail), Italian ryegrass, common ragweed, palmer amaranth, waterhemp, goosegrass, hairy fleabane, broadleaf plantain, johnsongrass, and wild poinsettia.

32. The method of any one of the above embodiments, wherein the herbicide safener composition is formulated into a formulation comprising one or more auxiliaries selected from a polyanion, extenders, carriers, solvents, surfactants (surface-active agents), stabilizers, anti-foaming agents, anti-freezing agents, preservatives, antioxidants, viscosity modifiers, suspending agents, light absorbers, corrosion inhibitors, fragrances, pH-modifying substances, glidants, lubricants, plasticizers, complexing agents, colorants, thickeners, solid adherents, fillers, wetting agents, dispersing agents, lubricants, anticaking agents, deformers and diluents.

33. The method of any one of the above embodiments, wherein the herbicide safener composition is in a form selected from a soluble liquid (SF), an emulsifiable concentrate (EC), a wettable powder (WP), a dry flowable (DF), a flowable (F), a water soluble powder (SP), an ultra-low-volume concentrate (ULV), a suspension concentrate (SC), an aqueous suspension (AS), a microencapsulated suspension (ME or MT), a capsule suspension (CS), a granule (G), or a pellet (P).

34. The method of any one of the above embodiments, wherein the herbicide safener composition is in the form of a ready to use formulation, a premix formulation or a tank mix formulation.

### EXAMPLES

It should be understood that the following Examples are provided by way of illustration only and nothing therein should be taken as a limiting factor.

### Example 1: Studies of PGA as an Herbicide Safener for Corn Plants Treated with Glyphosate Herbicide or Bayer All-In-One® Herbicide

Corn seeds were sown in standard 10 cm diameter pots in peat-based media (Fafard #2/Sunshine Mix #8 soilless media: 75% Canadian sphagnum peat moss, 20% perlite, 5% vermiculite, trace: dolomitic limestone, wetting agent, silicon). Plants were grown under the following environmental conditions:
Temperature: 30° C. day/23° C.
Relative humidity: 60-70%
Photoperiod: 16 hours light/8 hours dark
Light intensity: 800-1000 μMols/m²/s
   Treatments were administered 5 days after planting. In experiment 1, glyphosate was applied at 1%, 10%, and 100% of label rate, with and without PGA (0.137 g/L), as outlined in the table below. In Experiment 2, Bayer All-in-One® herbicide was applied at 10% and 100% of the label rate, with and without PGA (0.137 g/L). In both treatments, control plants received water. In both experiments, herbicide was applied as a 0.5 mL droplet by pipet on the 1^{st} fully expanded leaf; PGA was applied as a 50 mL soil drench. Plants were grown in a completely randomized design for an additional 2 days to allow the treatments to take effect. At 7 days after planting, plants were photographed, and destructively harvested for leaf area and dry biomass.

TABLE 1

| | | |
|---|---|---|
| Rate 1 | Rate 2 | Avg(DryWt) |

| | | | |
|---|---|---|---|
| 1% Label Rate Glyphosate | 0.0 | g/L PGA | 0.12 |
| | 0.137 | g/L PGA | 0.10 |
| 10% Label Rate Glyphosate | 0.0 | g/L PGA | 0.06 |
| | 0.137 | g/L PGA | 0.10 |
| 100% Label Rate Glyphosate | 0.0 | g/L PGA | 0.05 |
| 0 Glyphosate | 0.0 | g/L PGA | 0.10 |
| | 0.137 | g/L PGA | 0.15 |

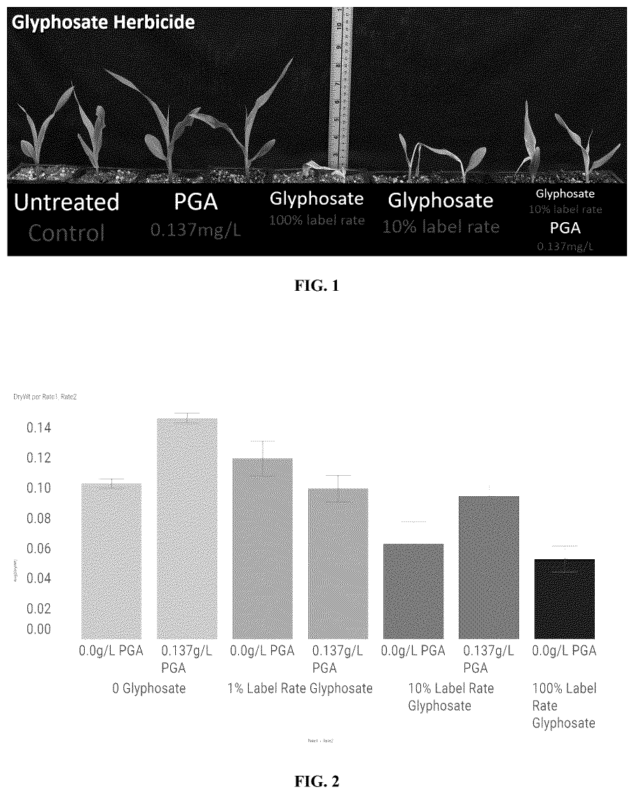

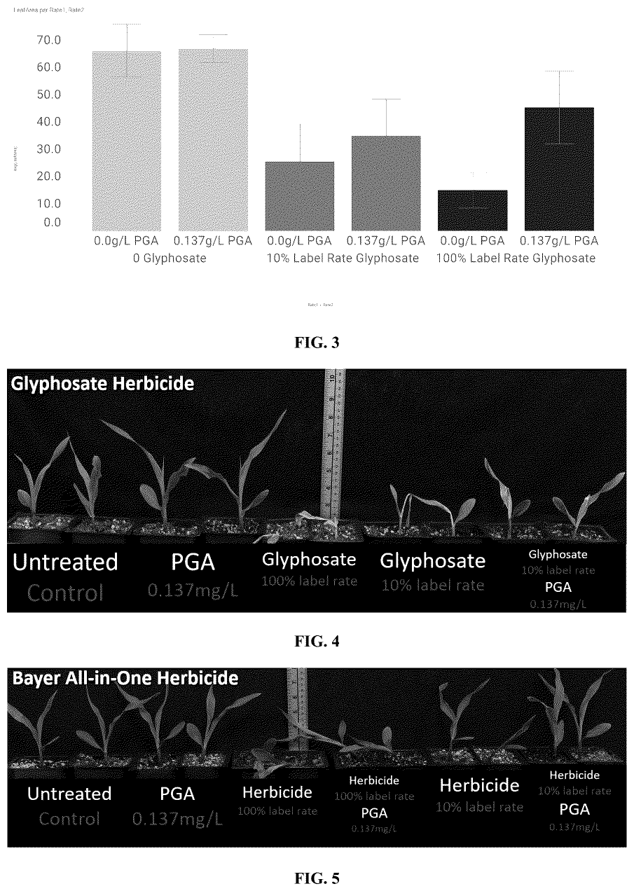

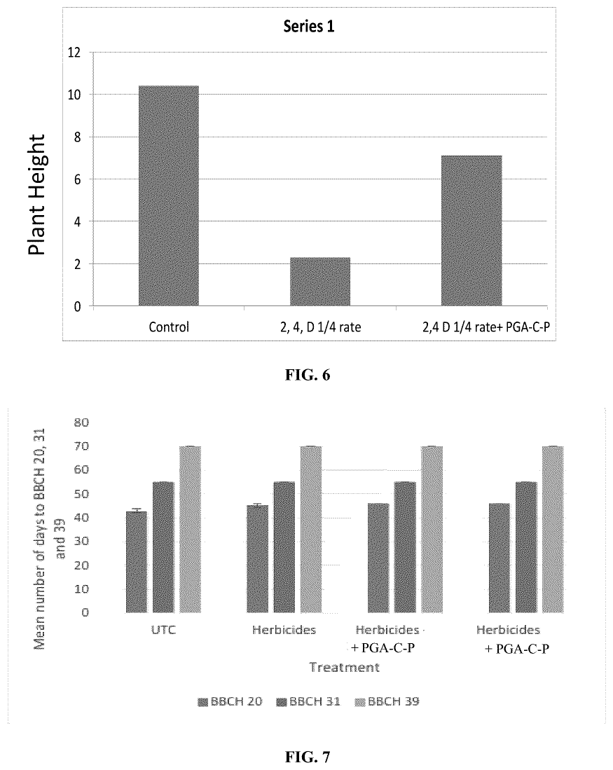

For results see FIGS. 1, 2, 3, 4 and 5.

### Example 2: Studies of PGA (Applied as TAKE OFF) as an Herbicide Safener for Soybean Plants Treated with 2,4 D

A similar procedure was carried out as in Example 1. For results see FIG. 6

### Example 3: Studies of PGA-Containing Product as an Herbicide Safener for Sugar Beet Crop Plants Treated with Various Herbicides

Summary: A trial was conducted under controlled conditions, within a glasshouse at i2 L Research Ltd, Field Station, Shotley Bridge, UK.

The trial aimed to evaluate the efficacy of PGA-containing product on sugar beet (Beta vulgaris subsp. vulgaris), in terms of its effect on early crop development and its effect on reducing herbicide stress. Herbicide products (Belvedere Duo, Goltix Titan and Hasten) were used in combination with PGA-containing test product and as a stand-alone treatment for comparison. It was concluded that:
There was no significant difference in crop development for plants to reach both BBCH31 and BBCH39, between the untreated control and herbicides combined with both rates of PGA-containing product. However, the untreated control reached BBCH20 significantly faster than all other treatments.
PGA-containing product without herbicides (applied at 2 L/ha) resulted in unexplained loss of plant vigor after application B. However, this effect was not observed when the same rate was combined with herbicides. Due to this, this treatment was removed from analyses in order to allow statistical analysis to not be skewed by this data. (See Deviation 3 in Appendix III.)
By the end of the trial at BBCH 39, both rates of PGA-containing product when combined with herbicides displayed significantly greater crop vigor when compared to the untreated control.
No phytotoxicity was displayed until after application B, where all treatments which contained herbicides displayed significant levels of phytotoxicity and this continued for the duration of the trial.
By both BBCH31 and BBCH39, both PGA-containing product rates with herbicides displayed significantly higher levels of chlorophyll content in comparison to the untreated control.
Also at both BBCH31 and BBCH39, a positive effect of the higher rate of PGA-containing product (2 L/ha) with herbicides was shown, where this treatment displayed significantly higher chlorophyll content in comparison to the herbicides without PGA-containing product.
Herbicides combined with the higher PGA-containing product rate displayed both higher fresh plant weight and higher beet weight than all other treatments; however, this was not statistically significant.

Aims & Objectives: A glasshouse trial was conducted to evaluate the efficacy of a biostimulant test product, PGA-containing product on sugar beet. The trial aimed to:
Validate the efficacy of PGA-containing product on sugar beet in terms of early crop development.
Validate the efficacy of PGA-containing product on sugar beet in terms of reduced herbicide stress.

The trial will be conducted in accordance with the principles of Good Experimental Practice (GEP) also known as “Official Recognition of Efficacy Testing Facilities or Organisations” as described in Regulation (EC) no. 1107/2009 and Commission Directive 93/71/EC.

The test substances are summarized in Table 2 below.

TABLE 2
Test Substances

| | Active | Batch | Storage | Expiry | i2L code |
|---|---|---|---|---|---|
| Test Product | substance(s) | number | conditions | Date | number |
| PGA- | Pidolic Acid | N/A | Ambient | 4 Mar. 2021* | 20030401 |
| containing | | | | | |
| Product | | | | | |
| Belvedere | Phenmedipham, | 19128231 | Ambient | 8 Dec. 2021 | 20030904 |
| Duo | Ethofumesat | | | | |
| Goltix | Metamitron, | 1903034589 | Ambient | 19 Mar. 2021* | 20030903 |
| Titan | Quinmerac | | | | |
| Hasten | Undisclosed | N/A | Ambient | 1 Apr. 2021* | 20040113 |

(*i2L Research Ltd default expiry date)

### Methodology

### Site Details:

The trial was conducted at i2 L Research Ltd (Newcastle) Field Station, County Durham (54.875647° N, −1.839069E°, 191 m elevation, EPPO climatic zone: Maritime). Plots were arranged using a randomized block design.

### Test System:

Sugar beet seeds (Beta vulgaris subsp. vulgaris var. “Degas”) were sown on Jan. 4, 2020 at a rate of 1 seed per pot in 2 L pots. Moisture was applied as and when required to enable plant germination. At BBCH growth stage 09-12, the first application was applied. Repeated applications were applied at BBCH 14-15 and 16-19.

All test products were supplied by Verdesian Life Sciences Ltd. Full details of all test products and treatment application rates are summarized in Table 3.

TABLE 3
Treatment List and Application Details

| | Product | | | Application | Application |
|---|---|---|---|---|---|
| Trt. No. | name | Rate | | Volume (L/ha) | timing |
| 1 | Untreated control | N/A | | N/A | N/A |
| 2 | PGA-containing | 2 | L/ha | 600 L/ha | ABC |
| | Product | | | | |
| 3 | Belvedere Duo | 1.25 | L/ha | 600 L/ha | ABC |
| | Goltix Titan | 2 | L/ha | | |
| | Hasten | 0.5 | L/ha | | |
| 4 | Belvedere Duo | 1.25 | L/ha | 600 L/ha | ABC |
| | Goltix Titan | 2 | L/ha | | |
| | Hasten | 0.5 | L/ha | | |
| | PGA-containing | 1 | L/ha | | |
| | Product | | | | |
| 5 | Belvedere Duo | 1.25 | L/ha | 600 L/ha | ABC |
| | Goltix Titan | 2 | L/ha | | |
| | Hasten | 0.5 | L/ha | | |
| | PGA-containing | 2 | L/ha | | |
| | Product | | | | |

All chemicals were applied using a Cooper Pegler pressurized knapsack sprayer with hollow cone nozzle for application. All spray equipment was fully calibrated prior to use. Treatments were applied at 3 growth stage ranges. Application A at BBCH 09-12, application B at BBCH 14-15 and application C at BBCH 16-19.

### Experimental Design:

The trial was conducted on sugar beet pants; var. “Degas,” under controlled conditions within a glasshouse. Plants were grown from seed in 2 L pots, and plots consisted of 10 plants per plot.

### Crop Maintenance:

All plants were watered when needed, using a hose. Care was taken to ensure that water was not directly applied to the foliage of test plants.

### Assessments:

At each application, the following information was recorded:
Time of application, temperature, relative humidity, cloud cover, crop surface moisture (wet/moist/dry) and soil moisture (wet/moist/dry)
BBCH growth stage of the crop
Any visible phytotoxicity
Vigor of the crop (0-10)
Damage to the crop (%)

At BBCH growth stages, 20, 31 and 39, the following information was recorded:
1. Crop development (Time (days) to reach each BBCH growth stage)
2. Chlorophyll content
3. Any visible phytotoxicity
4. Vigor of the crop (0-10)
5. Damage to the crop (%)
6. Photographs of each plot were also taken at each assessment
7. Climatic data (temperature and relative humidity)
   Chlorophyll content was recorded using a calibrated SPAD 502 Plus Chlorophyll meter. Following the final assessment at BBCH39, both the fresh plant weight and root/beet biomass were recorded.

### Statistical Analyses

One-way ANOVAs were performed at each assessment interval to investigate the effect of each treatment on: phytotoxicity, crop vigor, damage to the crop, crop development, chlorophyll content and final fresh plant and beet weights. A subsequent Tukey Kramer HSD comparison test was performed to distinguish between treatment means. This analysis was performed using ARM.

In all analyses, the probability of no significant differences occurring between treatments was calculated as the F probability value (p(F)). All tests were undertaken initially at the 90% confidence interval. Where significant differences were seen at 90%, analysis was repeated at the 95% confidence interval. Residuals were tested for normality where P>0.05 indicated normal distribution.

### Amendments/Deviations

Extra assessment of fresh plant and beet weights taken. (See Appendix IV)
Treatment 2—PGA-containing product removed from statistical analysis. (See Appendix IV)

### Results

The Table 4 below shows that conditions for applications in this trial:

TABLE 4
Conditions at Application:

| | Temp. | Humidity | Cloud | Crop | Soil |
|---|---|---|---|---|---|
| BBCH | (° C.) | (%) | Cover (%) | surface | surface |
| 09-12 | 19.4 | 66 | 60 | Dry | Moist |
| 14 | 27.9 | 47 | 15 | Dry | Moist |
| 16-18 | 18.7 | 68 | 100 | Dry | Moist |

### 1. Crop Development

The untreated control reached BBCH20 in significantly fewer days than all other treatments, at both the 90% confidence interval and 95% confidence interval. However, for BBCH 31 and BBCH 39, there was no significant difference in the time taken to reach either BBCH growth stage. PGA-containing product without herbicides was omitted from all analyses, due to the unexplained loss in vigor displayed in all plots following a second application. This was unexpected, especially as the same rate of PGA-containing product was included in treatment 5, alongside herbicides and no such reduction in vigor was observed with this treatment. Therefore, to prevent this abnormal data from skewing statistical analysis, it has been omitted from the analysis (see FIG. 7 and Table 5).

TABLE 5
One-way ANOVA of the time taken (days) to reach BBCH 20, BBCH 31 and BBCH 39.

| Description | | | | | Days to BBCH 20 | Days to BBCH 31 | Days to BBCH 39 |
|---|---|---|---|---|---|---|---|
| Rating Type | | | | | TIME | TIME | TIME |
| Rating Unit | | | | | DAP | DAP | DAP |
| Crop Stage Scale | | | | | BBCH | BBCH | BBCH |
| Crop Stage Majority | | | | | 20 | 31 | 39 |
| Trt-Eval Interval | | | | | 11 DA-C | 20 DA-C | 35 DA-C |
| Trt | Treatment | | Rate | Appl | | | |
| No. | Name | Rate | Unit | Code | | | |
| 1 | Untreated Check | | | | 42.8b | 55.0a | 70.0a |
| 3 | Belvedere Duo | 1.25 | 1/ha | ABC | 45.2a | 55.0a | 70.0a |
| | Goltix Titan | 2 | 1/ha | ABC | | | |
| | Hasten | 0.5 | 1/ha | ABC | | | |
| 4 | PGA-containing Product | 1 | 1/ha | ABC | 46.0a | 55.0a | 70.0a |
| | Belvedere Duo | 1.25 | 1/ha | ABC | | | |
| | Goltix Titan | 2 | 1/ha | ABC | | | |
| | Hasten | 0.5 | 1/ha | ABC | | | |
| 5 | PGA-containing Product | 2 | 1/ha | ABC | 46.0a | 55.0a | 70.0a |
| | Belvere Duo | 1.25 | 1/ha | ABC | | | |
| | Goltix Titan | 2 | 1/ha | ABC | | | |
| | Hasten | 0.5 | 1/ha | ABC | | | |

| | | | |
|---|---|---|---|
| Turkey's HSD P = .05 | 2.27 | — | — |
| Standard Deviation | 1.21 | 0.00 | 0.00 |
| CV | 2.69 | 0.0 | 0.0 |
| Levene's F | 0.00 | 0.00 | 0.00 |
| Levene's Prob (F) | 0.00* | 0.00* | 0.00* |
| Skewness | −1.2505* | — | — |
| Kurtosis | −0.4967 | — | — |
| Replicate F | 1.364 | 0.000 | 0.000 |
| Replicate Prob(F) | 0.3036 | 1.0000 | 1.0000 |
| Treatment F | 7.818 | 0.000 | 0.000 |
| Treatment Prob(F) | 0.0037 | 1.0000 | 1.0000 |

### 2. Phytotoxicity and Crop Damage

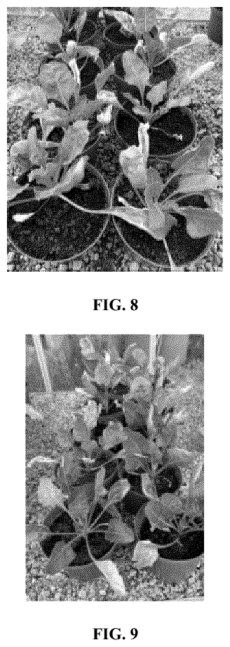

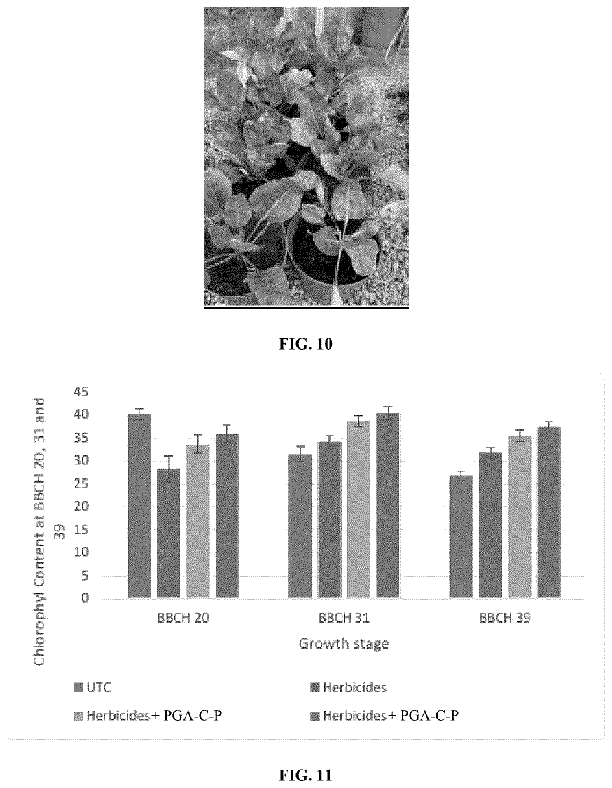

There was no phytotoxicity displayed by any treatments until after application B, where all three treatments with herbicides included displayed significant levels of phytotoxicity (at both 90% and 95% confidence intervals) and this continued for the duration of the trial. The primary damage symptoms displayed were necrosis to sections of leaves and some leaf discoloration (see Table 6 and FIGS. 8-10).

TABLE 6
One-way ANOVA on the % phytotoxicity displayed at each assessment.

| Description | | | | | Phyto | Phyto | Phyto | Phyto | Phyto | Phyto |
|---|---|---|---|---|---|---|---|---|---|---|
| Rating Type | | | | | PHYGEN | PHYGEN | PHYGEN | PHYGEN | PHYGEN | PHYGEN |
| Rating Unit | | | | | % | % | % | % | % | % |
| Crop Stage Scale | | | | | BBCH | BBCH | BBCH | BBCH | BBCH | BBCH |
| Crop Stage Majority | | | | | 09 | 14 | 16 | 20 | 31 | 39 |
| Trt-Eval Interval | | | | | 0 DA-A | 19 DA-A | 10 DA-B | 11 DA-C | 20 DA-C | 35 DA-C |
| Trt | Treatment | | Rate | Appl | | | | | | |
| No. | Name | Rate | Unit | Code | | | | | | |
| 1 | Untreated Check | | | | 0.0a | 0.0a | 0.0b | 0.0b | 0.0b | 0.0b |
| 3 | Belvedere Duo | 1.25 | 1/ha | ABC | 0.0a | 0.0a | 10.0a | 11.0a | 6.0a | 6.0a |
| | Goltix Titan | 2 | 1/ha | ABC | | | | | | |
| | Hasten | 0.5 | 1/ha | ABC | | | | | | |
| 4 | PGA-containing | 1 | 1/ha | ABC | 0.0a | 0.0a | 6.0a | 13.0a | 7.0a | 7.0a |
| | Product | | | | | | | | | |
| | Belvedere Duo | 1.25 | 1/ha | ABC | | | | | | |
| | Goltix Titan | 2 | 1/ha | ABC | | | | | | |
| | Hasten | 0.5 | 1/ha | ABC | | | | | | |
| 5 | PGA-containing | 2 | 1/ha | ABC | 0.0a | 0.0a | 6.0a | 11.0a | 8.0a | 7.0a |
| | Product | | | | | | | | | |
| | Belvedere Duo | 1.25 | 1/ha | ABC | | | | | | |
| | Goltix Titan | 2 | 1/ha | ABC | | | | | | |
| | Hasten | 0.5 | 1/ha | ABC | | | | | | |

| | | | | | | |
|---|---|---|---|---|---|---|
| Turkey's HSD P = .05 | — | — | 4.92 | 6.80 | 3.83 | 4.02 |
| Standard Deviation | 0.00 | 0.00 | 2.62 | 3.62 | 2.04 | 2.14 |
| CV | 0.0 | 0.0 | 47.67 | 41.4 | 38.88 | 42.82 |
| Levene's F | 0.00 | 0.00 | 0.762 | 1.385 | 0.917 | 0.917 |
| Levene's Prob(F) | 0.00* | 0.00* | 0.532 | 0.284 | 0.455 | 0.455 |
| Skewness | — | — | 0.3628 | −0.2609 | −0.0862 | 0.0 |
| Kurtosis | — | — | −0.3028 | −0.7406 | −1.1544 | −0.9314 |
| Replicate F | 0.000 | 0.000 | 0.273 | 0.238 | 1.800 | 1.364 |
| Replicate Prob(F) | 1.0000 | 1.0000 | 0.8899 | 0.9114 | 0.1937 | 0.3036 |
| Treatment F | 0.000 | 0.000 | 12.364 | 13.302 | 15.500 | 12.364 |
| Treatment Prob(F) | 1.0000 | 1.0000 | 0.0006 | 0.0004 | 0.0002 | 0.0006 |

### 3. Crop Vigor

Significantly lower crop vigor was also displayed by the treatment of herbicides alone PG-8T in comparison to the untreated control at 11DAC, with necrosis displayed. However, by the next assessment interval, there was no longer any significant difference in the crop vigor between these treatments. At the final assessment 35DAC, at BBCH 39, both herbicide treatments which contained PGA-containing product displayed significantly greater crop vigor when compared to the untreated control (at both 90% and 95% o confidence intervals) (see Table 7).

TABLE 7
One-way ANOVA on the crop vigor displayed at each assessment.

| Description | | | | | Vigor | Vigor | Vigor | Vigor | Vigor M | Vigor |
|---|---|---|---|---|---|---|---|---|---|---|
| Rating Type | | | | | VIGOR | VIGOR | VIGOR | VIGOR | VIGOR | VIGOR |
| Rating Unit | | | | | 0-10 | 0-10 | 0-10 | 0-10 | 0-10 | 0-10 |
| Crop Stage Scale | | | | | BBCH | BBCH | BBCH | BBCH | BBCH | BBCH |
| Crop Stage Majority | | | | | 09 | 14 | 16 | 20 | 31 | 39 |
| Trt-Eval Interval | | | | | 0 DA-A | 19 DA-A | 10 DA-B | 11 DA-C | 20 DA-C | 35 DA-C |
| Trt | Treatment | | Rate | Appl | | | | | | |
| No. | Name | Rate | Unit | Code | | | | | | |
| 1 | Untreated Check | | | | 10.0a | 10.0a | 10.0a | 10.0a | 10.0a | 9.0b |
| 3 | Belvedere Duo | | 1/ha | ABC | 10.0a | 10.0a | 9.0a | 8.0b | 9.8a | 9.6ab |
| | Goltix Titan | 2 | 1/ha | ABC | | | | | | |
| | Hasten | 0.5 | 1/ha | ABC | | | | | | |
| 4 | PGA-containing | 1 | 1/ha | ABC | 10.0a | 10.0a | 9.4a | 8.4ab | 10.0a | 9.8a |
| | Product | | | | | | | | | |
| | Belvedere Duo | 1.25 | 1/ha | ABC | | | | | | |
| | Goltix Titan | 2 | 1/ha | ABC | | | | | | |
| | Hasten | 0.5 | 1/ha | ABC | | | | | | |
| 5 | PGA-containing | 2 | 1/ha | ABC | 10.0a | 10.0a | 10.0a | 8.8ab | 10.0a | 9.8a |
| | Product | | | | | | | | | |
| | Belvedere Duo | 1.25 | 1/ha | ABC | | | | | | |
| | Goltix Titan | 2 | 1/ha | ABC | | | | | | |
| | Hasten | 0.5 | 1/ha | ABC | | | | | | |

| | | | | | | |
|---|---|---|---|---|---|---|
| Turkey's HSD P = .05 | — | — | 1.37 | 1.86 | 0.43-0.43 | 0.79 |
| Standard Deviation | 0.00 | 0.00 | 0.73 | 0.99 | 0.04t | 0.42 |
| CV | 0.0 | 0.0 | 7.61 | 11.27 | 1.09t | 4.38 |
| Levene's F | 0.00 | 0.00 | 3.40 | 1.686 | 1.00 | 0.267 |
| Levene's Prob(F) | 0.00* | 0.00* | 0.044* | 0.21 | 0.418 | 0.848 |
| Skewness | — | — | −1.6047* | −0.2573 | −4.4721* | −1.0032 |
| Kurtosis | — | — | 1.0004 | 1.4636 | 20.0* | 0.1886 |
| Replicate F | 0.000 | 0.000 | 0.375 | 0.559 | 1.000 | 3.857 |
| Replicate Prob(F) | 1.0000 | 1.0000 | 0.8221 | 0.6966 | 0.4449 | 0.0307 |
| Treatment F | 0.000 | 0.000 | 2.250 | 3.797 | 1.000 | 4.095 |
| Treatment Prob(F) | 1.0000 | 1.0000 | 0.1349 | 0.0400 | 0.4262 | 0.0324 |

### 4. Chlorophyll Content

At BBCH20, herbicides without the PGA-containing product treatment displayed significantly lower chlorophyll content when compared to the untreated control. There was no significant difference in the chlorophyll content between the untreated control and the PGA-containing product at both rates, with the herbicides.

By BBCH31, both PGA-containing product rates+herbicides displayed significantly higher levels of chlorophyll content when compared to the untreated control. The herbicides with the higher rate of PGA-containing product (2 L/ha) also displayed significantly higher chlorophyll content in comparison to the herbicides without PGA-containing product at this assessment.

At the final assessment, BBCH39, this same trend continued with both herbicides with PGA-containing product treatments displaying significantly higher levels of chlorophyll content than the untreated control. The higher rate of PGA-containing product (2 L/ha) with herbicides also continued to display significantly higher levels of chlorophyll content in comparison to herbicides without PGA-containing product. All significant differences were found at both the 90% and 95% confidence intervals (see Table 8 and FIG. 11).

TABLE 8
One-way ANOVA on the chlorophyll content displayed at each assessment.

| Description | | | | | Chlorophyll Co> | Chlorophyll Co> | Chlorophyll Co> |
|---|---|---|---|---|---|---|---|
| Rating Type | | | | | CHLCON | CHLCON | CHLCON |
| Rating Unit | | | | | NUMBER | NUMBER | NUMBER |
| Crop Stage Scale | | | | | BBCH | BBCH | BBCH |
| Crop Stage Majority | | | | | 20 | 31 | 39 |
| Trt-Eval Interval | | | | | 11 DA-C | 20 DA-C | 35 DA-C |
| Trt | Treatment | | Rate | Appl | | | |
| No. | Name | Rate | Unit | Code | | | |
| 1 | Untreated Check | | | | 40.12a | 31.40c | 26.74c |
| 3 | Belvedere Duo | 1.25 | 1/ha | ABC | 28.22b | 33.98bc | 31.66bc |
| | Goltix Titan | 2 | 1/ha | ABC | | | |
| | Hasten | 0.5 | 1/ha | ABC | | | |
| 4 | PGA-containing | 1 | 1/ha | ABC | 33.50ab | 38.62ab | 35.36ab |
| | Product | | | | | | |
| | Belvedere Duo | 1.25 | 1/ha | ABC | | | |
| | Goltix Titan | 2 | 1/ha | ABC | | | |
| | Hasten | 0.5 | 1/ha | ABC | | | |
| 5 | PGA-containing | 2 | 1/ha | ABC | 35.82ab | 40.36a | 37.44a |
| | Product | | | | | | |
| | Belvere Duo | 1.25 | 1/ha | ABC | | | |
| | Goltix Titan | 2 | 1/ha | ABC | | | |
| | Hasten | 0.5 | 1/ha | ABC | | | |

| | | | |
|---|---|---|---|
| Turkey's HSD P = .05 | 9.201 | 5.533 | 5.120 |
| Standard Deviation | 4.900 | 2.946 | 2.727 |
| CV | 14.24 | 8.16 | 8.31 |
| Levene's F | 0.244 | 0.115 | 0.153 |
| Levene's Prob(F) | 0.865 | 0.95 | 0.926 |
| Skewness | −0.3821 | −0.214 | −0.2593 |
| Kurtosis | −1.2212 | −0.8079 | −0.7768 |
| Replicate F | 0.567 | 1.453 | 0.241 |
| Replicate Prob(F) | 0.6917 | 0.2766 | 0.9098 |
| Treatment F | 5.119 | 9.808 | 14.821 |
| Treatment Prob(F) | 0.0165 | 0.0015 | 0.0002 |

### 5. Fresh Plant Weight

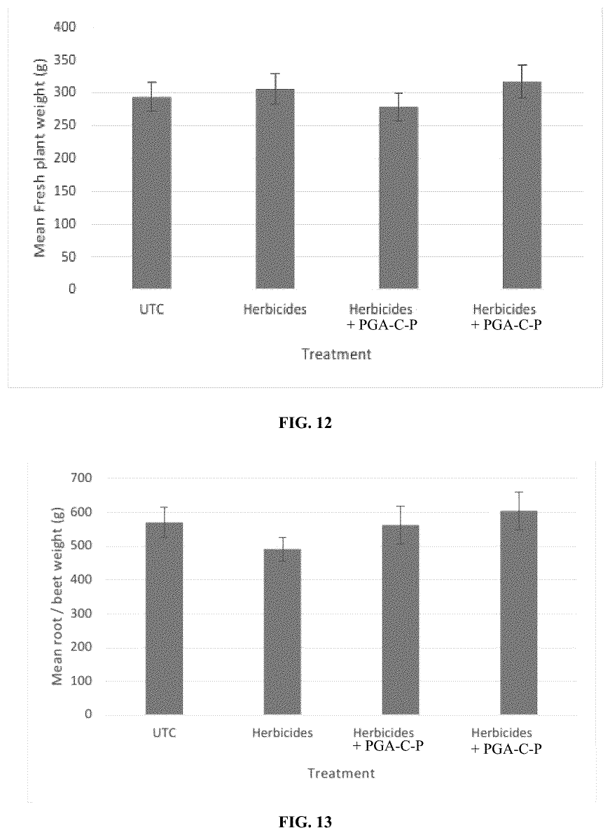

Herbicides combined with the higher PGA-containing product rate (2 L/ha) displayed the highest fresh plant weight; however, this was not statistically significant including at the 90% confidence interval (see Table 9 and FIG. 12).

TABLE 9
One-way ANOVA of the fresh plant weight at the end of the trial.

| Description | | | | | Fresh plant we> |
|---|---|---|---|---|---|
| Rating Type | | | | | WEIFRE |
| Rating Unit | | | | | 9 |
| Crop Stage Scale | | | | | BBCH |
| Crop Stage Majority | | | | | 39 |
| Trt-Eval Interval | | | | | 39 DA-C |
| Trt | Treatment | | Rate | Appl | |
| No. | Name | Rate | Unit | Code | |
| 1 | Untreated Check | | | | 292.8a |
| 3 | Belvedere Duo | 1.25 | l/ha | ABC | 305.4a |
| | Goltix Titan | 2 | l/ha | ABC | |
| | Hasten | 0.5 | l/ha | ABC | |
| 4 | PGA-containing Product | 1 | l/ha | ABC | 277.8a |
| | Belvedere Duo | 1.25 | l/ha | ABC | |
| | Goltix Titan | 2 | l/ha | ABC | |
| | Hasten | 0.5 | l/ha | ABC | |
| 5 | PGA-containing Product | 2 | l/ha | ABC | 316.0a |
| | Belvedere Duo | 1.25 | l/ha | ABC | |
| | Goltix Titan | 2 | l/ha | ABC | |
| | Hasten | 0.5 | l/ha | | |

| | |
|---|---|
| Turkey's HSD P = .10 | 87.13 |
| Standard Deviation | 53.81 |
| CV | 18.06 |
| Levene's F | 0.085 |
| Levene's Prob(F) | 0.967 |
| Skewness | 0.9718 |
| Kurtosis | −0.1633 |
| Replicate F | 0.755 |
| Replicate Prob(F) | 0.5736 |
| Treatment F | 0.468 |
| Treatment Prob(F) | 0.7097 |

### 6. Root/Beet Weight

Similarly to the fresh plant weight, herbicides combined with the higher PGA-containing product rate (2 L/ha) displayed the highest beet weight; however, again this was not statistically significant including at the 90% confidence interval (see Table 10 and FIG. 13).

TABLE 10
One-way ANOVA of the root/beet weight at the end of the trial.

| Description | | | | | Root/beet we> |
|---|---|---|---|---|---|
| Rating Type | | | | | WEIGHT |
| Rating Unit | | | | | g |
| Crop Stage Scale | | | | | BBCH |
| Crop Stage Majority | | | | | 39 |
| Trt-Eval Interval | | | | | 39 DA-C |
| Trt | Treatment | | Rate | Appl | |
| No. | Name | Rate | Unit | Code | |
| 1 | Untreated Check | | | | 568.8a |
| 3 | Belvedere Duo | 1.25 | l/ha | ABC | 489.6a |
| | Goltix Titan | 2 | l/ha | ABC | |
| | Hasten | 0.5 | l/ha | ABC | |
| 4 | PGA-containing Product | 1 | l/ha | ABC | 560.6a |
| | Belvedere Duo | 1.25 | l/ha | ABC | |
| | Goltix Titan | 2 | l/ha | ABC | |
| | Hasten | 0.5 | l/ha | ABC | |
| 5 | PGA-containing Product | 2 | l/ha | ABC | 602.8a |
| | Belvedere Duo | 1.25 | l/ha | ABC | |
| | Hasten | 0.5 | l/ha | ABC | |
| | Goltix Titan | 2 | l/ha | ABC | |
| | Hasten | 0.5 | l/ha | | |

| | |
|---|---|
| Turkey's HSD P = .10 | 174.11 |
| Standard Deviation | 107.52 |
| CV | 19.36 |
| Levene's F | 0.224 |
| Levene's Prob(F) | 0.878 |
| Skewness | 0.9156 |
| Kurtosis | −0.2947 |
| Replicate F | 1.192 |
| Replicate Prob(F) | 0.3637 |
| Treatment F | 0.978 |
| Treatment Prob(F) | 0.4354 |

APPENDIX I
Raw Data

| Crop Type, Code | | | | | | C BEAVP | C BEAVP | C BEAVP | C BEAVP | C BEAVP |
|---|---|---|---|---|---|---|---|---|---|---|
| BBCH Scale | | | | | | BPER | BPER | BPER | BPER | BPER |
| Crop Scientific Name | | | | | | Beta vulgaris > | Beta vulgaris > | Beta vulgaris > | Beta vulgaris > | Beta vulgaris > |
| Crop Name | | | | | | Planted sugar > | Planted sugar > | Planted sugar > | Planted sugar > | Planted sugar > |
| Crop Variety | | | | | | Degas | Degas | Degas | Degas | Degas |
| Description | | | | | | Phyto | Vigor | Damage | Phyto | Vigor |
| | | | | | | | | to crop | | |
| Rating Date | | | | | | Apr. 1, 2020 | Apr. 1, 2020 | Apr. 1, 2020 | Apr. 1, 2020 | Apr. 1, 2020 |
| SE Group No. | | | | | | 1 | 1 | 2 | 3 | 3 |
| Part Rated | | | | | | PLANT - | PLANT - | PLANT - | PLANT - | PLANT - |
| Rating Type | | | | | | PHYGEN | VIGOR | DAMAGE | PHYGEN | VIGOR |
| Rating Unit | | | | | | % | % | % | % | 0-10 |
| Sample Size | | | | | | 10 PLANT | 10 PLANT | 10 PLANT | 10 PLANT | 10 PLANT |
| Collection Basis | | | | | | 1 PLOT | 1 PLOT | 1 PLOT | 1 PLOT | 1 PLOT |
| Reporting Basis | | | | | | 1 PLOT | 1 PLOT | 1 PLOT | 1 PLOT | 1 PLOT |
| Number of Subsamples | | | | | | 1 | 1 | 1 | 1 | 1 |
| Crop Stage Scale | | | | | | BBCH | BBCH | BBCH | BBCH | BBCH |
| Crop Stage Majority | | | | | | 09 | 09 | 09 | 14 | 14 |
| Crop Stage Minimum/Maximum | | | | | | 09-12 - | 09-12 - | 09-12 - | 14 - | 14 - |
| Crop Density | | | | | | 10 PLOT | 10 PLOT | 10 PLOT | 10 PLOT | 10 PLOT |
| Assessed By | | | | | | MV | MV | MV | MV | MV |
| Data Entry Date | | | | | | May 15, 2020 | May 15, 2020 | May 15, 2020 | May 15, 2020 | May 15, 2020 |
| Rating Timing | | | | | | AO | AO | AO | A1 | A1 |
| Days After First/Last Applic. | | | | | | 0 0 | 0 0 | 0 0 | 19 19 | 19 19 |
| Trt-Eval Interval | | | | | | 0 DA-A | 0 DA-A | 0 DA-A | 19 DA-A | 19 DA-A |
| Plant-Eval Interval | | | | | | 6 DP-1 | 6 DP-1 | 6 DP-1 | 25 DP-1 | 25 DP-1 |
| ARM Action Codes | | | | | | | | | | |
| Trt | Treatment | | Rate | Appl | | | | | | |
| No. | Name | Rate | Unit | Code | Plot | 1 | 2 | 3 | 4 | 5 |
| 1 | Untreated | | | | 102 | 0.0 | 10.0 | 0.0 | 0.0 | 10.0 |
| | Check | | | | 205 | 0.0 | 10.0 | 0.0 | 0.0 | 10.0 |
| | | | | | 305 | 0.0 | 10.0 | 0.0 | 0.0 | 10.0 |
| | | | | | 403 | 0.0 | 10.0 | 0.0 | 0.0 | 10.0 |
| | | | | | 501 | 0.0 | 10.0 | 0.0 | 0.0 | 10.0 |
| | | | | | Mean= | 0.0 | 10.0 | 0.0 | 0.0 | 10.0 |
| 2 | PGA-containing | | 21/ha | ABC | 101 | 0.0 | 10.0 | 0.0 | 0.0 | 10.0 |
| | Product | | | | 202 | 0.0 | 10.0 | 0.0 | 0.0 | 10.0 |
| | | | | | 301 | 0.0 | 10.0 | 0.0 | 0.0 | 10.0 |
| | | | | | 401 | 0.0 | 10.0 | 0.0 | 0.0 | 10.0 |
| | | | | | 505 | 0.0 | 10.0 | 0.0 | 0.0 | 10.0 |
| | | | | | Mean= | 0.0 | 10.0 | 0.0 | 0.0 | 10.0 |
| 3 | Belvedere | | 1.251/ha | ABC | 103 | 0.0 | 10.0 | 0.0 | 0.0 | 10.0 |
| | Goltix | | 21/ha | ABC | 201 | 0.0 | 10.0 | 0.0 | 0.0 | 10.0 |
| | Titan | | | | | | | | | |
| | Hasten | | 0.51/ha | ABC | 304 | 0.0 | 10.0 | 0.0 | 0.0 | 10.0 |
| | | | | | 402 | 0.0 | 10.0 | 0.0 | 0.0 | 10.0 |
| | | | | | 502 | 0.0 | 10.0 | 0.0 | 0.0 | 10.0 |
| | | | | | Mean= | 0.0 | 10.0 | 0.0 | 0.0 | 10.0 |
| 4 | PGA-containing | | 11/ha | ABC | 105 | 0.0 | 10.0 | 0.0 | 0.0 | 10.0 |
| | Product | | | | | | | | | |
| | Belvedere | | 1.251/ha | ABC | 204 | 0.0 | 10.0 | 0.0 | 0.0 | 10.0 |
| | Duo | | | | | | | | | |
| | Goltix | | 21/ha | ABC | 302 | 0.0 | 10.0 | 0.0 | 0.0 | 10.0 |
| | Titan | | | | | | | | | |
| | Hasten | | 0.51/ha | ABC | 404 | 0.0 | 10.0 | 0.0 | 0.0 | 10.0 |
| | | | | | 504 | 0.0 | 10.0 | 0.0 | 0.0 | 10.0 |
| | | | | | Mean= | 0.0 | 10.0 | 0.0 | 0.0 | 10.0 |
| 5 | PGA-containing | | 11/ha | ABC | 104 | 0.0 | 10.0 | 0.0 | 0.0 | 10.0 |
| | Product | | | | | | | | | |
| | Belvedere | | 1.251/ha | ABC | 203 | 0.0 | 10.0 | 0.0 | 0.0 | 10.0 |
| | Duo | | | | | | | | | |
| | Goltix | | 21/ha | ABC | 303 | 0.0 | 10.0 | 0.0 | 0.0 | 10.0 |
| | Titan | | | | | | | | | |
| | Hasten | | 0.51/ha | ABC | 405 | 0.0 | 10.0 | 0.0 | 0.0 | 10.0 |
| | | | | | 503 | 0.0 | 10.0 | 0.0 | 0.0 | 10.0 |
| | | | | | Mean= | 0.0 | 10.0 | 0.0 | 0.0 | 10.0 |
| Crop Type, Code | | | | | | C BEAVP | C BEAVP | C BEAVP | C BEAVP | C BEAVP |
| BBCH Scale | | | | | | BPER | BPER | BPER | BPER | BPER |
| Crop Scientific Name | | | | | | Beta vulgaris > | Beta vulgaris > | Beta vulgaris > | Beta vulgaris > | Beta vulgaris > |
| Crop Name | | | | | | Planted sugar > | Planted sugar > | Planted sugar > | Planted sugar > | Planted sugar > |
| Crop Variety | | | | | | Degas | Degas | Degas | Degas | Degas |
| Description | | | | | | Damage | Phyto | Vigor | Damage | Days to |
| | | | | | | to crop | | | to crop | BBCH 20 |
| Rating Date | | | | | | Apr. 20, 2020 | Apr. 30, 2020 | Apr. 30, 2020 | Apr. 30, 2020 | May 11, 2020 |
| SE Group No. | | | | | | 4 | 5 | 5 | 6 | 7 |
| Part Rated | | | | | | PLANT - | PLANT - | PLANT - | PLANT - | PLANT - |
| Rating Type | | | | | | DAMAGE | PHYDEN | VIGOR | DAMAGE | TIME |
| Rating Unit | | | | | | % | % | 0-10 | % | % |
| Sample Size | | | | | | 10 PLANT | 10 PLANT | 10 PLANT | 10 PLANT | 10 PLANT |
| Collection Basis | | | | | | 1 PLOT | 1 PLOT | 1 PLOT | 1 PLOT | 1 PLOT |
| Reporting Basis | | | | | | 1 PLOT | 1 PLOT | 1 PLOT | 1 PLOT | 1 PLOT |
| Number of Subsamples | | | | | | 1 | 1 | 1 | 1 | 1 |
| Crop Stage Scale | | | | | | BBCH | BBCH | BBCH | BBCH | BBCH |
| Crop Stage Majority | | | | | | 14 | 16 | 16 | 16 | 20 |
| Crop Stage Minimum/Maximum | | | | | | 14 - | 16-18 - | 16-18 - | 16-18 - | 20 - |
| Crop Density | | | | | | 10 PLOT | 10 PLOT | 10 PLOT | 10 PLOT | 10 PLOT |
| Assessed By | | | | | | MV | MV | MV | MV | MV |
| Data Entry Date | | | | | | May 15, 2020 | May 15, 2020 | May 15, 2020 | May 15, 2020 | May 15, 2020 |
| Rating Timing | | | | | | A1 | A2 | A2 | A2 | A3 |
| Days After First/Last Applic. | | | | | | 19 19 | 29 10 | 29 10 | 29 10 | 40 11 |
| Trt-Eval Interval | | | | | | 19 DA-A | 10 DA-B | 10 DA-B | 10 DA-B | 11 DA-C |
| Plant-Eval Interval | | | | | | 25 DP-1 | 35 DP-1 | 35 DP-1 | 35 DP-1 | 46 DP-1 |
| ARM Action Codes | | | | | | | | | | |
| Trt | Treatment | | Rate | Appl | | | | | | |
| No. | Name | Rate | Unit | Code | Plot | 6 | 7 | 8 | 9 | 10 |
| 1 | Untreated | | | | 102 | 0.0 | 0.0 | 10.0 | 0.0 | 42.0 |
| | Check | | | | 205 | 0.0 | 0.0 | 10.0 | 0.0 | 42.0 |
| | | | | | 305 | 0.0 | 0.0 | 10.0 | 0.0 | 46.0 |
| | | | | | 403 | 0.0 | 0.0 | 10.0 | 0.0 | 42.0 |
| | | | | | 501 | 0.0 | 0.0 | 10.0 | 0.0 | 42.0 |
| | | | | | Mean= | 0.0 | 0.0 | 10.0 | 0.0 | 42.8 |
| 2 | PGA-containing | | 21/ha | ABC | 101 | 0.0 | 0.0 | 5.0 | 0.0 | — |
| | Product | | | | 202 | 0.0 | 0.0 | 5.0 | 0.0 | — |
| | | | | | 301 | 0.0 | 0.0 | 5.0 | 0.0 | — |
| | | | | | 401 | 0.0 | 0.0 | 5.0 | 0.0 | — |
| | | | | | 505 | 0.0 | 0.0 | 5.0 | 0.0 | — |
| | | | | | Mean= | 0.0 | 0.0 | 5.0 | 0.0 | — |
| 3 | Belvedere | | 1.251/ha | ABC | 103 | 0.0 | 5.0 | 10.0 | 5.0 | 42.0 |
| | Goltix | | 21/ha | ABC | 201 | 0.0 | 10.0 | 9.0 | 10.0 | 46.0 |
| | Titan | | | | | | | | | |
| | Hasten | | 0.51/ha | ABC | 304 | 0.0 | 10.0 | 10.0 | 10.0 | 46.0 |
| | | | | | 402 | 0.0 | 15.0 | 8.0 | 15.0 | 46.0 |
| | | | | | 502 | 0.0 | 10.0 | 8.0 | 10.0 | 46.0 |
| | | | | | Mean= | 0.0 | 10.0 | 9.0 | 10.0 | 45.2 |
| 4 | PGA-containing | | 11/ha | ABC | 105 | 0.0 | 10.0 | 8.0 | 10.0 | 46.0 |
| | Product | | | | | | | | | |
| | Belvedere | | 1.251/ha | ABC | 204 | 0.0 | 5.0 | 9.0 | 5.0 | 46.0 |
| | Duo | | | | | | | | | |
| | Goltix | | 21/ha | ABC | 302 | 0.0 | 5.0 | 10.0 | 5.0 | 46.0 |
| | Titan | | | | | | | | | |
| | Hasten | | 0.51/ha | ABC | 404 | 0.0 | 5.0 | 10.0 | 5.0 | 46.0 |
| | | | | | 504 | 0.0 | 5.0 | 10.0 | 5.0 | 46.0 |
| | | | | | Mean= | 0.0 | 6.0 | 9.4 | 6.0 | 46.0 |
| 5 | PGA-containing | | 11/ha | ABC | 104 | 0.0 | 5.0 | 10.0 | 5.0 | 46.0 |
| | Product | | | | | | | | | |
| | Belvedere | | 1.251/ha | ABC | 203 | 0.0 | 5.0 | 10.0 | 5.0 | 46.0 |
| | Duo | | | | | | | | | |
| | Goltix | | 21/ha | ABC | 303 | 0.0 | 10.0 | 10.0 | 10.0 | 46.0 |
| | Titan | | | | | | | | | |
| | Hasten | | 0.51/ha | ABC | 405 | 0.0 | 5.0 | 10.0 | 5.0 | 46.0 |
| | | | | | 503 | 0.0 | 5.0 | 10.0 | 5.0 | 46.0 |
| | | | | | Mean= | 0.0 | 6.0 | 10.0 | 6.0 | 46.0 |
| Crop Type, Code | | | | | | C BEAVP | C BEAVP | C BEAVP | C BEAVP | C BEAVP |
| BBCH Scale | | | | | | BPER | BPER | BPER | BPER | BPER |
| Crop Scientific Name | | | | | | Beta vulgaris > | Beta vulgaris > | Beta vulgaris > | Beta vulgaris > | Beta vulgaris |
| Crop Name | | | | | | Planted sugar > | Planted sugar > | Planted sugar > | Planted sugar > | Planted sugar > |
| Crop Variety | | | | | | Degas | Degas | Degas | Degas | Degas |
| Description | | | | | | Chlorophyll | Phyto | Vigor | Damage | Days to |
| | | | | | | Co> | | | to crop | BBCH 31 |
| Rating Date | | | | | | May 11, 2020 | May 11, 2020 | May 11, 2020 | May 11, 2020 | May 30, 2020 |
| SE Group No. | | | | | | 8 | 9 | 10 | 11 | 12 |
| Part Rated | | | | | | PLANT - | PLANT - | PLANT - | PLANT - | PLANT - |
| Rating Type | | | | | | CHLCON | PHYGEN | VIGOR | DAMAGE | TIME |
| Rating Unit | | | | | | NUMBER | % | 0-10 | % | DAP |
| Sample Size | | | | | | 10 PLANT | 10 PLANT | 10 PLANT | 10 PLANT | 10 PLANT |
| Collection Basis | | | | | | 1 PLOT | 1 PLOT | 1 PLOT | 1 PLOT | 1 PLOT |
| Reporting Basis | | | | | | 1 PLOT | 1 PLOT | 1 PLOT | 1 PLOT | 1 PLOT |
| Number of Subsamples | | | | | | 1 | 1 | 1 | 1 | 1 |
| Crop Stage Scale | | | | | | BBCH | BBCH | BBCH | BBCH | BBCH |
| Crop Stage Majority | | | | | | 20 | 20 | 20 | 20 | 31 |
| Crop Stage Minimum/Maximum | | | | | | 20 - | 20 - | 20 - | 20 - | 31 - |
| Crop Density | | | | | | 10 PLOT | 10 PLOT | 10 PLOT | 10 PLOT | 10 PLOT |
| Assessed By | | | | | | MV | MV | MV | MV | MV |
| Data Entry Date | | | | | | May 15, 2020 | May 15, 2020 | May 15, 2020 | May 15, 2020 | May 20, 2020 |
| Rating Timing | | | | | | A3 | A3 | A3 | A3 | A4 |
| Days After First/Last Applic. | | | | | | 40 11 | 40 11 | 40 11 | 40 11 | 49 20 |
| Trt-Eval Interval | | | | | | 11 DA-C | 11 DA-C | 11 DA-C | 10 DA-B | 20 DA-C |
| Plant-Eval Interval | | | | | | 46 DP-1 | 46 DP-1 | 46 DP-1 | 46 DP-1 | 55 DP-1 |
| ARM Action Codes | | | | | | | | | | |
| Trt | Treatment | | Rate | Appl | | | | | | |
| No. | Name | Rate | Unit | Code | Plot | 11 | 12 | 13 | 14 | 15 |
| 1 | Untreated | | | | 102 | 41.70 | 0.0 | 10.0 | 0.0 | 55.0 |
| | Check | | | | 205 | 38.80 | 0.0 | 10.0 | 0.0 | 55.0 |
| | | | | | 305 | 36.20 | 0.0 | 10.0 | 0.0 | 55.0 |
| | | | | | 403 | 42.90 | 0.0 | 10.0 | 0.0 | 55.0 |
| | | | | | 501 | 41.00 | 0.0 | 10.0 | 0.0 | 55.0 |
| | | | | | Mean= | 40.12 | 0.0 | 10.0 | 0.0 | 55.0 |
| 2 | PGA-containing | | 21/ha | ABC | 101 | — | — | — | — | — |
| | Product | | | | 202 | — | — | — | — | — |
| | | | | | 301 | — | — | — | — | — |
| | | | | | 401 | — | — | — | — | — |
| | | | | | 505 | — | — | — | — | — |
| | | | | | Mean= | — | — | — | — | — |
| 3 | Belvedere | | 1.251/ha | ABC | 103 | 38.80 | 5.0 | 10.0 | 5.0 | 55.0 |
| | Goltix | | 21/ha | ABC | 201 | 25.10 | 10.0 | 8.0 | 10.0 | 55.0 |
| | Titan | | | | | | | | | |
| | Hasten | | 0.51/ha | ABC | 304 | 25.60 | 10.0 | 8.0 | 10.0 | 55.0 |
| | | | | | 402 | 23.40 | 15.0 | 7.0 | 15.0 | 55.0 |
| | | | | | 502 | 28.20 | 15.0 | 7.0 | 15.0 | 55.0 |
| | | | | | Mean= | 28.22 | 11.0 | 8.0 | 11.0 | 55.0 |
| 4 | PGA-containing | | 11/ha | ABC | 105 | 29.30 | 20.0 | 8.0 | 20.0 | 55.0 |
| | Product | | | | | | | | | |
| | Belvedere | | 1.251/ha | ABC | 204 | 34.70 | 15.0 | 9.0 | 15.0 | 55.0 |
| | Duo | | | | | | | | | |
| | Goltix | | 21/ha | ABC | 302 | 28.80 | 10.0 | 10.0 | 10.0 | 55.0 |
| | Titan | | | | | | | | | |
| | Hasten | | 0.51/ha | ABC | 404 | 40.10 | 10.0 | 10.0 | 10.0 | 55.0 |
| | | | | | 504 | 34.60 | 10.0 | 10.0 | 10.0 | 55.0 |
| | | | | | Mean= | 33.50 | 13.0 | 9.4 | 13.0 | 55.0 |
| 5 | PGA-containing | | 11/ha | ABC | 104 | 31.10 | 15.0 | 8.0 | 15.0 | 55.0 |
| | Product | | | | | | | | | |
| | Belvedere | | 1.251/ha | ABC | 203 | 31.10 | 10.0 | 9.0 | 10.0 | 55.0 |
| | Duo | | | | | | | | | |
| | Goltix | | 21/ha | ABC | 303 | 39.10 | 10.0 | 9.0 | 10.0 | 55.0 |
| | Titan | | | | | | | | | |
| | Hasten | | 0.51/ha | ABC | 405 | 37.80 | 10.0 | 10.0 | 10.0 | 55.0 |
| | | | | | 503 | 40.00 | 10.0 | 8.0 | 10.0 | 55.0 |
| | | | | | Mean= | 35.82 | 11.0 | 8.8 | 11.0 | 55.0 |
| Crop Type, Code | | | | | | C BEAVP | C BEAVP | C BEAVP | C BEAVP | C BEAVP |
| BBCH Scale | | | | | | BPER | BPER | BPER | BPER | BPER |
| Crop Scientific Name | | | | | | Beta vulgaris > | Beta vulgaris > | Beta vulgaris > | Beta vulgaris > | Beta vulgaris > |
| Crop Name | | | | | | Planted sugar > | Planted sugar > | Planted sugar > | Planted sugar > | Planted sugar > |
| Crop Variety | | | | | | Degas | Degas | Degas | Degas | Degas |
| Description | | | | | | Chlorophyll | Phyto | Vigor | Damage | Days to |
| | | | | | | Co> | | | to crop | BBCH 39 |
| Rating Date | | | | | | May 20, 2020 | May 20, 2020 | May 20, 2020 | May 20, 2020 | Jun. 4, 2020 |
| SE Group No. | | | | | | 13 | 14 | 15 | 16 | 17 |
| Part Rated | | | | | | PLANT - | PLANT - | PLANT - | PLANT - | PLANT - |
| Rating Type | | | | | | CHLCON | PHYGEN | VIGOR | DAMAGE | TIME |
| Rating Unit | | | | | | NUMBER | % | 0-10 | % | DAP |
| Sample Size | | | | | | 10 PLANT | 10 PLANT | 10 PLANT | 10 PLANT | 10 PLANT |
| Collection Basis | | | | | | 1 PLOT | 1 PLOT | 1 PLOT | 1 PLOT | 1 PLOT |
| Reporting Basis | | | | | | 1 PLOT | 1 PLOT | 1 PLOT | 1 PLOT | 1 PLOT |
| Number of Subsamples | | | | | | 1 | 1 | 1 | 1 | 1 |
| Crop Stage Scale | | | | | | BBCH | BBCH | BBCH | BBCH | BBCH |
| Crop Stage Majority | | | | | | 31 | 31 | 31 | 31 | 39 |
| Crop Stage Minimum/Maximum | | | | | | 31 - | 31 - | 31 - | 31 - | 39 |
| Crop Density | | | | | | 10 PLOT | 10 PLOT | 10 PLOT | 10 PLOT | 10 PLOT |
| Assessed By | | | | | | MV | MV | MV | MV | MV |
| Data Entry Date | | | | | | May 20, 2020 | May 20, 2020 | May 20, 2020 | May 20, 2020 | Jun. 5, 2020 |
| Rating Timing | | | | | | A4 | A4 | A4 | A4 | A5 |
| Days After First/Last Applic. | | | | | | 49 20 | 49 20 | 49 20 | 49 20 | 50 35 |
| Trt-Eval Interval | | | | | | 20 DA-C | 20 DA-C | 20 DA-C | 20 DA-B | 35 DA-C |
| Plant-Eval Interval | | | | | | 55 DP-1 | 55 DP-1 | 55 DP-1 | 55 DP-1 | 70 DP-1 |
| ARM Action Codes | | | | | | | | AS | | |
| Trt | Treatment | | Rate | Appl | | | | | | |
| No. | Name | Rate | Unit | Code | Plot | 16 | 17 | 18 | 19 | 20 |
| 1 | Untreated | | | | 102 | 28.80 | 0.0 | 10.0 | 0.0 | 70.0 |
| | Check | | | | 205 | 31.00 | 0.0 | 10.0 | 0.0 | 70.0 |
| | | | | | 305 | 32.50 | 0.0 | 10.0 | 0.0 | 70.0 |
| | | | | | 403 | 37.00 | 0.0 | 10.0 | 0.0 | 70.0 |
| | | | | | 501 | 27.70 | 0.0 | 10.0 | 0.0 | 70.0 |
| | | | | | Mean= | 31.40 | 0.0 | 10.0d | 0.0 | 70.0 |
| 2 | PGA-containing | | 21/ha | ABC | 101 | — | — | — | — | — |
| | Product | | | | 202 | — | — | — | — | — |
| | | | | | 301 | — | — | — | — | — |
| | | | | | 401 | — | — | — | — | — |
| | | | | | 505 | — | — | — | — | — |
| | | | | | Mean= | — | — | — | — | — |
| 3 | Belvedere | | 1.251/ha | ABC | 103 | 29.60 | 5.0 | 10.0 | 5.0 | 70.0 |
| | Goltix | | 21/ha | ABC | 201 | 38.00 | 10.0 | 10.0 | 9.0 | 70.0 |
| | Titan | | | | | | | | | |
| | Hasten | | 0.51/ha | ABC | 304 | 35.50 | 5.0 | 10.0 | 5.0 | 70.0 |
| | | | | | 402 | 32.40 | 5.0 | 9.0 | 5.0 | 70.0 |
| | | | | | 502 | 34.40 | 5.0 | 10.0 | 5.0 | 70.0 |
| | | | | | Mean= | 33.98 | 6.0 | 9.8d | 5.8 | 70.0 |
| 4 | PGA-containing | | 11/ha | ABC | 105 | 37.80 | 10.0 | 10.0 | 10.0 | 70.0 |
| | Product | | | | | | | | | |
| | Belvedere | | 1.251/ha | ABC | 204 | 40.20 | 5.0 | 10.0 | 5.0 | 70.0 |
| | Duo | | | | | | | | | |
| | Goltix | | 21/ha | ABC | 302 | 42.20 | 5.0 | 10.0 | 5.0 | 70.0 |
| | Titan | | | | | | | | | |
| | Hasten | | 0.51/ha | ABC | 404 | 36.40 | 10.0 | 10.0 | 10.0 | 70.0 |
| | | | | | 504 | 36.50 | 5.0 | 10.0 | 5.0 | 70.0 |
| | | | | | Mean= | 38.62 | 7.0 | 10.0d | 7.0 | 70.0 |
| 5 | PGA-containing | | 11/ha | ABC | 104 | 42.90 | 10.0 | 10.0 | 10.0 | 70.0 |
| | Product | | | | | | | | | |
| | Belvedere | | 1.251/ha | ABC | 203 | 41.00 | 10.0 | 10.0 | 10.0 | 70.0 |
| | Duo | | | | | | | | | |
| | Goltix | | 21/ha | ABC | 303 | 43.20 | 5.0 | 10.0 | 5.0 | 70.0 |
| | Titan | | | | | | | | | |
| | Hasten | | 0.51/ha | ABC | 405 | 36.20 | 10.0 | 10.0 | 10.0 | 70.0 |
| | | | | | 503 | 38.50 | 5.0 | 10.0 | 5.0 | 70.0 |
| | | | | | Mean= | 40.36 | 8.0 | 10.0d | 8.0 | 70.0 |
| Crop Type, Code | | | | | | C BEAVP | C BEAVP | C BEAVP | C BEAVP | C BEAVP |
| BBCH Scale | | | | | | BPER | BPER | BPER | BPER | BPER |
| Crop Scientific Name | | | | | | Beta vulgaris > | Beta vulgaris > | Beta vulgaris > | Beta vulgaris > | Beta vulgaris > |
| Crop Name | | | | | | Planted sugar > | Planted sugar > | Planted sugar > | Planted sugar > | Planted sugar > |
| Crop Variety | | | | | | Degas | Degas | Degas | Degas | Degas |
| Description | | | | | | Chlorophyll | Phyto | Vigor | Damage | Fresh plant |
| | | | | | | Co> | | | to crop | we> |
| Rating Date | | | | | | Jun. 4, 2020 | Jun. 4, 2020 | Jun. 4, 2020 | Jun. 4, 2020 | Jun. 8, 2020 |
| SE Group No. | | | | | | 18 | 19 | 20 | 21 | 22 |
| Part Rated | | | | | | PLANT - | PLANT - | PLANT - | PLANT - | PLANT - |
| Rating Type | | | | | | CHLCON | PHYGEN | VIGOR | DAMAGE | WEIFRE |
| Rating Unit | | | | | | NUMBER | % | 0-10 | % | g |
| Sample Size | | | | | | 10 PLANT | 10 PLANT | 10 PLANT | 10 PLANT | 10 PLANT |
| Collection Basis | | | | | | 1 PLOT | 1 PLOT | 1 PLOT | 1 PLOT | 1 PLOT |
| Reporting Basis | | | | | | 1 PLOT | 1 PLOT | 1 PLOT | 1 PLOT | 1 PLOT |
| Number of Subsamples | | | | | | 1 | 1 | 1 | 1 | 1 |
| Crop Stage Scale | | | | | | BBCH | BBCH | BBCH | BBCH | BBCH |
| Crop Stage Majority | | | | | | 39 | 39 | 39 | 39 | 39 |
| Crop Stage Minimum/Maximum | | | | | | 39- | 39- | 39- | 39- | 39- |
| Crop Density | | | | | | 10 PLOT | 10 PLOT | 10 PLOT | 10 PLOT | 10 PLOT |
| Assessed By | | | | | | MV | MV | MV | MV | MV |
| Data Entry Date | | | | | | Jun. 5, 2020 | Jun. 5, 2020 | May 20, 2020 | Jun. 5, 2020 | Jun. 9, 2020 |
| Rating Timing | | | | | | A5 | A5 | A5 | A5 | A6 |
| Days After First/Last Applic. | | | | | | 64 35 | 64 35 | 64 35 | 64 35 | 68 39 |
| Trt-Eval Interval | | | | | | 35 DA-C | 35 DA-C | 35 DA-C | 35 DA-C | 39 DA-C |
| Planet-Eval Interval | | | | | | 70 DP-1 | 70 DP-1 | 70 DP-1 | 70 DP-1 | 74 DP-1 |
| ARM Action Codes | | | | | | | | | | |
| Trt | Treatment | | Rate | Appl | | | | | | |
| No. | Name | Rate | Unit | Code | Plot | 21 | 22 | 23 | 24 | 25 |
| 1 | Untreated | | | | 102 | 27.00 | 0.0 | 10.0 | 0.0 | 338.0 |
| | Check | | | | 205 | 28.00 | 0.0 | 9.0 | 0.0 | 249.0 |
| | | | | | 305 | 23.40 | 0.0 | 8.0 | 0.0 | 251.0 |
| | | | | | 403 | 26.20 | 0.0 | 9.0 | 0.0 | 355.0 |
| | | | | | 501 | 29.10 | 0.0 | 9.0 | 0.0 | 271.0 |
| | | | | | Mean= | 26.74 | 0.0 | 9.0 | 0.0 | 292.8 |
| 2 | PGA-containing | | 21/ha | ABC | 101 | 38.00 | 0.0 | 2.0 | 0.0 | 18.0 |
| | Product | | | | 202 | 36.51* | 0.4* | 0.0 | 0.4* | 0.0 |
| | | | | | 301 | 37.80 | 1.0 | 3.0 | 0.0 | 12.0 |
| | | | | | 401 | 34.77* | 1.7* | 0.0 | 1.7* | 0.0 |
| | | | | | 505 | 32.50 | 0.0 | 2.0 | 0.0 | 24.0 |
| | | | | | Mean= | 35.92 | 0.4 | 1.4 | 0.4 | 10.8 |
| 3 | Belvedere | | 1.251/ha | ABC | 103 | 27.80 | 5.0 | 10.0 | 5.0 | 391.0 |
| | Goltix | | 21/ha | ABC | 201 | 31.90 | 5.0 | 10.0 | 5.0 | 276.0 |
| | Titan | | | | | | | | | |
| | Hasten | | 0.51/ha | ABC | 304 | 31.10 | 10.0 | 9.0 | 10.0 | 267.0 |
| | | | | | 402 | 33.40 | 5.0 | 9.0 | 5.0 | 273.0 |
| | | | | | 502 | 34.10 | 5.0 | 10.0 | 5.0 | 320.0 |
| | | | | | Mean= | 31.66 | 6.0 | 9.6 | 6.0 | 305.4 |
| 4 | PGA-containing | | 11/ha | ABC | 105 | 38.90 | 5.0 | 10.0 | 5.0 | 246.0 |
| | Product | | | | | | | | | |
| | Belvedere | | 1.251/ha | ABC | 204 | 36.30 | 5.0 | 10.0 | 5.0 | 261.0 |
| | Duo | | | | | | | | | |
| | Goltix | | 21/ha | ABC | 302 | 36.70 | 10.0 | 10.0 | 10.0 | 363.0 |
| | Titan | | | | | | | | | |
| | Hasten | | 0.51/ha | ABC | 404 | 32.50 | 10.0 | 9.0 | 10.0 | 252.0 |
| | | | | | 504 | 32.40 | 5.0 | 10.0 | 5.0 | 267.0 |
| | | | | | Mean= | 35.36 | 7.0 | 9.8 | 7.0 | 277.8 |
| 5 | PGA-containing | | 11/ha | ABC | 104 | 38.50 | 5.0 | 10.0 | 5.0 | 317.0 |
| | Product | | | | | | | | | |
| | Belvedere | | 1.251/ha | ABC | 203 | 37.40 | 10.0 | 10.0 | 10.0 | 312.0 |
| | Duo | | | | | | | | | |
| | Goltix | | 21/ha | ABC | 303 | 40.60 | 5.0 | 10.0 | 5.0 | 410.0 |
| | Titan | | | | | | | | | |
| | Hasten | | 0.51/ha | ABC | 405 | 34.50 | 10.0 | 9.0 | 10.0 | 280.0 |
| | | | | | 503 | 36.20 | 5.0 | 10.0 | 5.0 | 261.0 |
| | | | | | Mean= | 37.44 | 7.0 | 9.8 | 7.0 | 316.0 |
| Crop Type, Code | | | | | | C BEAVP | | | | |
| BBCH Scale | | | | | | BPER | | | | |
| Crop Scientific Name | | | | | | Beta vulgaris > | | | | |
| Crop Name | | | | | | Planted sugar > | | | | |
| Crop Variety | | | | | | Degas | | | | |
| Description | | | | | | Root/Beet we> | | | | |
| Rating Date | | | | | | Jun. 8, 2020 | | | | |
| SE Group No. | | | | | | 23 | | | | |
| Part Rated | | | | | | BEET - | | | | |
| Rating Type | | | | | | WEIGHT | | | | |
| Rating Unit | | | | | | g | | | | |
| Sample Size | | | | | | 10 PLANT | | | | |
| Collection Basis | | | | | | 1 PLOT | | | | |
| Reporting Basis | | | | | | 1 PLOT | | | | |
| Number of Subsamples | | | | | | 1 | | | | |
| Crop Stage Scale | | | | | | BBCH | | | | |
| Crop Stage Majority | | | | | | 39 | | | | |
| Crop Stage Minimum/Maximum | | | | | | 39 - | | | | |
| Crop Density | | | | | | 10 PLOT | | | | |
| Assessed By | | | | | | MV | | | | |
| Data Entry Date | | | | | | Jun. 5, 2020 | | | | |
| Rating Timing | | | | | | A6 | | | | |
| Days After First/Last Applic. | | | | | | 68 39 | | | | |
| Trt-Eval Interval | | | | | | 39 DA-C | | | | |
| Plant-Eval Interval | | | | | | 74 DP-1 | | | | |
| ARM Action Codes | | | | | | | | | | |
| Trt | Treatment | | Rate | Appl | | | | | | |
| No. | Name | Rate | Unit | Code | Plot | 26 | | | | |
| 1 | Untreated | | | | 102 | 638.0 | | | | |
| | Check | | | | 205 | 486.0 | | | | |
| | | | | | 305 | 524.0 | | | | |
| | | | | | 403 | 714.0 | | | | |
| | | | | | 501 | 482.0 | | | | |
| | | | | | Mean= | 568.8 | | | | |
| 2 | PGA-containing | | 21/ha | ABC | 101 | 0.0 | | | | |
| | Product * | | | | 202 | 0.0 | | | | |
| | | | | | 301 | 10.0 | | | | |
| | | | | | 401 | 0.0 | | | | |
| | | | | | 505 | 13.0 | | | | |
| | | | | | Mean= | 4.6 | | | | |
| 3 | Belvedere | | 1.251/ha | ABC | 103 | 616.0 | | | | |
| | Goltix | | 21/ha | ABC | 201 | 513.0 | | | | |
| | Titan | | | | | | | | | |
| | Hasten | | 0.51/ha | ABC | 304 | 442.0 | | | | |
| | | | | | 402 | 446.0 | | | | |
| | | | | | 502 | 431.0 | | | | |
| | | | | | Mean= | 489.6 | | | | |
| 4 | PGA-containing | | 11/ha | ABC | 105 | 471.0 | | | | |
| | Product | | | | | | | | | |
| | Belvedere | | 1.251/ha | ABC | 204 | 495.0 | | | | |
| | Duo | | | | | | | | | |
| | Goltix | | 21/ha | ABC | 302 | 785.0 | | | | |
| | Titan | | | | | | | | | |
| | Hasten | | 0.51/ha | ABC | 404 | 537.0 | | | | |
| | | | | | 504 | 515.0 | | | | |
| | | | | | Mean= | 560.6 | | | | |
| 5 | PGA-containing | | 11/ha | ABC | 104 | 615.0 | | | | |
| | Product | | | | | | | | | |
| | Belvedere | | 1.251/ha | ABC | 203 | 667.0 | | | | |
| | Duo | | | | | | | | | |
| | Goltix | | 21/ha | ABC | 303 | 768.0 | | | | |
| | Titan | | | | | | | | | |
| | Hasten | | 0.51/ha | ABC | 405 | 508.0 | | | | |
| | | | | | 503 | 456.0 | | | | |
| | | | | | Mean= | 602.8 | | | | |

d = Means are reported in de-transformed data units for all of the above tables
* Note that manual weed control was omitted.

APPENDIX II
Weather Data

| | Max. | Min. | Average |
|---|---|---|---|
| Date | Temp | Temp | Humidity |
| 1 Apr. 2020 | 10.7 | 5.0 | 71.0 |
| 2 Apr. 2020 | 12.8 | 5.9 | 64.9 |
| 3 Apr. 2020 | 10.7 | 1.7 | 70.5 |
| 4 Apr. 2020 | 11.9 | 5.9 | 70.7 |
| 5 Apr. 2020 | 18.1 | 4.4 | 58.2 |
| 6 Apr. 2020 | 14.1 | 9.8 | 61.1 |
| 7 Apr. 2020 | 16.9 | 4.0 | 62.8 |
| 8 Apr. 2020 | 18.2 | 4.2 | 62.5 |
| 9 Apr. 2020 | 10.7 | 6.5 | 90.5 |
| 10 Apr. 2020 | 17.8 | 5.4 | 78.4 |
| 11 Apr. 2020 | 20.5 | 8.1 | 60.0 |
| 12 Apr. 2020 | 14.3 | 7.6 | 73.6 |
| 13 Apr. 2020 | 7.8 | 4.3 | 62.0 |
| 14 Apr. 2020 | 16.0 | −2.3 | 66.9 |
| 15 Apr. 2020 | 21.2 | 1.6 | 62.8 |
| 16 Apr. 2020 | 13.7 | 4.2 | 81.4 |
| 17 Apr. 2020 | 11.1 | 6.1 | 75.6 |
| 18 Apr. 2020 | 12.0 | 4.8 | 74.8 |
| 19 Apr. 2020 | 13.7 | 1.6 | 79.5 |
| 20 Apr. 2020 | 12.9 | 2.9 | 77.5 |
| 21 Apr. 2020 | 13.7 | 4.2 | 81.7 |
| 22 Apr. 2020 | 15.7 | 4.1 | 82.9 |
| 23 Apr. 2020 | 16.6 | 5.6 | 76.4 |
| 24 Apr. 2020 | 17.5 | 0.8 | 73.4 |
| 25 Apr. 2020 | 16.9 | 5.2 | 72.6 |
| 26 Apr. 2020 | 17.7 | 5.9 | 72.0 |
| 27 Apr. 2020 | 15.0 | 3.6 | 71.9 |
| 28 Apr. 2020 | 10.9 | 1.6 | 79.3 |
| 29 Apr. 2020 | 9.1 | 4.9 | 84.6 |
| 30 Apr. 2020 | 12.8 | 5.7 | 80.5 |
| 1 May 2020 | 15.6 | 4.6 | 82.1 |
| 2 May 2020 | 14.4 | 6.9 | 77.4 |
| 3 May 2020 | 14.2 | 6.1 | 89.0 |
| 4 May 2020 | 13.6 | 7.4 | 83.9 |
| 5 May 2020 | 13.0 | 1.7 | 77.7 |
| 6 May 2020 | 16.0 | −0.6 | 73.5 |
| 7 May 2020 | 20.7 | 3.2 | 63.8 |
| 8 May 2020 | 20.3 | 8.8 | 68.3 |
| 9 May 2020 | 20.4 | 7.8 | 73.6 |
| 10 May 2020 | 8.6 | 6.0 | 74.1 |
| 11 May 2020 | 10.7 | 2.6 | 64.9 |
| 12 May 2020 | 14.7 | 3.1 | 67.8 |
| 13 May 2020 | 11.5 | 0.2 | 68.9 |
| 14 May 2020 | 16.5 | 1.6 | 61.8 |
| 15 May 2020 | 16.1 | 6.3 | 62.1 |
| 16 May 2020 | 16.1 | 6.7 | 64.5 |
| 17 May 2020 | 15.7 | 9.4 | 74.2 |
| 18 May 2020 | 15.9 | 11.2 | 79.9 |
| 19 May 2020 | 19.0 | 11.5 | 80.5 |
| 20 May 2020 | 24.9 | 9.6 | 68.7 |
| 21 May 2020 | 22.0 | 10.0 | 63.2 |
| 22 May 2020 | 16.7 | 7.4 | 67.9 |
| 23 May 2020 | 15.3 | 11.4 | 65.5 |
| 24 May 2020 | 17.4 | 6.3 | 74.1 |
| 25 May 2020 | 21.4 | 6.0 | 60.7 |
| 26 May 2020 | 22.6 | 10.6 | 69.1 |
| 27 May 2020 | 18.6 | 8.1 | 72.1 |
| 28 May 2020 | 23.7 | 8.2 | 64.9 |
| 29 May 2020 | 24.0 | 6.0 | 56.8 |
| 30 May 2020 | 19.3 | 6.0 | 66.9 |
| 31 May 2020 | 21.4 | 8.2 | 70.1 |
| 1 Jun. 2020 | 22.0 | 6.0 | 62.0 |
| 2 Jun. 2020 | 24.0 | 6.0 | 64.0 |
| 3 Jun. 2020 | 12.0 | 8.0 | 81.0 |
| 4 Jun. 2020 | 15.0 | 6.0 | 80.0 |
| 5 Jun. 2020 | 15.0 | 6.0 | 73.0 |
| 6 Jun. 2020 | 14.0 | 6.0 | 75.0 |
| 7 Jun. 2020 | 11.0 | 8.0 | 83.0 |
| 8 Jun. 2020 | 14.0 | 5.0 | 84.0 |

APPENDIX III
Final Amendment
Study Title: PGA-containing product plant biostimulant application
on sugar beet - crop safety and performance under protected conditions.

| | |
|---|---|
| Description of | The final report has been entirely replaced |
| amendment | by this amended report. |
| Reason for | Incorrect days after application entries |
| amendment | in tables 3 and 4. |
| Impact on study | No negative impact on trial data. |

APPENDIX IV
Study Protocol
Protocol amendment: 1
Title: PGA-containing product plant biostimulant application on sugar beet -
crop safety and performance under protected conditions.

| Description of | Herbicide products and rates to be | |
|---|---|---|
| amendment | used in treatments 3, 4and 5: | |
| | Product | Appl. Rate l/ha |
| | Belvedere | 1.25 |
| | Goltrix | 2.0 |
| | Hasten | 0.5 |
| Reason for | Details not included in protocol. | |
| amendment | | |

| | |
|---|---|
| Impact on study | No impact. |

Protocol deviation: 1
Title: PGA-containing product plant biostimulant application on sugar beet -
crop safety and performance under protected conditions.

| | |
|---|---|
| Description of | Chlorophyll content taken where possible for treatment 2 at the |
| deviation | assessment for BBCH 39 for all other treatments, despite the crop |
| | not reaching appropriate growth stage |
| Reason for | Upon agreement with sponsor to obtain data for treatment 2 |
| deviation | following all 3 applications |
| Impact on study | Positive, more data generated |

Protocol deviation: 2
Title: PGA-containing product plant biostimulant application on sugar beet -
crop safety and performance under protected conditions.

| | |
|---|---|
| Description of | Additional assessment of fresh plant weight and root/beet |
| deviation | weight taken following completion of trial |
| Reason for | Upon agreement with sponsor to obtain |
| deviation | further data. |
| Impact on study | Positive, more data generated. |

Protocol deviation: 3
Title: BOOSTER plant biostimulant application on sugar beet -
crop safety and performance under protected conditions.

| | |
|---|---|
| Description of | Removal of PGA-containing Product |
| deviation | from statistical analysis. |
| Reason for | Upon agreement with sponsor, as due to lack |
| deviation | of data for this treatment, may cause skewed |
| | data for other treatments. |
| Impact on study | Negative, fewer treatments statistically analysed. |

| | | | Application |
|---|---|---|---|
| | Product | Dose Rate | timings |
| Treatment | Name | (L/ha) | (BBCH) |
| 1 | UTC | — | — |
| 2 | PGA-containing | 2 | As |
| | Product | | treatments |
| | | | 3-5 |
| 3 | Herbicides | Label Rate | Lable |
| | | | Timings |
| | | | (three apps.) |
| 4 | Herbicides + | Herbicides label rate + | Lable |
| | PGA-containing | PGA-containing Product | Timings |
| | Product | at 1 L/ha | (three apps.) |
| 5 | Herbicides + | Herbicides label rate + | Lable |
| | PGA-containing | PGA-containing Product | Timings |
| | Product | at 1 L/ha | (three apps.) |

Sufficient volume to enable complete coverage of upper and lower leaf surfaces but avoiding run-off. Real spray volume to be calculated at application.

### Trial Methodology

| | |
|---|---|
| Trial Type: | Biostimulant efficacy - Protected |
| Trial Location: | UK |
| Guidelines | EPPO PP1/181 Conduct and reporting of efficacy |
| to be used | evaluation trials including good experimental practice |
| | EPPO PP1/135(4): Phytotxicity |
| | EPPO PP1/152(4): Design and analysis of |
| | efficacy ecaluation trials |

### Plot Size/Replication/Randomization

Plot size: 10 plants
Replication: Minimum of 5 replicates
Randomization: Complete Randomized Block

### Experimental Conditions

| Test crop | Sugar beet | | |
|---|---|---|---|
| Planting density | 10 plants/plot | | |
| Application | Spray Volume: | Spray pressure: | Other: |
| specs | Refer to treatment list | N/A | N/A |

| | |
|---|---|
| Timing of | Trial to start at BBCH 09-12 (cotyledon - 2 true leaves) |
| Application: | Apply treatments at the beginning of crop growth (ideally BBCH09), |
| | with application, and repeat applications to be made as |
| | recommended by herbicide label. A maximum of 3 |
| | applications are to be applied. |
| | NB. Herbivide label applications expected to be BBCH 09-12, |
| | BBCH 14-15 and BBCH 16-19, with the earliest BBCH stage (09, |
| | 14 and 16) being preferable. |
| Information at | The following information will be recorded at application: |
| application(s) | Time of application (start and end time) |
| | Temperature (max and min in ° C.) |
| | Relative humidity (%) |
| | Cloud cover (%) |
| | Crop surface moisture (wet/moist/dry) |
| | Soil moisture (wet/moist/dry). |
| | BBCH growth stage of the crop |

### Assessments

### At Every Application Record:

Time of application, temperature, relative humidity, cloud cover, crop surface moisture (wet/moist/dry) and soil moisture (wet/moist/dry)
BBCH growth stage of the crop
Any visible phytotoxicity
Vigor of the crop (0-10)
Damage to the crop (%)

### Assessments at BBCH20, BBCH31 and BBCH39:

Crop development (time (days) to reach BBCH growth stages of the crop)
Chlorophyll content
Any visible phytotoxicity
Vigor of the crop (0-10)
Damage to the crop (%)
Photographs taken at each assessment for all plots
NB. BBCH 20—beginning of rosette stage (10 leaf)
   BBCH 31—beginning of crop cover (10%)
   BBCH 39—crop cover complete (90%)

### Special Requirements

Normal crop maintenance treatments to be applied, but no foliage fertilizers, fungicides or insecticides to be applied.
Observations should also be made of any adverse effects on beneficial organisms used in the crop before application and at the same time as assessing pest control and crop safety (phytotoxicity).

### Statistical Analyses

All data will be subjected to the appropriate statistical analysis using Minitab (v.16). Statistical analyses performed will be fully documented in the ARM file and written report. Statistical analysis to confidence level 90% & 95% where difference is shown.

### Protocol Amendments and Deviations

Any protocol amendments and/or deviations will be documented, fully justified and maintained with the protocol.

All technical and scientific terms used herein have the same meaning. Efforts have been made to ensure accuracy with respect to numbers used (e.g., amounts, temperature, etc.) but some experimental errors and deviations should be accounted for.

As used herein, the term “about,” when referring to a value, is meant to encompass variations of, in some embodiments ±5%, in some embodiments ±2%, in some embodiments ±1%, in some embodiments ±0.5%, in some embodiments ±0.1% from the specified amount, as such variations are appropriate to perform the disclosed methods or employ the disclosed compositions.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers are also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of controlling the growth of undesired vegetation in a target area, the method comprising
applying to the target area an herbicidally effective amount of an herbicide composition comprising an herbicide selected from a lipid synthesis inhibitor, an amino acid synthesis inhibitor, a nitrogen metabolism inhibitor, a growth regulator inhibitor, and a combination thereof; and
applying an herbicide safener composition comprising pyroglutamic acid (PGA) and/or 2-oxoglutaramate at a concentration of less than 1 g/L,
wherein the herbicide safener composition is applied to the target area in an amount effective to cause an herbicide safening effect, and
wherein the target area contains plants of cultivated crops selected from specialty crops, sugar crops, legumes, and a combination thereof.

2. The method of claim 1, wherein the PGA amount effective to cause an herbicide safening effect is from about 0.001 mg to about 50 mg per plant of cultivated crop.

3. The method of claim 1, wherein the herbicide safener composition comprises PGA at a concentration ranging from about 0.1 g/L to about 0.2 g/L.

4. The method of claim 1, wherein the herbicide safening effect is measured by at least one method selected from an increase in crop development, a decrease in phytotoxicity, an increase in crop vigor, an increase in chlorophyll content, an increase in fresh or dry plant weight, an increase in root weight, an increase in crop yield, an increase in fruit quality, an increase in plant growth, and an increase in leaf area of plants treated with the herbicide safener composition compared to plants that were only treated with the herbicide composition and were not treated with the herbicide safener composition.

5. The method of claim 4, wherein an increase of about 1% to about 20% of plant height of plants treated with the herbicide safener composition was observed compared to plants that were not treated with the herbicide safener composition; and/or an increase of about 1% to about 90% of dry plant weight of plants treated with the herbicide safener composition was observed compared to plants that were only treated with the herbicide composition; and/or an increase of about 1% to about 300% of leaf area of plants treated with the herbicide safener composition was observed compared to plants that were only treated with the herbicide composition.

6. (canceled)

7. (canceled)

8. The method of claim 1, wherein the target area contains unwanted vegetation and plants of cultivated crops and the herbicide safener composition is applied to the soil of the target area, the plants of cultivated crops, or a combination thereof.

9. The method of claim 6, wherein the herbicide safener composition is applied to the soil adjacent to the plant, the root zone of the plant, one or more plant parts of the plants of cultivated crops, or a combination thereof.

10. The method of claim 1, wherein the herbicidal composition and the herbicide safener composition are applied to the soil of the target area containing crops of cultivated plants that have not yet emerged.

11. The method of claim 1, wherein the herbicidal composition and the herbicide safener composition are applied to the target area at the same time.

12. (canceled)

13. The method of claim 1, wherein the plants of cultivated crops are selected from:
specialty crops selected from fruits and nuts such as almonds, apples, apricots, avocado, banana, blackberry, blueberry, breadfruit, cacao, cashew, citrus, cherimoya, cherry, chestnut, coconut, coffee, cranberry, currant, date, feijoa, fig, filbert, gooseberry, grape, guava, kiwi, lychee, macadamia, mango, melons, nectarine, olive, papaya, passion fruit, peach, pear, pecan, persimmon, pineapple, pistachio, plum, pomegranate, quince, raspberry, strawberry, suriname cherry, walnut, watermelon; and/or
vegetables such as artichoke, asparagus, bean snap, green lima, beet, broccoli, brussels sprouts, cabbage, cauliflower, celeriac, celery, chive, collards, cucumber, edamame, eggplant, endive, garlic, horseradish, kohlrabi, leek, lettuce, mustard greens, okra, peas, onion, opuntia, parsley, parsnip, pepper, potato, pumpkin, radish, rhubarb, rutabaga, salsify, spinach, squash, sweet corn, sweet potato, swiss chard, taro, tomato, tomatillo, turnip, and combinations thereof; and/or
legumes selected from alfalfa, clover, beans, peas, chickpeas, lentils, lupins, mesquite, carob, soybeans, peanuts, and tamarind; and/or
sugar crops selected from sugar beets, sugar cane, and a combination thereof.

14. (canceled)

15. (canceled)

16. The method of claim 1, wherein the cultivated crops are not genetically modified crops.

17. (canceled)

18. (canceled)

19. (canceled)

20. The method of claim 1, wherein the PGA is a mixture of L- and D-PGA stereoisomers in a molar ratios of L and D from about 80:20 to about 97:3.

21. The method of claim 1, wherein the herbicidal composition is selected from:
a lipid synthesis inhibitor selected from fenoxaprop, fluazifob, quizalofob, clethodim, sethaxydim, and a combination thereof;
an amino acid synthesis inhibitor selected from chlorimuron, foramsulfuron, halosulfuron, iodosulfuron, nicosulfuron, primisulfuron, prosulfuron, rimsulfuron, thifensulfuron, tribenuron, imazamox, imazaquin, imazethapyr, flumetsulam, cloransulam, thiencarbazone, glyphosate, and a combination thereof;
a nitrogen metabolism inhibitor selected from glufosinate;
a growth regulator inhibitor selected from 2,4-D, dicamba, quinmerac, clopyralid, fluroxpyr, diflufenzopyr, and a combination thereof; and
a combination thereof.

22. The method of claim 13, wherein the herbicidal composition is selected from glyphosate, glufosinate, 2,4-D, dicamba, quinmerac, metamitron, phenmedipham, ethofumesate, quinclorac, and a combination thereof.

23. (canceled)

24. The method of claim 1, wherein the herbicidally effective amount ranges from 0.005 to about 500 kilograms/hectare (kg/ha).

25. (canceled)

26. The method of claim 1, wherein the herbicidal composition is applied to the target area at a rate of from about 0.1 to about 10 gallons/acre; and/or is applied with a field strength of at least about 10% of the label rate.

27. (canceled)

28. (canceled)

29. The method of claim 1, wherein the herbicide composition and/or herbicide safener composition is applied to a portion of the target area.

30. The method of claim 1, wherein the unwanted vegetation is selected from:
a monocotyledonous weed selected from the group of genera consisting of Agrostis spp., Alopecurus spp., Apera spp., Avena spp., Brachiaria spp., Bromus spp., Digitaria spp., Echinochloa spp., Eleusine spp., Eriochloa spp., Leptochloa spp., Lolium spp., Ottochloa spp., Panicum spp., Paspalum spp., Phalaris spp., Poa spp., Rottboelia spp., Setaria spp., Sorghum spp., Commelina spp., Monochoria spp., Sagittaria spp. and sedges such as Cyperus spp. and Scirpus spp.; and/or
a dicotyledonous weed selected from the group of genera consisting of Abutilon spp., Ambrosia spp., Amaranthus spp., Chenopodium spp., Erysimum spp., Euphorbia spp., Fallopia spp., Galium spp., Hydrocotyle spp., Ipomoea spp., Lamium spp., Medicago spp., Oxalis spp., Plantago spp., Polygonum spp., Richardia spp., Sida spp., Sinapis spp., Solanum spp., Stellaria spp., Taraxacum spp., Trifolium spp., Veronica spp., Viola spp. and Xanthium spp; and/or glyphosphate-resistant weeds selected from the group consisting of rigid ryegrass, horseweed (marestail), Italian ryegrass, common ragweed, palmer amaranth, waterhemp, goosegrass, hairy fleabane, broadleaf plantain, johnsongrass, and wild poinsettia.

31. The method of claim 1, wherein the herbicide safener composition is formulated into a formulation comprising one or more auxiliaries selected from a polyanion, extenders, carriers, solvents, surfactants (surface-active agents), stabilizers, anti-foaming agents, anti-freezing agents, preservatives, antioxidants, viscosity modifiers, suspending agents, light absorbers, corrosion inhibitors, fragrances, pH-modifying substances, glidants, lubricants, plasticizers, complexing agents, colorants, thickeners, solid adherents, fillers, wetting agents, dispersing agents, lubricants, anticaking agents, deformers and diluents.

33. The method of claim 1, wherein the herbicide safener composition is in a form selected from a ready to use formulation, a premix formulation, a tank mix formulation, a soluble liquid (SF), an emulsifiable concentrate (EC), a wettable powder (WP), a dry flowable (DF), a flowable (F), a water soluble powder (SP), an ultra-low-volume concentrate (ULV), a suspension concentrate (SC), an aqueous suspension (AS), a microencapsulated suspension (ME or MT), a capsule suspension (CS), a granule (G), or a pellet (P).

34. (canceled)
